(19) United States
(12) Patent Application Publication
(10) Pub. No.: US 2025/0242730 A1
(43) Pub. Date: Jul. 31, 2025

(54) CONVEYANCE SEAT

(71) Applicant: TS TECH CO., LTD., Asaka-shi (JP)

(72) Inventors: Hiroaki WADA, Tochigi (JP); Hironori WATANABE, Tochigi (JP); Soichiro KAMEI, Tochigi (JP); Jinichi TANABE, Tochigi (JP)

(21) Appl. No.: 19/184,531

(22) Filed: Apr. 21, 2025

Related U.S. Application Data
(63) Continuation of application No. 18/351,830, filed on Jul. 13, 2023.
Application No. 18/351,830 is a continuation of application No. PCT/JP2022/000684, filed on Jan. 12, 2022.

(30) Foreign Application Priority Data
Jan. 14, 2021 (JP) 2021-004428
Jan. 21, 2021 (JP) 2021-004429
Jan. 21, 2021 (JP) 2021-008193
Jan. 21, 2021 (JP) 2021-008194
Jan. 21, 2021 (JP) 2021-008195
Jan. 21, 2021 (JP) 2021-008196
Jan. 26, 2021 (JP) 2021-010316
Feb. 22, 2021 (JP) 2021-026552
Mar. 8, 2021 (JP) 2021-036581
Mar. 23, 2021 (JP) 2021-049240

(51) Int. Cl. B60N 2/22; B60N 2/68

(52) U.S. Cl. CPC B60N 2/22; B60N 2/68

(57) ABSTRACT

A conveyance seat capable of ensuring the rigidity of a reclining device and suppressing manufacturing cost includes a reclining device that rotatably connects a seat back to a seat cushion. The reclining device includes rotating shafts disposed on right and left sides in a seat width direction and serving as a rotation center of the seat back, and a connecting member having a plate shape, extending the seat width direction, and connecting the right and left rotating shafts. The connecting member includes a connecting body portion extending long in the seat width direction, and shaft attachment portions provided at extending end portions of the connecting body portion and used for attaching the rotating shafts. The shaft attachment portions have an open cross-sectional shape in which opening portions are formed on upper sides of the shaft attachment portions, and support extending portions of the rotating shafts.

### CROSS REFERENCE TO RELATED APPLICATIONS

This application is a continuation of U.S. patent application Ser. No. 18/351,830, filed on Jul. 13, 2023, which is a continuation of International Application No. PCT/JP2022/000684, filed on Jan. 12, 2022, which, in turn, claims priority to Japanese Patent Application No. 2021-004428, filed on Jan. 14, 2021; Japanese Patent Application No. 2021-004429, filed on Jan. 14, 2021; Japanese Patent Application No. 2021-008193, filed on Jan. 21, 2021; Japanese Patent Application No. 2021-008194, filed on Jan. 21, 2021; Japanese Patent Application No. 2021-008195, filed on Jan. 21, 2021; Japanese Patent Application No. 2021-008196, filed on Jan. 21, 2021; Japanese Patent Application No. 2021-010316, filed on Jan. 26, 2021; Japanese Patent Application No. 2021-026552, filed on Feb. 22, 2021; Japanese Patent Application No. 2021-036581, filed on Mar. 8, 2021; and Japanese Patent Application No. 2021-049240, filed on Mar. 23, 2021, all of which are hereby incorporated herein by reference in their entireties for all purposes.

### BACKGROUND OF THE INVENTION

### Field of the Invention

The present invention relates to a conveyance seat.

In related art, as described in JP 2008 136552 A (“552 document”), a vehicle seat including a reclining device has been known. The reclining device mainly includes a reclining body that is driven when a seat cushion is rotated; rotating shafts disposed on right and left sides and serving as a rotation center of the seat cushion; a connecting rod having a pipe shape and connecting the right and left rotating shafts; an operating lever operated to release a locked state of the seat cushion.

In the above-described configuration, the connecting rod is connected to rotate together with the rotating shafts as the rotating shafts rotationally operate. Specifically, the connecting rod is connected to the rotating shafts via cap members, so that the connecting rod can operate in synchronization with the rotational operation of the rotating shafts.

### SUMMARY OF THE INVENTION

An object of the present invention is to provide a conveyance seat capable of ensuring the rigidity of a reclining device and suppressing the manufacturing cost of the reclining device.

In order to achieve the above object, there is provided a conveyance seat including: a seat body including a seat cushion and a seat back; and a reclining device that rotatably connects the seat back to the seat cushion. The reclining device includes rotating shafts disposed on right and left sides in a seat width direction and serving as a rotation center of the seat back, and a connecting member extending in the seat width direction and connecting the right and left rotating shafts. The connecting member includes a connecting body portion extending long in the seat width direction, and shaft attachment portions provided at extending end portions of the connecting body portion and used for attaching the rotating shafts. Each of the shaft attachment portions has an open cross-sectional shape in which an opening portion is formed on one side in an up to down direction or on one side in a seat front to rear direction, and supports an extending portion of the corresponding rotating shaft.

With the above-described configuration, the conveyance seat capable of suppressing the manufacturing cost of the reclining device while ensuring the rigidity of the device can be realized.

In more detail, each of the shaft attachment portions has an open cross-sectional shape in which the opening portion is formed on the one side in the up to down direction or on the one side in the seat front to rear direction, and supports the extending portion of the corresponding rotating shaft. For this reason, compared to the case of the connecting member having a pipe shape in the related art, the manufacturing cost can be suppressed through a simple configuration while the assembly rigidity of the connecting member and the rotating shafts is ensured.

### BRIEF DESCRIPTION OF THE DRAWINGS

FIG. 1 is a perspective view of a conveyance seat of a first embodiment.

FIG. 2 is a perspective view of a seat frame serving as a skeleton of the conveyance seat.

FIG. 3 is an enlarged view of main parts of the seat frame, and is a perspective view of a reclining device.

FIG. 4 is a perspective view of the reclining device when viewed at another angle.

FIG. 5A is a perspective view of a connecting member and a rotating shaft.

FIG. 5B is a perspective view of the connecting member and the rotating shaft when viewed at another angle.

FIG. 6A is a perspective view of a connecting member of a first modification example.

FIG. 6B is a perspective view of the connecting member of the first modification example when viewed at another angle.

FIG. 7A is a perspective view of a connecting member of a second modification example.

FIG. 7B is a perspective view of the connecting member of the second modification example when viewed at another angle.

FIG. 8A is a perspective view of a connecting member of a third modification example.

FIG. 8B is a perspective view of the connecting member of the third modification example when viewed at another angle.

FIG. 9A is a perspective view of a connecting member of a fourth modification example.

FIG. 9B is a perspective view of the connecting member of the fourth modification example when viewed at another angle.

FIG. 10 is a perspective view of a conveyance seat of a second embodiment.

FIG. 11 is a perspective view of a seat frame serving as a skeleton of the conveyance seat.

FIG. 12 is an enlarged view of main parts of a cushion frame, and is a perspective view of a side frame and a connecting frame.

FIG. 13 is a perspective view of the connecting frame.

FIG. 14 is a perspective view of a conveyance seat of a third embodiment.

FIG. 15 is a perspective view of a seat frame included in the conveyance seat.

FIG. 16 is a top view of the seat frame.

FIG. 17 is an enlarged view describing a structure around a rear connection pipe of the seat frame.

FIG. 18 is a perspective view showing a structure of the rear connection pipe.

FIG. 19 is a cross-sectional view taken along line A-A of FIG. 18.

FIG. 20 is a perspective view showing an appearance of a conveyance seat of a fourth embodiment, when viewed obliquely from the front.

FIG. 21 is a perspective view showing a seat frame of the conveyance seat, when viewed obliquely from the front.

FIG. 22 is a view of an upper frame of a seat back frame when viewed from the front.

FIG. 23 is a view of the upper frame of the seat back frame when viewed from behind.

FIG. 24 is a perspective view showing an inner side of a first pan frame forming the upper frame.

FIG. 25 is a perspective view showing an inner side of a second pan frame forming the upper frame.

FIG. 26 is an end view taken along line XXVI-XXVI of FIG. 22.

FIG. 27 is a cross-sectional view taken along line XXVII-XXVII of FIG. 22.

FIG. 28 is a perspective view of another example of the upper frame.

FIG. 29 is a perspective view showing an appearance of a conveyance seat of a fifth embodiment, when viewed obliquely from the front.

FIG. 30 is a perspective view of a seat frame of the conveyance seat.

FIG. 31 is a view of an upper frame of a seat back frame when viewed from the front.

FIG. 32 is a view of the upper frame of the seat back frame when viewed from behind.

FIG. 33 is a view of the upper frame from which a headrest guide is removed, when viewed from the front.

FIG. 34 is a cross-sectional view of a third member taken along line XXXIV-XXXIV of FIG. 31.

FIG. 35 is a cross-sectional view of the third member taken along line XXXV-XXXV of FIG. 31.

FIG. 36 is an end view of a first member taken along line XXXVI-XXXVI of FIG. 31.

FIG. 37 is a perspective view showing an appearance of a conveyance seat of a sixth embodiment, when viewed obliquely from the front.

FIG. 38 is a perspective view showing a seat frame, when viewed obliquely from the front.

FIG. 39 is a view of an upper frame of a seat back frame when viewed from the front.

FIG. 40 is a view of the upper frame of the seat back frame when viewed from behind.

FIG. 41 is a cross-sectional view taken along line XLI-XLI of FIG. 39.

FIG. 42 is a cross-sectional view taken along line XLII-XLII of FIG. 39.

FIG. 43A is a cross-sectional view taken along line XLIII-XLIII of FIG. 39.

FIG. 43B is a cross-sectional view showing another example of the upper frame.

FIG. 43C is a cross-sectional view showing another example of the upper frame.

FIG. 44 is a perspective view of a conveyance seat of a seventh embodiment.

FIG. 45 is a perspective view of a seat frame serving as a skeleton of the conveyance seat.

FIG. 46 is an enlarged view of main parts of a cushion frame, and is a perspective view of a side frame and a pan frame.

FIG. 47 is a top view of the side frame and the pan frame.

FIG. 48 is a side view of the side frame and the pan frame.

FIG. 49 is a view describing a state where the pan frame (engagement clip) engages with the side frame (engagement hole).

FIG. 50 is a cross-sectional view taken along line L-L of FIG. 48.

FIG. 51 is a schematic perspective view of a conveyance seat of an eighth embodiment.

FIG. 52 is a schematic perspective view of a seat frame of the conveyance seat.

FIG. 53 is a schematic view showing a state where an occupant is seated in the conveyance seat, and is a view showing a state where a load from the occupant is applied to the conveyance seat and the back of the occupant is supported by a neck support or the like.

FIG. 54 is a front view of a frame of the neck support when viewed from the front.

FIG. 55A is a side view of the frame of the neck support when viewed from the side.

FIG. 55B is a side view of another example of the frame of the neck support when viewed from the side.

FIG. 56 is a cross-sectional view taken along line LVI-LVI of FIGS. 54 and 55A.

FIG. 57 is a front view showing a seat back frame to which the neck support is attached.

FIG. 58A is a descriptive view showing a position where a guide member of the neck support is fixed.

FIG. 58B is a descriptive view showing a position where the guide member of the neck support is fixed.

FIG. 58C is a descriptive view showing a position where the guide member of the neck support is fixed.

FIG. 59 is a perspective view of a conveyance seat of a ninth embodiment.

FIG. 60 is a perspective view of a seat frame serving as a skeleton of the seat.

FIG. 61 is an enlarged view of main parts of a cushion frame, and is a perspective view of a side frame and a pan frame.

FIG. 62A is a perspective view of the side frame and the pan frame when viewed from a back side, and is a view showing a frame contact portion and a second frame contact portion.

FIG. 62B is a perspective view of the frame contact portion and the second frame contact portion.

FIG. 63 is a top view showing the side frame and the pan frame.

FIG. 64 is a perspective view of a frame contact portion of a first modification example.

FIG. 65 is a perspective view of a frame contact portion of a second modification example.

FIG. 66 is a perspective view of a conveyance seat of a tenth embodiment.

FIG. 67 is a perspective view of a seat frame serving as a skeleton of the seat.

FIG. 68 is an enlarged view of main parts of FIG. 67, and is a perspective view of a periphery of a reclining device.

FIG. 69 is an exploded perspective view of the reclining device and a connecting bracket.

FIG. 70A is a perspective view of the connecting bracket.

FIG. 70B is a perspective view of the connecting bracket when viewed at another angle.

FIG. 71 is a perspective view of the periphery of the reclining device when viewed at another angle.

FIG. 72 is a cross-sectional view taken along line LXXII-LXXII of FIG. 71, and is a view describing a positional relationship between a connecting bracket, a back side frame, and a link.

### DESCRIPTION OF THE PREFERRED EMBODIMENTS

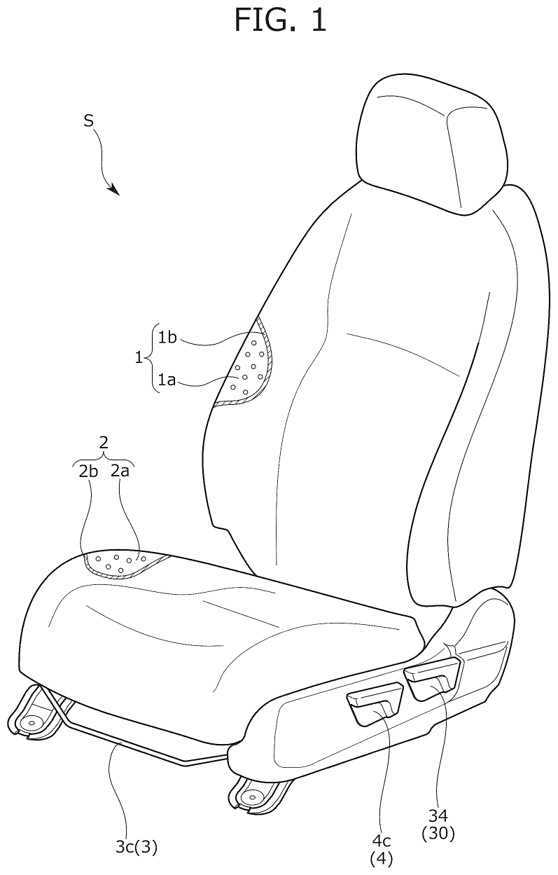

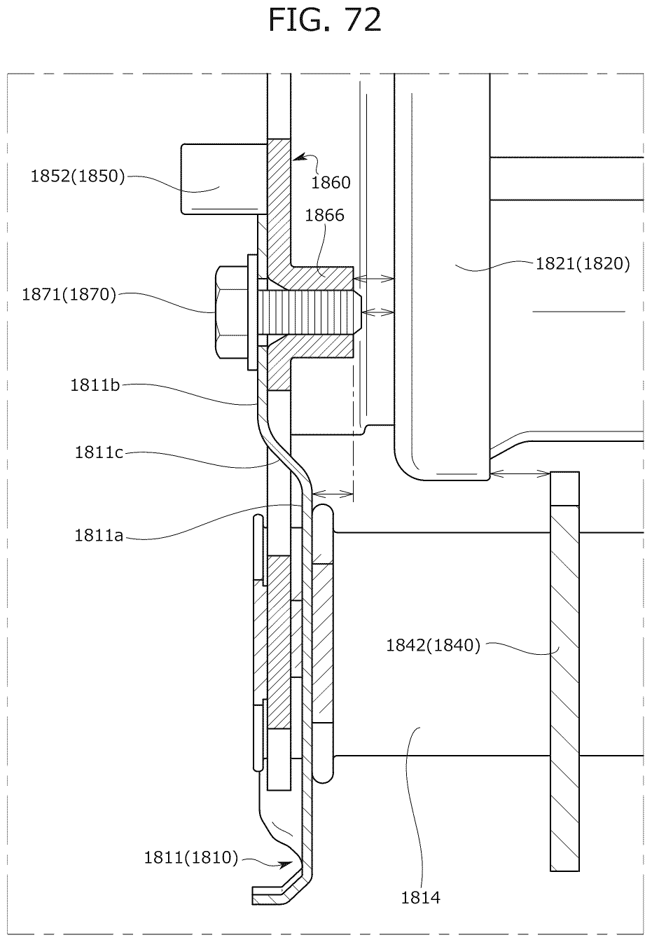

Hereinafter, embodiments according to the present invention will be described with reference to FIGS. 1 to 72.

Incidentally, a side on which an occupant is seated with respect to a seat back of a conveyance seat is a seat front side.

### First Embodiment

A conveyance seat S1 of a first embodiment will be described with reference to FIGS. 1 to 9B.

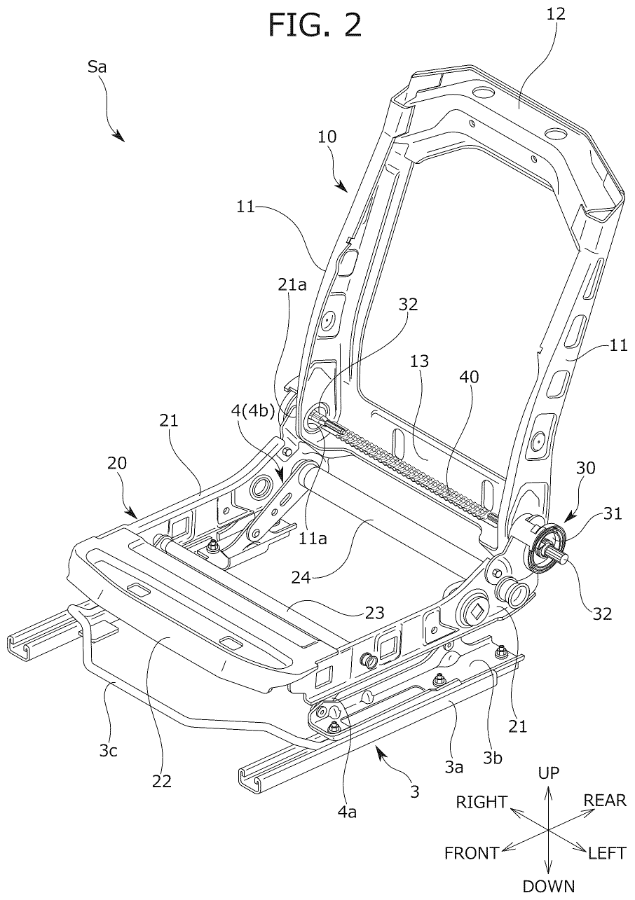

The conveyance seat S1 mainly includes, as shown in FIG. 1, a seat body including a seat back 1 and a seat cushion 2, and as shown in FIG. 2, a slide rail device 3 that supports the seat body so as to be movable forward and rearward with respect to a vehicle body floor, a height link device 4 that connects the seat body to the vehicle body floor so as to be raisable and lowerable, and a reclining device 30 that rotatably connects the seat back 1 to the seat cushion 2.

As shown in FIG. 1, the seat back 1 is a backrest portion that supports a seated occupant from behind, and is configured by placing a cushion material 1a on a back frame 10 serving as a skeleton shown in FIG. 2, and by covering the cushion material 1a with a skin material 1b.

The seat cushion 2 is a seating portion that supports the seated occupant from below, and is configured by placing a cushion material 2a on a cushion frame 20 serving as a skeleton shown in FIG. 2, and by covering the cushion material 2a with a skin material 2b.

As shown in FIG. 2, the slide rail device 3 is disposed between the seat body and the vehicle body floor in an up to down direction, and mainly includes right and left lower rails 3a fixed to the vehicle body floor and extending in a seat front to rear direction; right and left upper rails 3b supported to be slidable along the lower rails 3a; a lock member (not shown) that non-slidably locks the upper rails 3b to the lower rails 3a; and a rail operating lever 3c for releasing a locked state of the lock member.

The cushion frame 20 is provided on upper surfaces of the right and left upper rails 3b via the height link device 4 in a bridging manner.

As shown in FIG. 2, the height link device 4 is attached between the slide rail device 3 and the cushion frame 20, and mainly includes right and left first links 4a disposed on the seat front side; right and left second links 4b disposed on a seat rear side; a lock member (not shown) that locks the seat body so as not to be raisable and lowerable; and a height operating lever 4c for releasing a locked state of the lock member. Further, the second links 4b are devices that serve as drive links to be able to adjust a height of the seat body.

As shown in FIG. 2, the back frame 10 is formed of a substantially rectangular frame-shaped body, and mainly includes back side frames 11 disposed on right and left sides; an upper frame 12 having an inverted U shape and connecting upper end portions of the back side frames 11; a lower frame 13 having a plate shape and connecting lower end portions of the back side frames 11; and elastic springs (not shown) hooked to each of the back side frames 11 and extending in a meandering manner.

The back side frames 11 are sheet material members extending in the up to down direction and having substantially C-shaped lateral cross sections, and the lower end portions of the back side frames 11 are connected to rear end portions of side frames 21 via the reclining device 30.

A fitting hole 11a for fitting a reclining body 31 and a rotating shaft 32 is formed in an outer surface in a seat width direction of the back side frame 11.

As shown in FIG. 2, the cushion frame 20 is formed of a substantially rectangular frame-shaped body, and mainly includes the side frames 21 disposed on the right and left sides and extending in the seat front to rear direction; a pan frame 22 having a plate shape and connecting front end portions of the side frames 21; a front connecting frame 23 connecting front portions of the side frames 21; a rear connecting frame 24 connecting rear portions of the side frames 21; and elastic springs (not shown) hooked to the pan frame 22 and the rear connecting frame 24 and extending in a meandering manner in the seat front to rear direction.

The side frames 21 are plate-shaped frames that are long in the seat front to rear direction, and the reclining device 30 is attached to rear end portions of the side frames 21.

A fitting hole 21a for fitting the reclining body 31 and the rotating shaft 32 is formed in an outer surface in the seat width direction of the side frame 21.

Each of the front connecting frame 23 and the rear connecting frame 24 is a pipe-shaped frame, and connects the right and left side frames 21 and connects the respective right and left links (the first links 4a and the second links 4b).

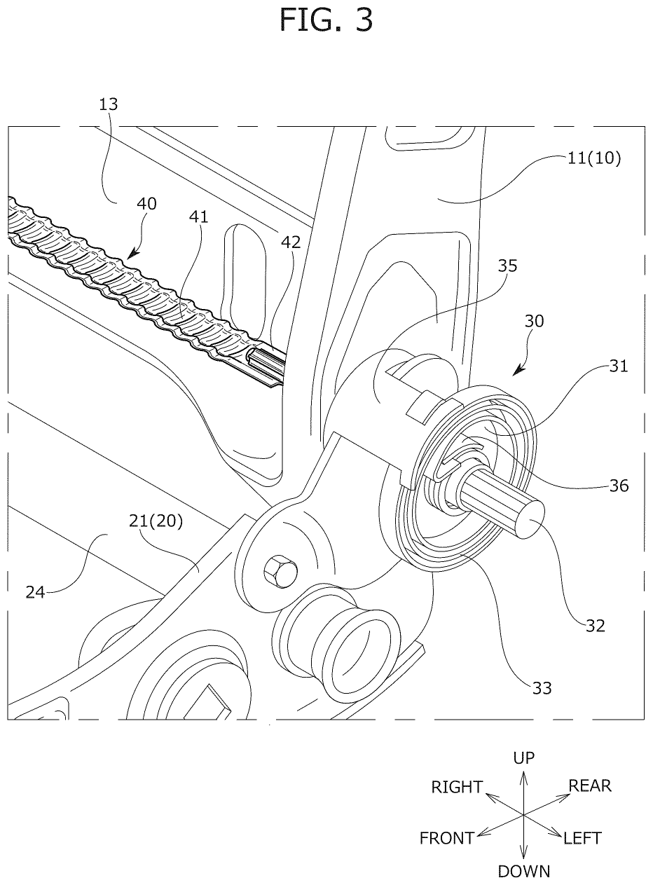

As shown in FIGS. 2 and 3, the reclining device 30 is a device that is switchable between a locked state where the rotational operation of the back frame 10 is locked and an unlocked state, and that can adjust an upright posture of the back frame 10 when a reclining operating lever 34 shown in FIG. 1 is operated from a state where the back frame 10 is locked in a predetermined upright posture.

As shown in FIGS. 2 to 4, the reclining device 30 includes the reclining body 31 disposed on the left side in the seat width direction, and driven when the back frame 10 is rotated; the rotating shafts 32 disposed on the right and left sides in the seat width direction, and serving as a rotation center of the back frame; and a connecting member 40 extending in the seat width direction, and connecting the right and left rotating shafts 32.

In addition, the reclining device 30 further includes a spiral spring 33 disposed on the left side in the seat width direction and biasing the back frame 10 to rotate forward, and the reclining operating lever 34 shown in FIG. 1 that is operated to release a locked state of the back frame 10.

The reclining body 31 includes a known lock mechanism, and can switch the state of the back frame 10 between a locked state where the back frame 10 is fixed to the cushion frame 20 and an unlocked state where the back frame 10 is rotatable with respect to the cushion frame 20.

The rotating shafts 32 are supported on a back frame 10 side and on a cushion frame 20 side in the seat width direction, and extending end portions (inner end portions) of the rotating shafts 32 are connected to the connecting member 40.

The spiral spring 33 is a biasing spring that biases the back frame 10 to the seat front side, and is configured such that one end portion of the spiral spring 33 is latched to a spring latch bracket 35 attached to the outer surface of the back side frame 11 and the other end portion is latched to a spring latch member 36 attached to the outer surface of the side frame 21.

As shown in FIGS. 3 to 5B, the connecting member 40 is, for example, formed by processing a plate-shaped member through press forming, and mainly includes a connecting body portion 41 extending long in the seat width direction, and shaft attachment portions 42 provided at extending end portions of the connecting body portion 41 and used for attaching the rotating shafts 32.

The connecting body portion 41 includes a plurality of reinforcement protrusions 43 and reinforcement recesses 44 that are formed to be alternately arranged adjacent to each other in an extending direction of the connecting body portion 41, and has a bellows shape due to the reinforcement protrusions 43 and the reinforcement recesses 44.

The reinforcement protrusions 43 and the reinforcement recesses 44 are formed as substantially semicircular protrusions and substantially semicircular recesses on an outer surface of the connecting body portion 41, respectively, and extend to be long along a direction intersecting (direction orthogonal to) the extending direction of the connecting body portion 41.

Incidentally, the reinforcement protrusion 43 is formed such that a central portion of the reinforcement protrusion 43 in the seat front to rear direction is deeper than both front and rear end portions thereof. The same applies to the reinforcement recess 44. For this reason, while the rigidity of the connecting member 40 is improved, interference between the connecting member 40 and other components when the connecting member 40 rotationally operates together with the rotating shafts 32 can be suppressed.

The shaft attachment portion 42 has an open cross-sectional shape in which an opening portion is formed on an upper side thereof, and surrounds and supports an extending portion of the rotating shaft 32.

Specifically, the shaft attachment portion 42 includes a pair of facing wall portions 42a and 42b provided with a predetermined distance therebetween in the seat front to rear direction; a connecting wall portion 42c connecting lower end portions of the pair of facing wall portions 42a and 42b; and a first flange portion 42d and a second flange portion 42e formed to extend opposite to each other from extending end portions of the pair of facing wall portions 42a and 42b.

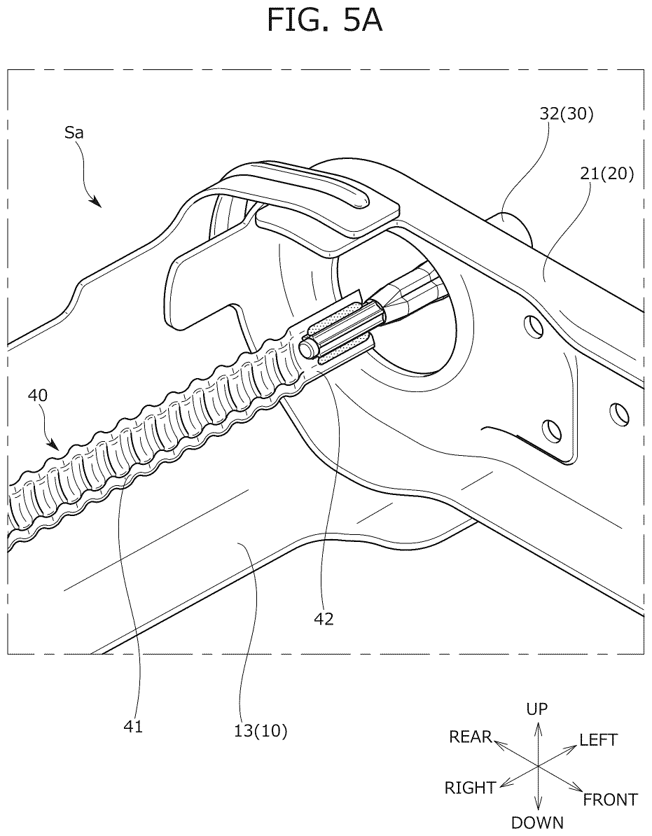

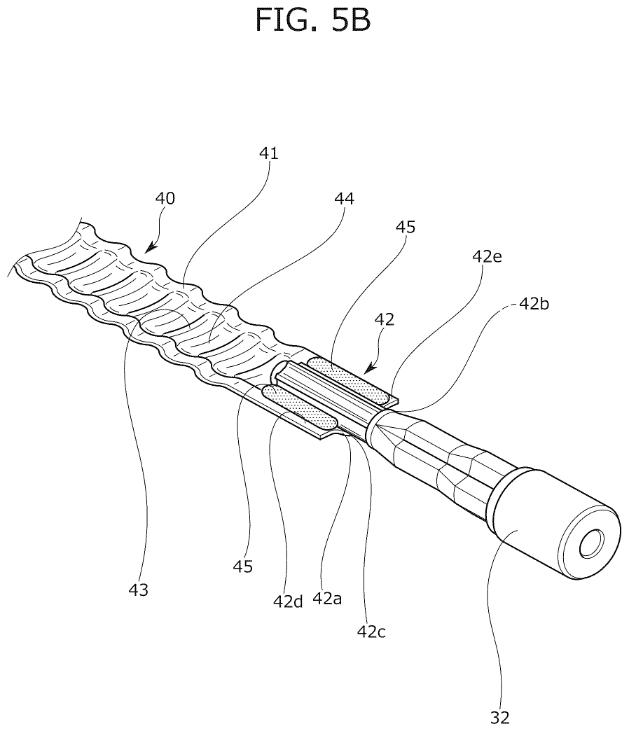

In the above-described configuration, as shown in FIGS. 5A and 5B, the extending portion of the rotating shaft 32 is accommodated in a region surrounded by the pair of facing wall portions 42a and 42b and the connecting wall portion 42c.

For this reason, the rotating shaft 32 can be easily assembled to the connecting member 40 (shaft attachment portion 42). In addition, the connecting member 40 can suitably hold the rotating shaft 32.

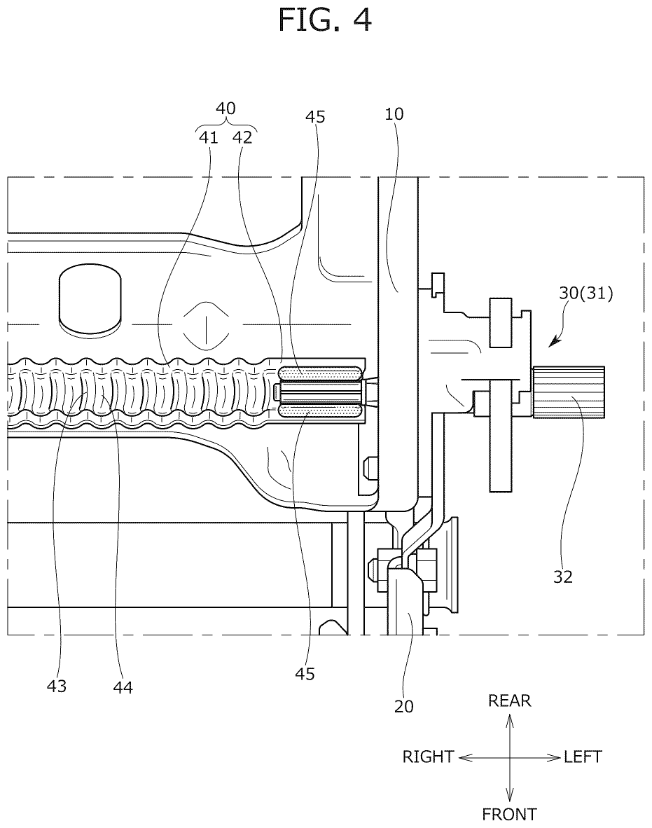

In addition, in the above-described configuration, as shown in FIGS. 4, 5A, and 5B, the shaft attachment portion 42 and the rotating shaft 32 are welded in a contact state, so that welding marks 45 are formed on the shaft attachment portion 42. A plurality of the welding marks 45 are formed with predetermined distances therebetween in the seat front to rear direction, and each extends along the rotating shaft 32. In other words, the plurality of welding marks 45 are provided to sandwich the extending portion of the rotating shaft 32 therebetween in the seat front to rear direction.

For this reason, the rotating shaft 32 can be firmly assembled to the connecting member 40. Particularly, the twisting rigidity of the connecting member 40 can be increased. In addition, the rotating shaft 32 can be easily assembled.

In addition, in the above-described configuration, as shown in FIGS. 5A and 5B, the connecting body portion 41 has a bellows shape since the reinforcement protrusions 43 and the reinforcement recesses 44 are formed in the extending direction of the connecting body portion 41.

For this reason, the connecting member 40 can be manufactured by press forming. Moreover, the rigidity of the connecting member 40 can be increased.

Incidentally, since consideration is not given to a significant increase in the size of the connecting member 40 in order to increase the rigidity of the connecting member 40, interference between the connecting member 40 and other components when the seat back 1 rotationally operates can be suppressed.

With the above configuration, the conveyance seat S capable of suppressing the manufacturing cost of the reclining device 30 while ensuring the rigidity of the reclining device 30 (connecting member 40) can be realized.

### First to Fourth Modification Examples of Connecting Member

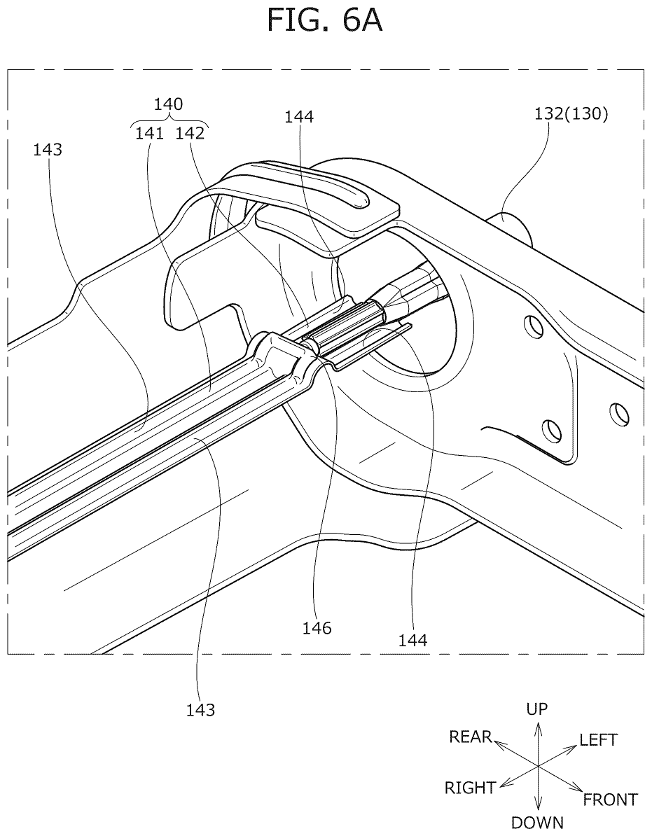

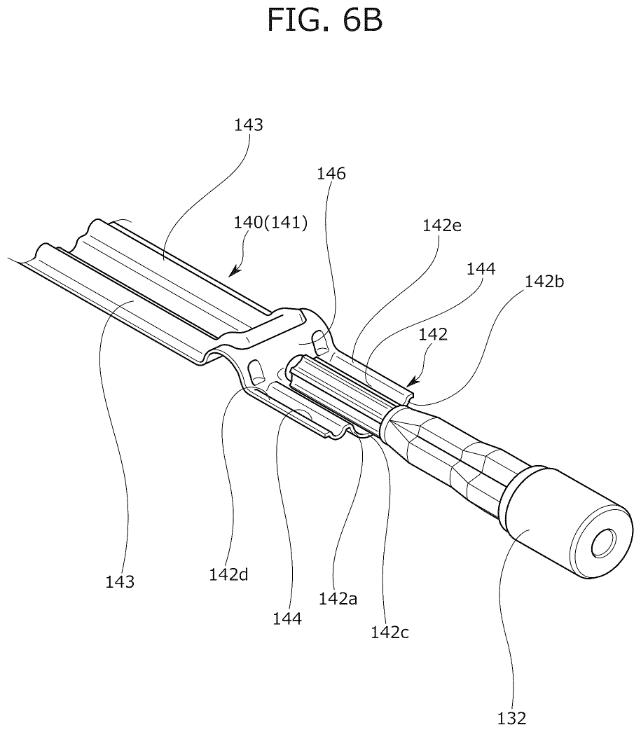

Next, first to fourth modification examples of the connecting member will be described with reference to FIGS. 6A to 9B.

Incidentally, the description of contents that overlap with those of the connecting member 40 described above will be omitted. In addition, the illustration of welding marks is omitted in FIGS. 6A to 9B.

As shown in FIGS. 6A and 6B, a connecting member 140 of the first modification example is, for example, formed by press forming, and mainly includes a connecting body portion 141 that is long in the seat width direction, and shaft attachment portions 142.

The connecting body portion 141 includes reinforcement protrusions 143 formed as substantially semicircular protrusions on an outer surface of the connecting body portion 141, and extending along an extending direction of the connecting member 140. A plurality of the reinforcement protrusions 143 are formed with predetermined distances therebetween in the seat front to rear direction.

The shaft attachment portion 142 has an open cross-sectional shape in which an opening portion is formed on an upper side thereof, and surrounds and supports an extending portion of a rotating shaft 132.

Specifically, the shaft attachment portion 142 includes a pair of facing wall portions 142a and 142b; a connecting wall portion 142c; and a first flange portion 142d and a second flange portion 142e.

A reinforcement recess 144 having a recessed shape and extending along the extending direction of the connecting member 140 is formed on an outer surface of the first flange portion 142d. Similarly, the reinforcement recess 144 is also formed on an outer surface of the second flange portion 142e.

In addition, the shaft attachment portion 142 includes a positioning portion 146 that is formed as a protrusion on an outer surface of the shaft attachment portion 142, and that positions the rotating shaft 132 by allowing an extending end portion of the rotating shaft 132 to come into contact with the positioning portion 146.

The positioning portion 146 is formed at an inner end portion in the seat width direction of the shaft attachment portion 142, and extends in a direction intersecting (direction orthogonal to) the extending direction of the connecting member 140.

For this reason, the rotating shaft 132 can be easily assembled by abutting the rotating shaft 132 against the positioning portion 146 from the outside in the seat width direction.

Even with the above-described configuration, a conveyance seat capable of ensuring the rigidity of the connecting member 140 and suppressing manufacturing cost can be realized.

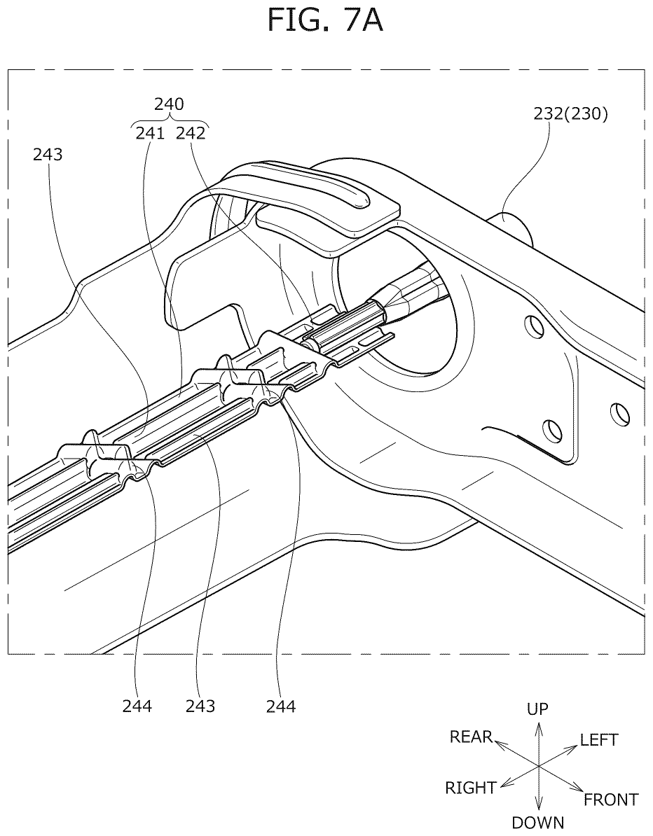

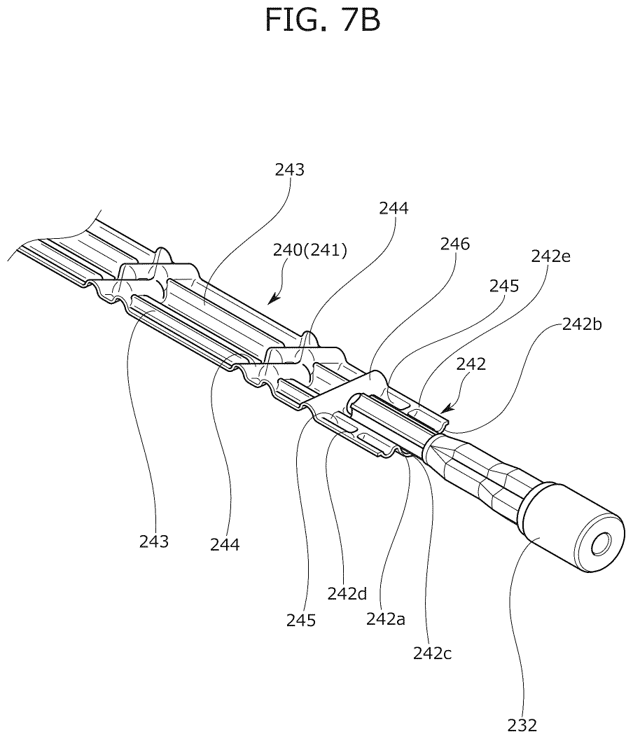

As shown in FIGS. 7A and 7B, a connecting member 240 of the second modification example is, for example, formed by press forming, and mainly includes a connecting body portion 241 that is long in the seat width direction, and shaft attachment portions 242.

The connecting body portion 241 includes reinforcement protrusions 243 formed as protrusions on an outer surface of the connecting body portion 241, and extending along an extending direction of the connecting member 240. A plurality of the reinforcement protrusions 243 are formed with distances therebetween in the seat front to rear direction.

In addition, the connecting body portion 241 includes second reinforcement protrusions 244 formed as protrusions on the outer surface of the connecting body portion 241, and formed in an X shape. A plurality of the second reinforcement protrusions 244 are formed adjacent to each other in the seat front to rear direction, and are formed with distances therebetween in the seat width direction.

The shaft attachment portion 242 has an open cross-sectional shape in which an opening portion is formed on an upper side thereof, and surrounds and holds an extending portion of a rotating shaft 232.

The shaft attachment portion 242 includes a pair of facing wall portions 242a and 242b, a connecting wall portion 242c, and a first flange portion 242d and a second flange portion 242e.

Reinforcement recesses 245 having a recessed shape are formed on an outer surface of each of the first flange portion 242d and the second flange portion 242e.

In addition, the shaft attachment portion 242 includes a positioning portion 246 that is formed as a protrusion on an outer surface of the shaft attachment portion 242, and that positions the rotating shaft 232 by allowing an extending end portion of the rotating shaft 232 to come into contact with the positioning portion 246.

Even with the above-described configuration, a conveyance seat capable of ensuring the rigidity of the connecting member 240 and suppressing manufacturing cost can be realized.

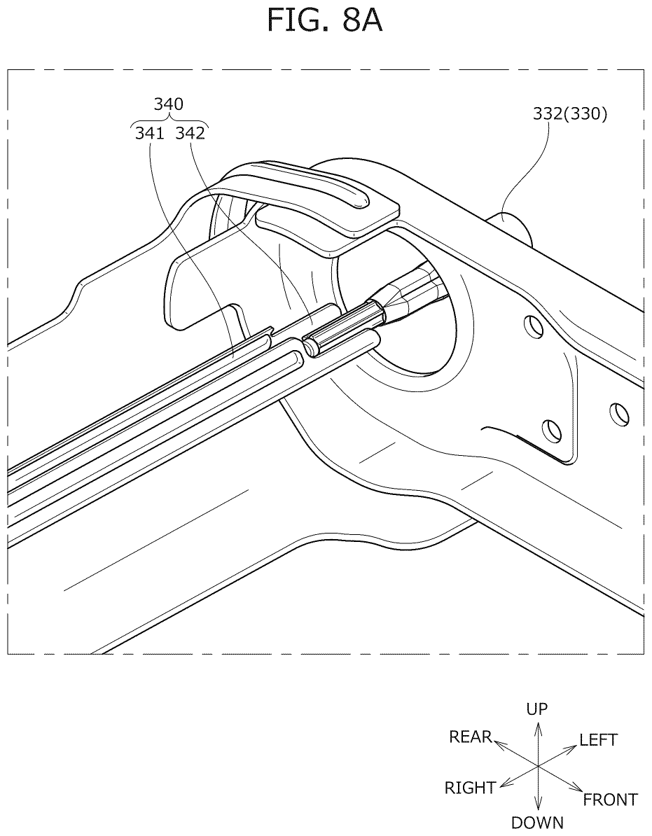

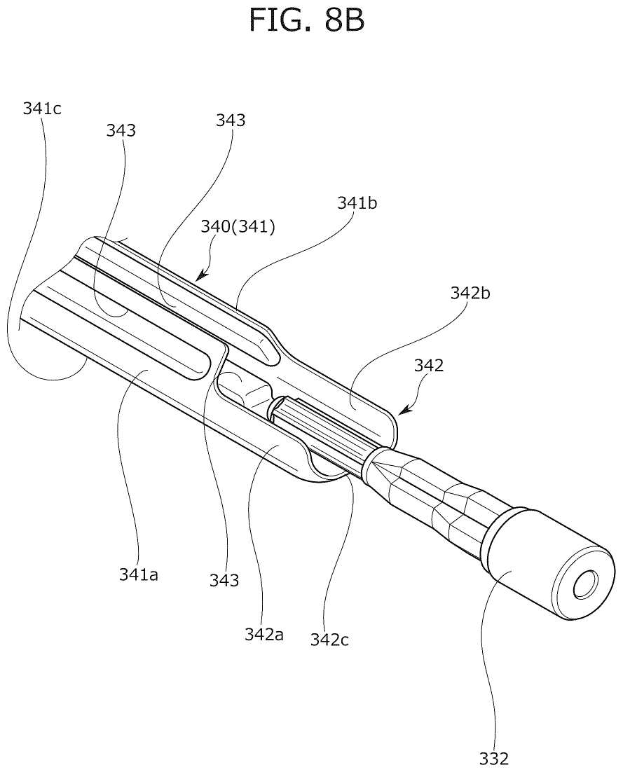

As shown in FIGS. 8A and 8B, a connecting member 340 of the third modification example is, for example, formed by bending a plate-shaped member through press forming, and mainly includes a connecting body portion 341 that is long in the seat width direction, and shaft attachment portions 342.

The connecting body portion 341 has an open cross-sectional shape in which an opening portion is formed on an upper side thereof, and has a substantially triangular cross-sectional shape.

Specifically, the connecting body portion 341 includes a pair of facing wall portions 341a and 341b and a connecting wall portion 341c connecting lower end portions of the pair of facing wall portions 341a and 341b.

The pair of facing wall portions 341a and 341b are inclined upward to approach each other from a lower side toward an upper side.

Reinforcement protrusions 343 having a protrusion shape and extending along an extending direction of the connecting member 340 are formed on an outer surface of each of the pair of facing wall portions 341a and 341b and the connecting wall portion 341c.

The shaft attachment portion 342 has an open cross-sectional shape in which an opening portion is formed on an upper side thereof, and surrounds and supports an extending portion of a rotating shaft 332.

Specifically, the shaft attachment portion 342 includes a pair of facing wall portions 342a and 342b and a connecting wall portion 342c.

In the above-described configuration, the opening portion of the connecting body portion 341 and the opening portion of the shaft attachment portion 342 are formed to face the same side. For this reason, the connecting member 340 can be made into a simple shape and manufacturing cost can be suppressed.

Even with the above-described configuration, a conveyance seat capable of ensuring the rigidity of the connecting member 340 and suppressing manufacturing cost can be realized.

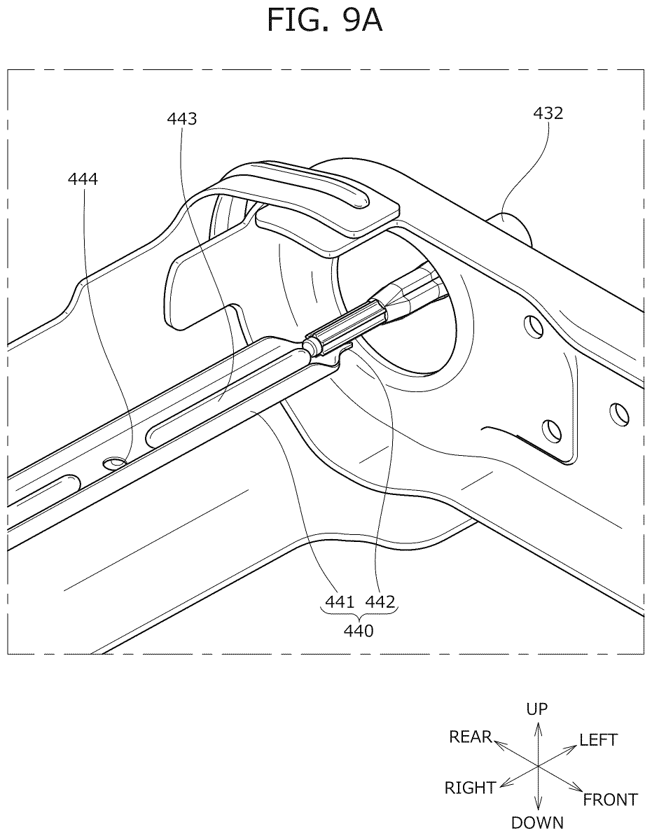

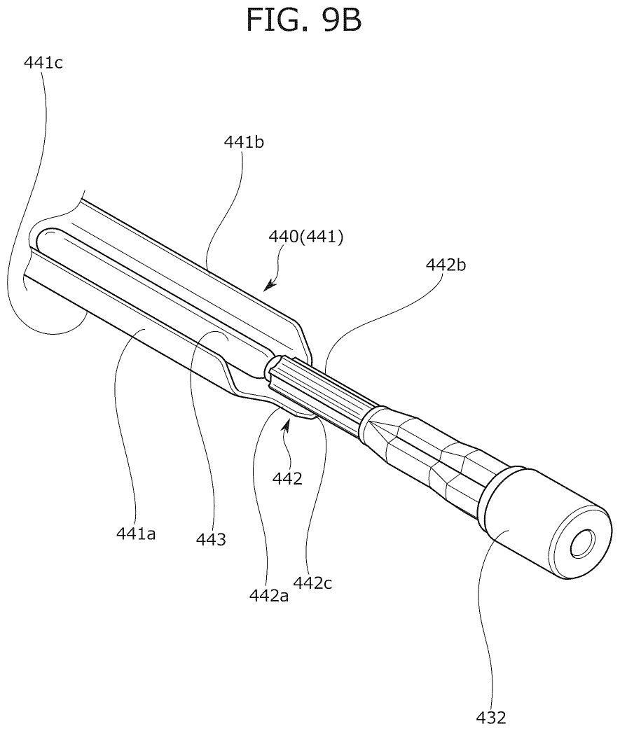

As shown in FIGS. 9A and 9B, a connecting member 440 of the fourth modification example is, for example, formed by bending a plate-shaped member through press forming, and mainly includes a connecting body portion 441 that is long in the seat width direction, and shaft attachment portions 442.

The connecting body portion 441 has an open cross-sectional shape in which an opening portion is formed on an upper side thereof, and has a substantially U-shaped cross section.

Specifically, the connecting body portion 441 includes a pair of facing wall portions 441a and 441b and a connecting wall portion 441c connecting lower end portions of the pair of facing wall portions 441a and 441b.

Each of the pair of facing wall portions 441a and 441b extends along the up to down direction. In other words, the facing wall portions 441a and 441b stand straight up from the connecting wall portion 441c.

Reinforcement protrusions 443 having a protrusion shape and extending along an extending direction of the connecting member 440 are formed on an outer surface of the connecting wall portion 441c.

A plurality of the reinforcement protrusions 443 are formed with distances therebetween in the extending direction. Further, a through hole 444 is formed between the plurality of reinforcement protrusions 443 to reduce the weight of the connecting member 440.

The shaft attachment portion 442 has an open cross-sectional shape in which an opening portion is formed on an upper side thereof, and surrounds and supports an extending portion of a rotating shaft 432.

Specifically, the shaft attachment portion 442 includes a pair of facing wall portions 442a and 442b and a connecting wall portion 442c.

In the above-described configuration, when the rotating shaft 432 is attached to the connecting member 440, an extending end portion of the rotating shaft 432 comes into contact with the reinforcement protrusion 443. Namely, the reinforcement protrusion 443 functions as a positioning portion that positions the rotating shaft 432.

For this reason, the rotating shaft 432 can be easily assembled.

Even with the above-described configuration, a conveyance seat capable of ensuring the rigidity of the connecting member 440 and suppressing manufacturing cost can be realized.

### Others

In the above-described embodiment, as shown in FIG. 3, the connecting member 40 is a component of the reclining device 30; however, such a configuration can be changed without being particularly limited.

For example, the connecting member 40 may be a component of the height link device 4, and may be adopted as a connecting member connecting right and left rotating shafts (not shown) of the height link device 4.

In addition, for example, the connecting member 40 may be a component of the slide rail device 3, and may be adopted as a connecting member connecting the right and left upper rails 3b.

In addition, the connecting member 40 may be a component of an ottoman device.

In the above-described embodiment, as shown in FIGS. 3 and 4, the shaft attachment portion 42 has an open cross-sectional shape in which an opening portion is formed on an upper side thereof; however, such a configuration can be changed without being particularly limited.

For example, the shaft attachment portion 42 may have an open cross-sectional shape in which an opening portion is formed on a lower side, front side, or rear side thereof.

In addition, for example, the shaft attachment portion 42 may have an open cross-sectional shape in which an opening portion is formed on a diagonally lower front side, diagonally upper front side, diagonally lower rear side, or diagonally upper rear side thereof.

Namely, the shaft attachment portion 42 may “have an open cross-sectional shape in which an opening portion is formed on one side in the up to down direction or on one side in the seat front to rear direction”. This implication includes all the configurations described above.

In the above-described embodiment, as shown in FIG. 5B, the rotating shaft 32 is attached to the shaft attachment portion 42 by welding; however, the method can be changed without being limited to attaching means using welding.

For example, the rotating shaft 32 may be attached to the shaft attachment portion 42 using an adhesive agent.

### Second Embodiment

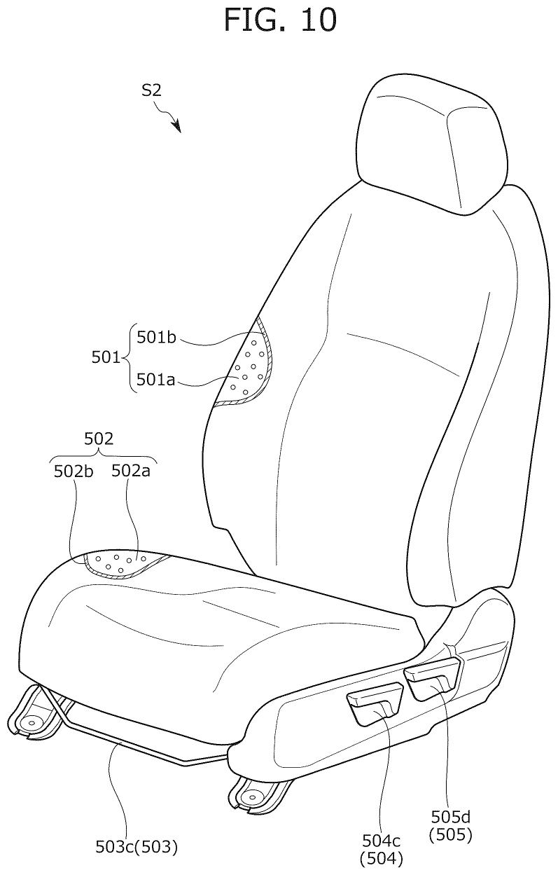

Next, a conveyance seat S2 of a second embodiment will be described with reference to FIGS. 10 to 13.

Incidentally, the description of contents that overlap with those of the conveyance seat 51 described above will be omitted.

The conveyance seat S2 can suppress the manufacturing cost of a seat frame serving as a skeleton while ensuring the rigidity of the seat frame.

In addition, the manufacturing cost of the seat frame can be suppressed by manufacturing frame components through press forming.

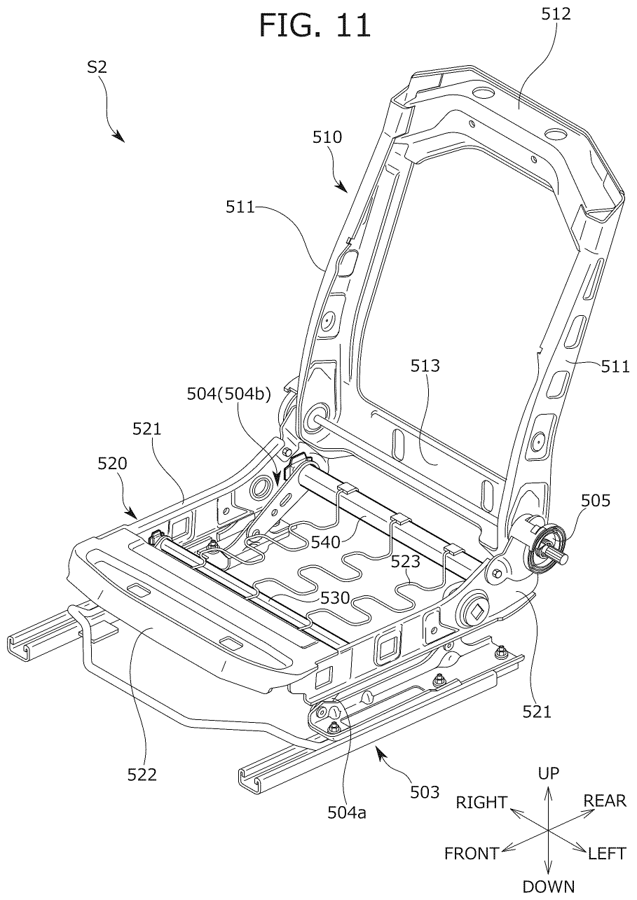

The conveyance seat S2 is, as shown in FIG. 10, a vehicle seat, and mainly includes a seat body including a seat back 501 and a seat cushion 502, and as shown in FIG. 11, a rail device 503 that supports the seat body so as to be movable forward and rearward with respect to a vehicle body floor, a height link device 504 that connects the seat body to the vehicle body floor so as to be raisable and lowerable, and a reclining device 505 that rotatably connects the seat back 501 to the seat cushion 502.

As shown in FIG. 10, the seat back 501 is a backrest portion that supports a seated occupant from behind, and is configured by placing a cushion material 501a on a back frame 510 serving as a skeleton shown in FIG. 11, and by covering the cushion material 501a with a skin material 501b.

The seat cushion 502 is a seating portion that supports the seated occupant from below, and is configured by placing a cushion material 502a on a cushion frame 520 serving as a skeleton shown in FIG. 11, and by covering the cushion material 502a with a skin material 502b.

As shown in FIG. 11, the back frame 510 is formed of a substantially rectangular frame-shaped body, and mainly includes back side frames 511 disposed on right and left sides; an upper frame 512 having an inverted U shape and connecting upper end portions of the back side frames 511; a lower frame 513 having a plate shape and connecting lower end portions of the back side frames 511; and elastic springs (not shown) hooked to each of the back side frames 511 and extending in a meandering manner.

The back side frames 511 are sheet material members extending in an up to down direction and having substantially C-shaped lateral cross sections, and the lower end portions of the back side frames 511 are connected to rear end portions of side frames 521 via the reclining device 505.

As shown in FIGS. 11 to 13, the cushion frame 520 is formed of a substantially rectangular frame-shaped body, and mainly includes the side frames 521 disposed on the right and left sides and extending in a seat front to rear direction; a pan frame 522 having a plate shape and connecting front end portions of the side frames 521; a front connecting frame 530 connecting front portions of the side frames 521; a rear connecting frame 540 connecting rear portions of the side frames 521; and a plurality of elastic springs 523 hooked to the pan frame 522 and the rear connecting frame 540 and extending in a meandering manner in the seat front to rear direction.

As shown in FIGS. 11 to 13, the side frame 521 is a plate-shaped frame that is long in the seat front to rear direction, and includes a frame body portion 521a and an upper end flange portion 521b and a lower end flange portion 521c that are bent and protrude inward in a seat width direction from an upper end portion and a lower end portion of the frame body portion 521a, respectively.

In addition, the side frame 521 includes skin hook portions 521d formed by cutting and raising parts of a side surface of the side frame 521 and used for hooking terminal portions of the skin material 502b.

A plurality of the skin hook portions 521d are formed with predetermined distances therebetween in the seat front to rear direction.

Incidentally, the reclining device 505 is attached to rear end portions of the side frames 521.

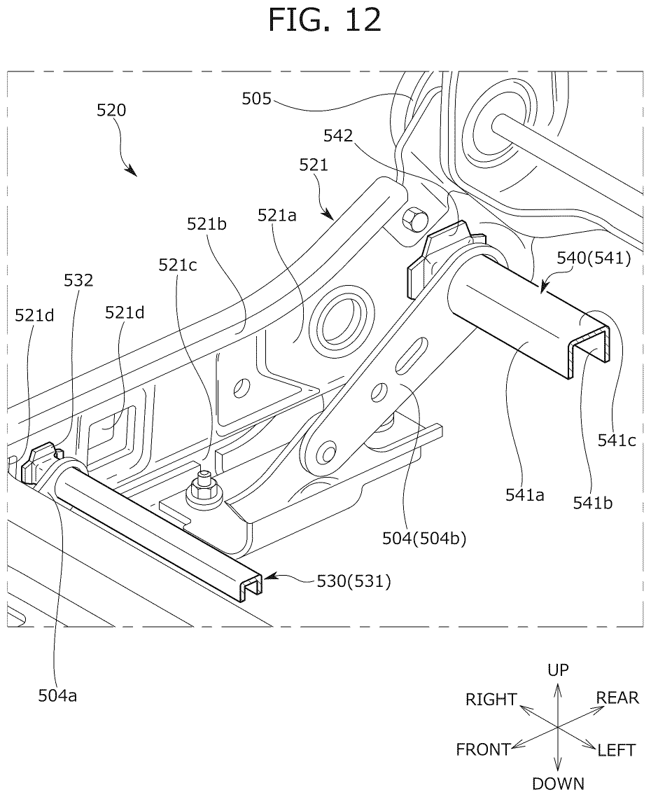

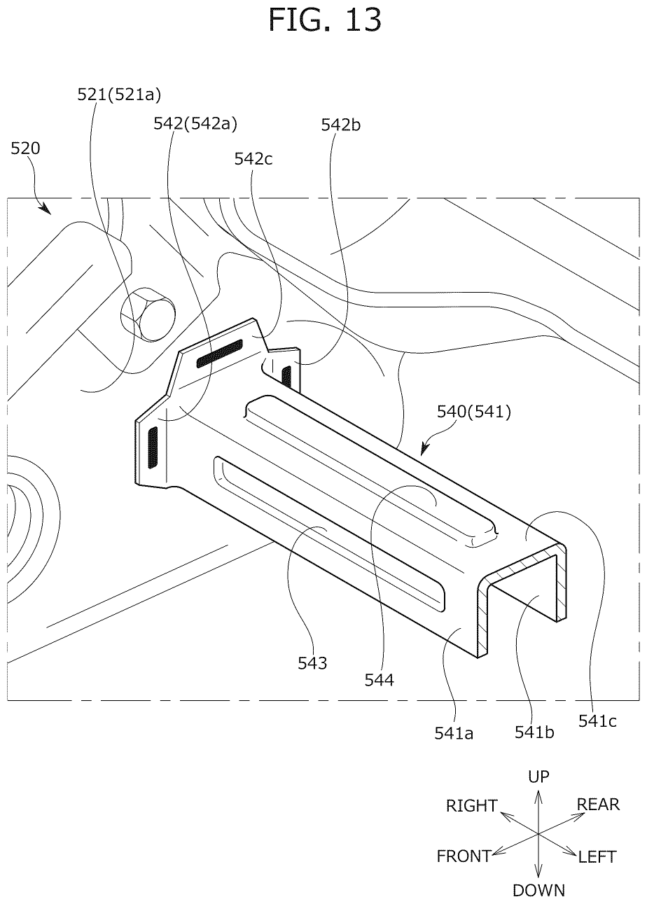

As shown in FIGS. 12 and 13, each of the front connecting frame 530 and the rear connecting frame 540 has an open cross-sectional shape in which an opening portion is formed on a lower side thereof, and is a frame that is long in the seat width direction.

The connecting frames 530 and 540 are, for example, formed from plate-shaped frames by press forming.

The connecting frames 530 and 540 connect the right and left side frames 521, and connects respective right and left links (first links 504a and second links 504b).

Specifically, the front connecting frame 530 extends long in the seat width direction, and includes a frame body portion 531 having an open cross-sectional shape and a flange portion 532 that is provided at an extending end portion of the frame body portion 531, and that is formed by cutting out so as to extend outward from the extending end portion.

Incidentally, the rear connecting frame 540 also has the same configuration, and includes a frame body portion 541 and a flange portion 542.

Hereinafter, the rear connecting frame 540 will be described in detail with reference to FIGS. 12 and 13, and details of the front connecting frame 530 will be omitted.

The frame body portion 541 includes a pair of facing wall portions 541a and 541b provided with predetermined distances therebetween in the seat front to rear direction, and a connecting wall portion 541c connecting upper end portions of the pair of facing wall portions 541a and 541b.

Reinforcement recesses 543 formed as recesses and extending along an extending direction of the rear connecting frame 540 are formed on outer surfaces of the facing wall portions 541a and 541b.

In addition, a reinforcement protrusion 544 formed as a protrusion and extending along the extending direction of the rear connecting frame 540 is formed on an outer surface of the connecting wall portion 541c.

The flange portion 542 is formed along an inner surface of the side frame 521, and is in contact with the inner surface of the side frame 521.

Specifically, the flange portion 542 includes a first flange portion 542a and a second flange portion 542b formed to extend opposite to each other from extending end portions of the pair of facing wall portions 541a and 541b, and a third flange portion 542c formed to extend outward (upward) from an extending end portion of the connecting wall portion 541c.

### Additional Notes

According to the present invention, there is provided a conveyance seat including a cushion frame serving as a skeleton of a seat cushion. It is preferable that the cushion frame includes side frames disposed on right and left sides in a seat width direction and extending in a seat front to rear direction, and a connecting frame connecting front portions or rear portions of the right and left side frames, and that the connecting frame has an open cross-sectional shape in which an opening portion is formed on one side in an up to down direction or on one side in the seat front to rear direction, and extends toward inner surfaces of the side frames.

With the above-described configuration, the conveyance seat capable of suppressing manufacturing cost while ensuring the rigidity of a seat frame can be realized.

In more detail, the connecting frame has an open cross-sectional shape in which an opening portion is formed on one side in the up to down direction or on one side in the seat front to rear direction, and extends toward the inner surfaces of the side frames. For this reason, the connecting frame can be, for example, manufactured by press forming. As a result, compared to the case of a connecting pipe of the related art, manufacturing cost can be suppressed (the connecting pipe of the related art cannot be manufactured by press forming).

Namely, while rigidity is ensured by forming the connecting frame having an open cross-sectional shape, the manufacturing cost of the connecting frame can be suppressed.

### Third Embodiment

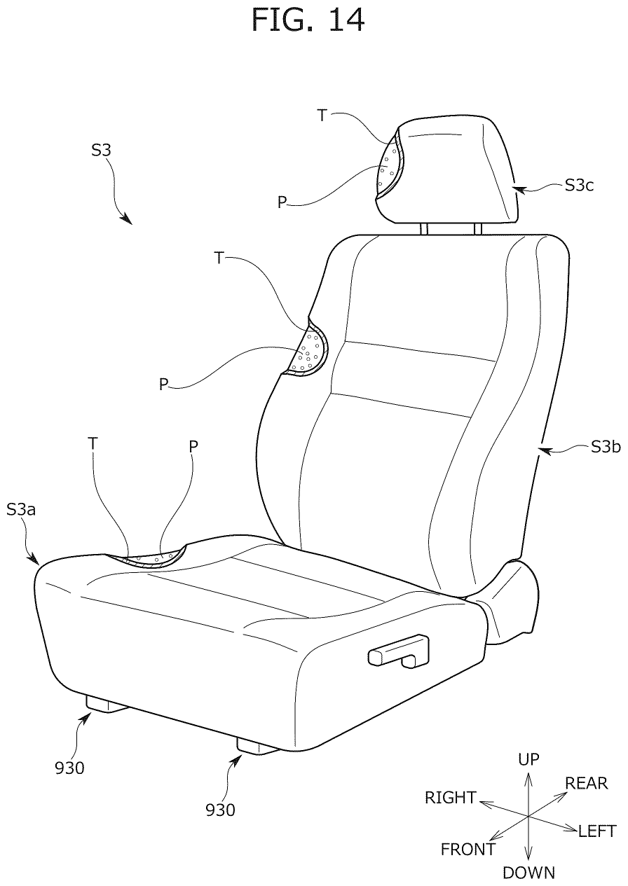

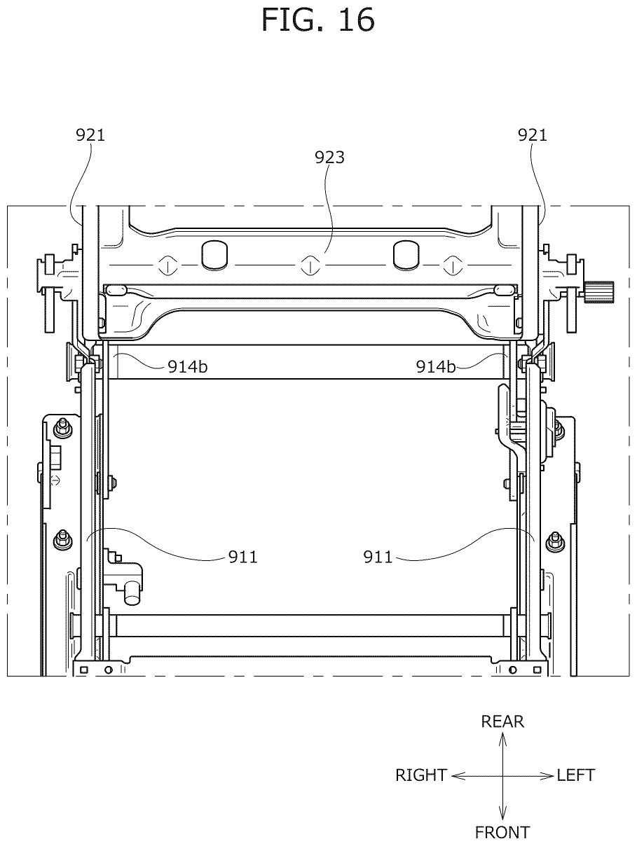

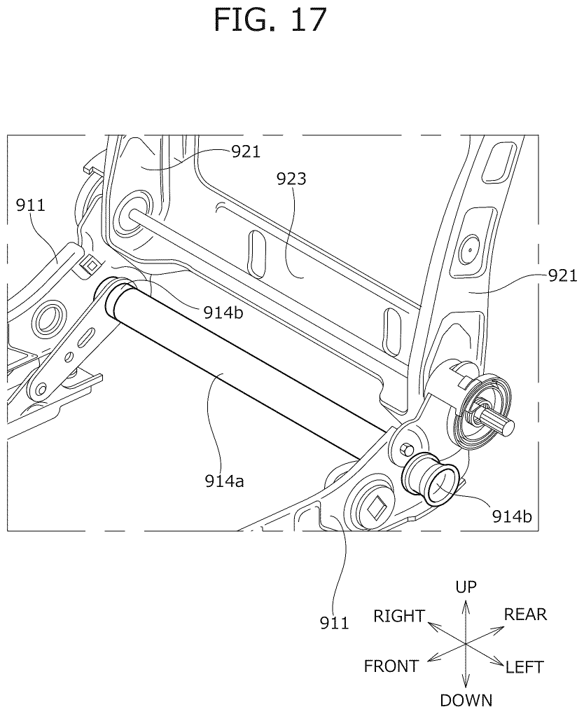

Next, a conveyance seat S3 of a third embodiment will be described with reference to FIGS. 14 to 19.

Incidentally, the description of contents that overlap with those of the conveyance seats S1 and S2 described above will be omitted.

In the conveyance seat S3, materials used for connection members in the conveyance seat can be flexibly selected.

The conveyance seat S3 includes, as main components, a seat cushion S3a serving as a seating portion that supports the buttocks of a seated occupant; a seat back S3b serving as a backrest portion that supports the back of the seated occupant; and a headrest S3c that is disposed on an upper portion of the seat back S3b and that support the head of the seated occupant.

The seat cushion S3a is configured by placing a pad member P on a seat cushion frame 910 serving as a skeleton, and by further covering the pad member P with a trim cover T. The seat back S3b is configured by placing the pad member P on a seat back frame 920, and by covering the pad member P with the trim cover T. The headrest S3c is formed by disposing the pad member P on a core material (not shown), and by covering the pad member P with the trim cover T.

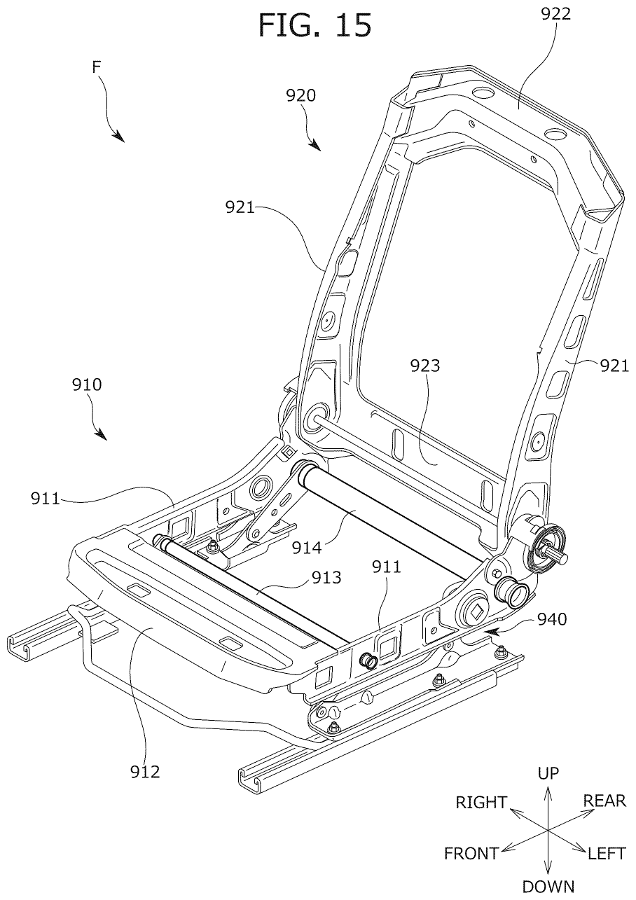

As shown in FIG. 15, a seat frame F includes, as main components, the seat cushion frame 910 serving as a skeleton of the seating portion of the seat frame F, and the seat back frame 920 serving as a skeleton of the backrest portion of the seat frame F.

Next, a configuration of the seat cushion frame 910 will be described. As shown in FIG. 15, the seat cushion frame 910 mainly includes cushion side frames 911 disposed on the right and left; a pan frame 912; a front connection pipe 913; and a rear connection pipe 914.

The cushion side frames 911 are frames extending in a seat front to rear direction. The pan frame 912 is connected to front end portions of the right and left cushion side frames 911.

The front connection pipe 913 is provided on a front side of the right and left cushion side frames 911 in a bridging manner, and the rear connection pipe 914 is provided on a rear side thereof in a bridging manner. In addition, rear end portions of the right and left cushion side frames 911 are rotatably connected to back side frames 921 of the seat back frame 920.

As shown in FIG. 15, the seat back frame 920 includes a pair of the right and left back side frames 921; an upper frame 922 that bridges between the pair of back side frames 921 in a seat width direction; and a lower frame 923 as a lower connecting frame.

In addition, slide rails 930 for moving the seat cushion S3a, the seat back S3b, and the headrest S3c in the front to rear direction in a sliding manner are disposed below the seat cushion S3a.

Further, a height adjustment mechanism 940 for adjusting the height of the seat cushion S3a is provided between the seat cushion S3a and the slide rails 930 in a height direction.

The front connection pipe 913 and the rear connection pipe 914 as connection members included in the conveyance seat S3 will be described below. Incidentally, in the following description, the front connection pipe 913 and the rear connection pipe 914 are different in diameter; however, since the front connection pipe 913 and the rear connection pipe 914 have the same shape, the rear connection pipe 914 will be described as an example. Characteristics of the rear connection pipe 914 to be described below are the same as those of the front connection pipe 913.

As shown in FIGS. 15 to 17, the rear connection pipe 914 connects a pair of the cushion side frames 911 in the seat width direction. The rear connection pipe 914 is formed of a central portion 914a (first portion) disposed at the center in the seat width direction, and end portions 914b (second portions) disposed at end portions.

In more detail, the rear connection pipe 914 is formed by joining the central portion 914a (first portion) made of a first material and the end portions 914b (second portion) made of a second material different from the first material, to each other at boundary portions 914c. Namely, in the conveyance seat S3, materials used for connection members can be flexibly selected for the first portion and the second portion.

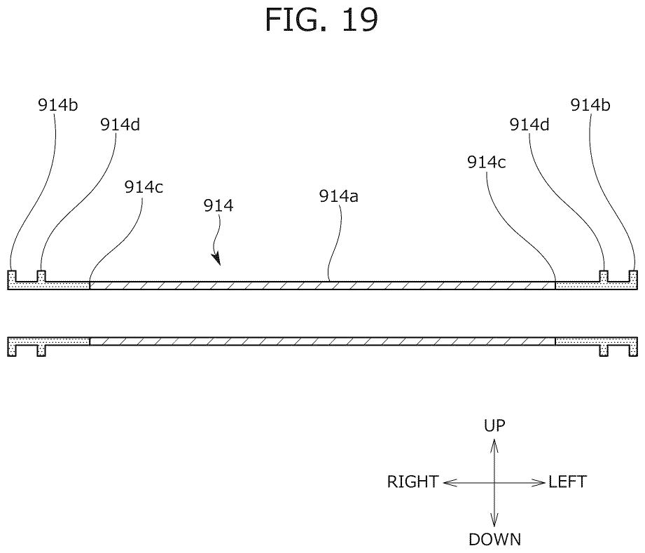

In the conveyance seat S3, the rear connection pipe 914 as a connection member is a hollow pipe member (FIG. 19). According to such a configuration, the hollow pipe member can be configured by flexibly selecting the first material or the second material, and by joining the central portion 914a (first portion) and the end portions 914b (second portion).

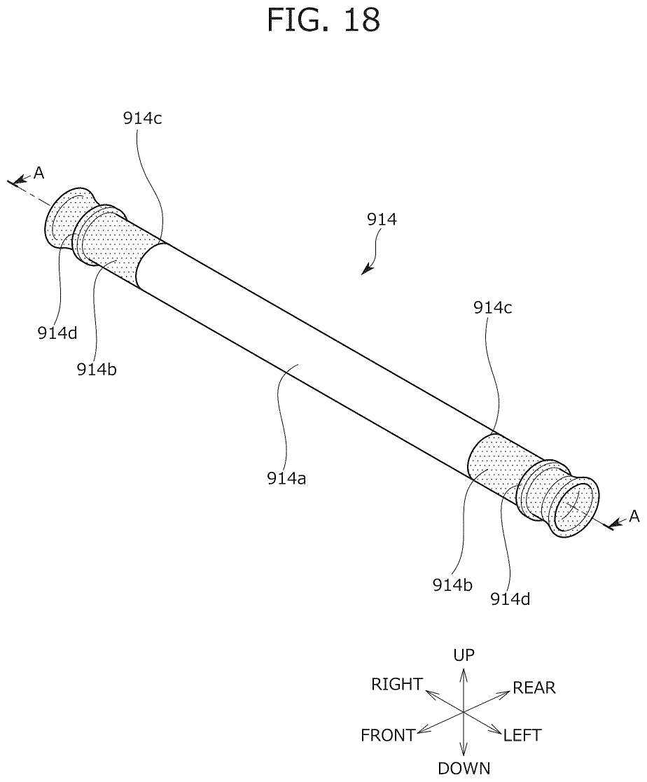

As shown in FIGS. 18 and 19, the end portion 914b (second portion) includes a contact portion 914d that comes into contact with the cushion side frame 911. The contact portion 914d protrudes from an outer surface of the end portion 914b, and has a larger outer shape than the central portion 914a. Due to the presence of the contact portion 914d, the rear connection pipe 914 can be disposed at an appropriate position with respect to the cushion side frame 911.

### (Regarding Mode of Joining First Portion and Second Portion)

As shown in a cross-sectional view of FIG. 19, the central portion 914a and the end portions 914b are joined at the boundary portions 914c in a state where end surfaces of the central portion 914a and the end portions 914b abut against each other. A method for joining the central portion 914a and the end portions 914b at the boundary portions 914c is not particularly limited, and examples of the method include welding, press-fitting, adhesion, friction welding, and the like. For example, the central portion 914a and the end portions 914b may be joined at the boundary portions 914c by welding along an entire periphery in a state where the end surfaces of the central portion 914a and the end portions 914b abut against each other.

In this case, it is preferable that the central portion 914a and the end portions 914b are joined by a dissimilar material joining technique using plastic flow. Specifically, it is preferable that the central portion 914a and the end portions 914b are joined through plastic flow at the boundary portions 914c. In other words, it is preferable that the first material and the second material having different mechanical strengths are joined through plastic flow at the boundary portions 914c. When the first material and the second material that are dissimilar materials form a joint through plastic flow, a firm joint is realized.

### Additional Notes

According to the present invention, there is provided a conveyance seat including a seat cushion. It is preferable that the seat cushion includes a seat cushion frame serving as a skeleton and a connection member, that the seat cushion frame includes a pair of side frames separated from each other in a width direction of the conveyance seat, that the pair of side frames are connected by the connection member, and that the connection member is formed by joining a first portion made of a first material and a second portion made of a second material different from the first material.

In the conveyance seat of the present invention configured as described above, materials used for the connection member in the conveyance seat can be flexibly selected for the first portion and the second portion.

### Fourth Embodiment

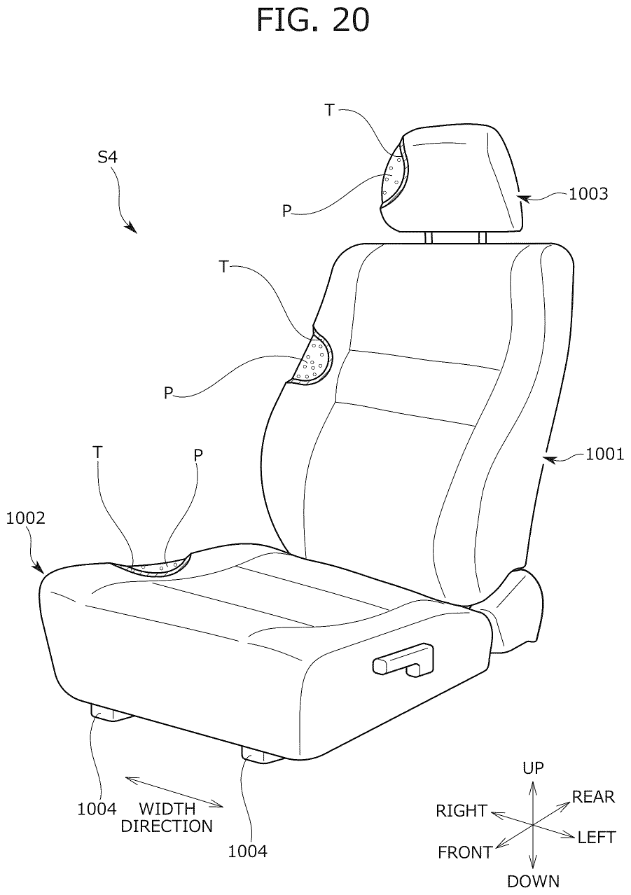

Next, a conveyance seat S4 of a fourth embodiment will be described with reference to FIGS. 20 to 28.

Incidentally, the description of contents that overlap with those of the conveyance seats S1 to S3 described above will be omitted.

The conveyance seat S4 realizes a seat including a seat back in which a headrest guide is fixed to a seat back frame using a relatively simple structure.

A basic configuration of the conveyance seat S4 will be described with reference to FIG. 20. FIG. 20 is a perspective view of the conveyance seat S4, and in FIG. 20, for convenience of illustration, a part of the conveyance seat S4 is shown with a cushion trim cover T or a pad P removed.

The conveyance seat S4 is a seat which is placed on a vehicle body floor and in which an occupant of a vehicle is seated. In the present embodiment, the conveyance seat S4 is used as a front seat corresponding to a front seat of the vehicle. However, the conveyance seat S4 is not limited to the front seat, and can also be used as a seat for a rear seat, and can also be used as a middle seat in a second row or a rear seat in a third row in a vehicle including three rows of seats in a front to rear direction.

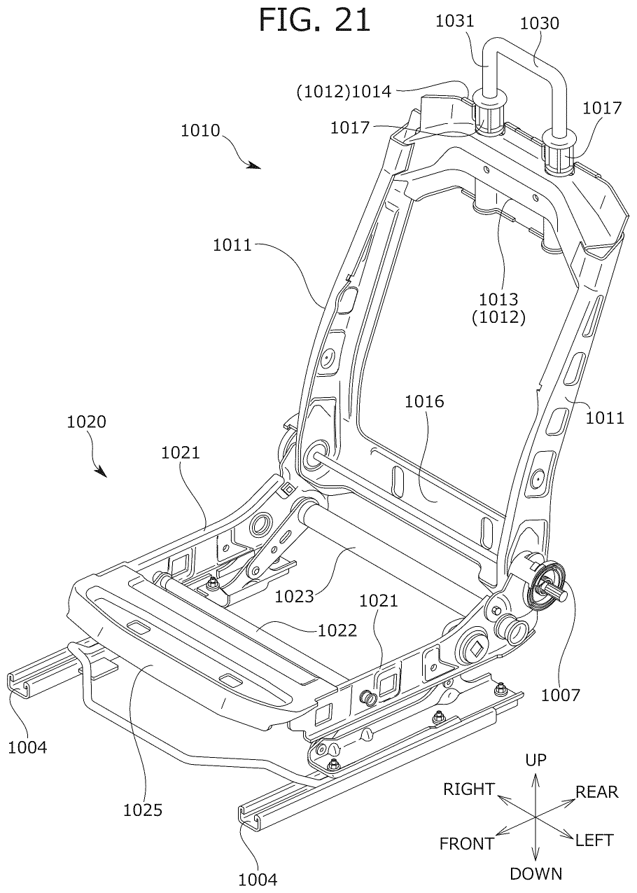

As illustrated in FIG. 20, the conveyance seat S4 includes, as main components, a seat back 1001 serving as a backrest portion that supports the back of the seated occupant; a seat cushion 1002 serving as a seating portion that supports the buttocks of the seated occupant; and a headrest 1003 that is disposed on an upper portion of the seat back 1001 and that supports the head of the seated occupant. The seat back 1001 and the seat cushion 1002 are connected to sandwich a reclining mechanism 1007 (refer to FIG. 21) therebetween. The seat back 1001 is connected to be rotatable and adjustable in angle with respect to the seat cushion 1002. The reclining mechanism 1007 adjusts an inclination angle of the seat back 1001.

As shown in FIG. 21, the seat frame F is provided in the conveyance seat S4, and the seat frame F includes a seat back frame 1010 forming a skeleton of the seat back 1001, and a seat cushion frame 1020 forming a skeleton of the seat cushion 1002.

Hereinafter, first, configurations such as the seat cushion frame 1020 other than the seat back frame 1010 will be described, and details of the seat back frame 1010 will be described thereafter.

The seat cushion frame 1020 is formed in a square frame shape, and cushion side frames 1021 are provided at side portions of the seat cushion frame 1020. In addition, the seat cushion frame 1020 includes a front connecting frame 1022 connecting the cushion side frames 1021 in the front, and a rear connecting frame 1023 connecting the cushion side frames 1021 in the rear. The front connecting frame 1022 and the rear connecting frame 1023 located in the front and rear of the conveyance seat S4 are formed of round pipes. In addition, a cushion pan frame 1024 is provided in front of the front connecting frame 1022. Incidentally, although not shown, a pressure receiving member that spans between the cushion pan frame 1024 and the rear connecting frame 1023 is attached, and the pressure receiving member supports the buttocks of the seated occupant from below.

The headrest 1003 is attached to the upper portion of the seat back 1001 so as to support the head of the seated occupant. Inside the headrest 1003, a headrest frame 1030 forming a skeleton of the headrest 1003 is provided, and two headrest stays 1031 (also referred to as headrest pillars) hanging down from a lower portion of the headrest 1003 are provided at both right and left ends of the headrest frame 1030. By inserting the headrest stays 1031 into headrest guides 1017 attached to an upper frame 1012 of the seat back frame 1010 to be described later, the headrest 1003 is attached to the seat back frame 1010.

The seat back 1001, the seat cushion 1002, and the headrest 1003 are configured by providing the pads P and the cushion trim covers T (cushion covers) on outer sides of the seat back frame 1010, the seat cushion frame, and the headrest frame 1030. The pad P is, for example, a urethane base material molded by foam molding using a urethane foam material, and the cushion trim cover T is made of, for example, a skin material such as cloth, synthetic leather, or genuine leather.

In addition, as shown in FIG. 21, a slide rail 1004 is installed at a lower portion of the conveyance seat S4. The conveyance seat S4 is attached to a vehicle body floor BF in a state where the conveyance seat S4 is movable in a sliding manner in the front to rear direction by the slide rail 1004.

The slide rail 1004 is a device that moves the conveyance seat S4 in a sliding manner along the front to rear direction, and has a known structure (structure of a general slide rail mechanism). The slide rail 1004 includes lower rails fixed onto the vehicle body floor BF, and upper rails that are movable in a sliding manner with respect to the lower rails. The upper rails are slidable with respect to the lower rails fixed to a vehicle body.

The reclining mechanism 1007 is provided between a lower end portion of the seat back 1001 and a rear end portion of the seat cushion 1002. In more detail, the reclining mechanism 1007 connects the seat back frame 1010 of the seat back 1001 and the seat cushion frame 1020 of the seat cushion 1002. The reclining mechanism 1007 can adjust an angle of the seat back 1001 (seat back frame 1010) with respect to the seat cushion 1002 (seat cushion frame 1020). The reclining mechanism 1007 can maintain a state where the seat back 1001 is locked and inclined at a predetermined angle. In addition, the seat back 1001 can be reclined forward or rearward by releasing the locking.

Hereinafter, the seat back frame 1010 will be described with reference to FIGS. 21 to 28.

As shown in FIG. 21, the seat back frame 1010 is formed in a square frame shape as a whole, and the seat back frame 1010 includes a pair of back side frames 1011 disposed on both sides; the upper frame 1012; and a lower frame 1016. The upper frame 1012 is disposed between the pair of back side frames 1011, and connects upper ends of the back side frames 1011. The lower frame 1016 is disposed between the pair of back side frames 1011, and connects lower ends of the pair of back side frames 1011.

The headrest guide 1017 is a tubular body member provided with an insertion opening 1017a into which the headrest stay 1031 is inserted. A head portion 1017b having an outer diameter larger than a diameter of an opening portion (upper opening portion 1015a) of a holder portion 1015 of the upper frame 1012 to be described later is provided at an upper portion of the headrest guide 1017. Accordingly, even when the headrest guide 1017 is inserted into the holder portion 1015 of the upper frame 1012, the falling of the headrest guide 1017 to a lower side of the upper frame 1012 is suppressed.

Incidentally, in order to maintain the holding strength of and to suppress the wobbling of the headrest 1003, the headrest guides 1017 are made of a metal member with high strength. The headrest guides 1017 are not limited to being made of metal, and may be made of resin.

The upper frame 1012 includes a first pan frame 1013 having a plate shape and a second pan frame 1014 having a plate shape. The first pan frame 1013 is located on a front side of the seat back 1001, and the second pan frame 1014 is located on a rear side of the seat back 1001 and on a back of the first pan frame 1013.

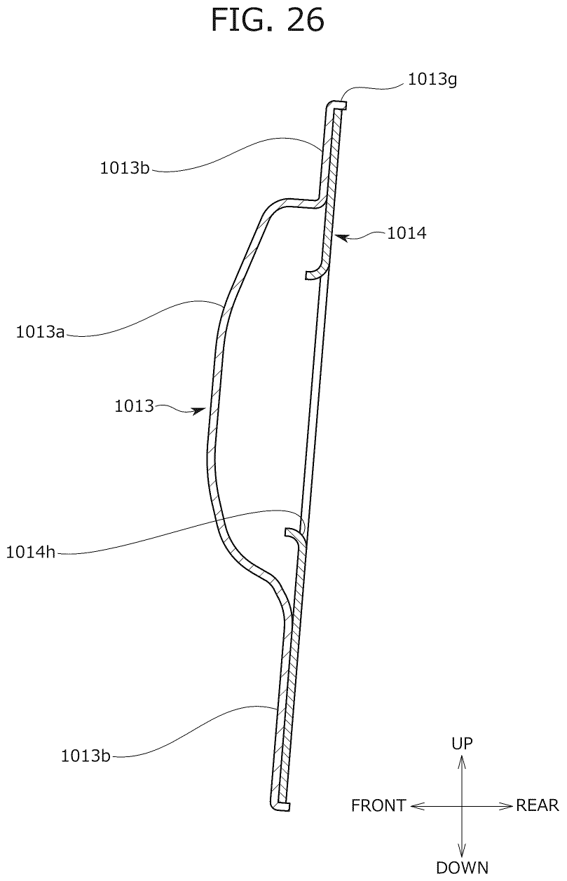

As shown in FIG. 26, the first pan frame 1013 and the second pan frame 1014 sandwich the headrest guides 1017 therebetween and support the headrest guides 1017 from the front of the seat back 1001 and the rear of the seat back 1001, respectively. The holder portion 1015 having a tubular shape and holding the headrest guide 1017 is formed by the first pan frame 1013 and the second pan frame 1014. The headrest guide 1017 is attached by inserting the headrest guide 1017 into the holder portion 1015.

A bulging portion 1013a bulging in a front direction of the seat is formed in the first pan frame 1013. The bulging portion 1013a is formed along a longitudinal direction of the first pan frame 1013 so as to extend in a width direction of the conveyance seat S4. Flange portions 1013b joined to the second pan frame 1014 are formed at end portions in an up to down direction of the bulging portion 1013a, and as shown in FIG. 26, the first pan frame 1013 is formed with a hat-shaped vertical cross section by the bulging portion 1013a and the flange portions 1013b.

Incidentally, the hat shape also includes a cap shape. In other words, the hat shape also includes a case where the flange portion 1013b extending from at least one of an upper end and a lower end of the bulging portion 1013a is formed.

In addition, in the present embodiment, only the first pan frame 1013 has a hat-shaped vertical cross section; however, the second pan frame 1014 may have a hat-shaped vertical cross section. Both the first pan frame 1013 and the second pan frame 1014 may have hat-shaped vertical cross sections, and a closed cross-sectional structure (also referred to as a monocoque structure) including a hollow portion may be formed by joining both the flange portions.

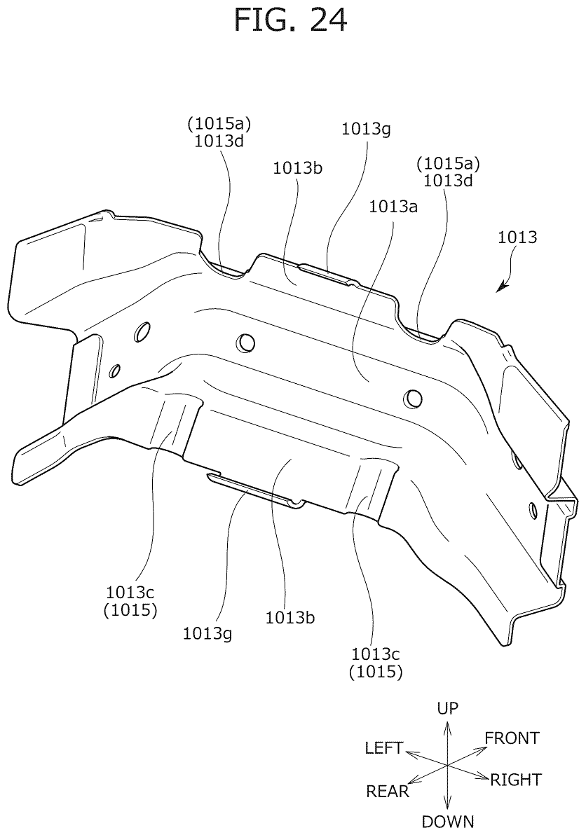

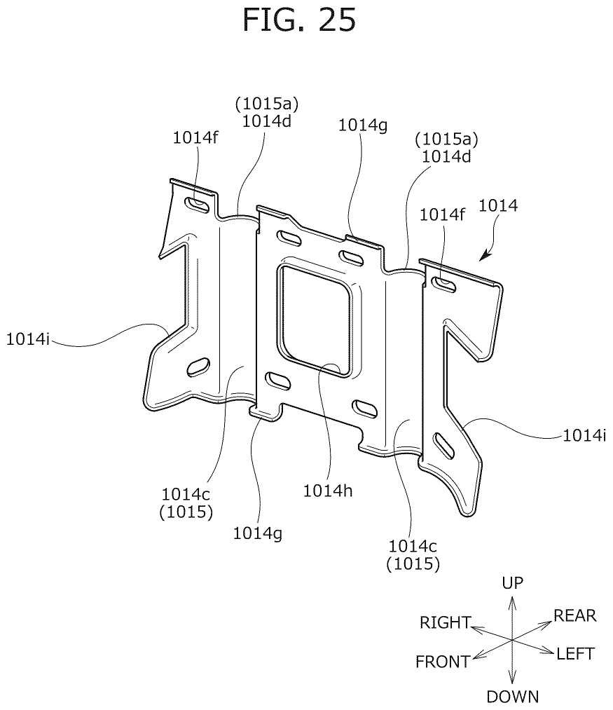

As shown in FIGS. 24 and 25, two recesses 1013c and two recesses 1014c extending in the up to down direction are formed in the first pan frame 1013 and the second pan frame 1014 at positions facing each other, respectively. The recesses 1013c and 1014c are formed to align with an outer shape of the headrest guides 1017. The holder portions 1015 holding the headrest guides 1017 are formed by disposing the recesses 1013c and the recesses 1014c to face each other, and by joining the first pan frame 1013 and the second pan frame 1014.

The holder portion 1015 forms a tubular space by means of the recess 1013c and the recess 1014c, and includes opening portions (the upper opening portion 1015a and a lower opening portion 1015b) at the top and bottom. In other words, the upper opening portion 1015a of the holder portion 1015 includes an opening portion 1013d of the recess 1013c and an opening portion 1014d of the recess 1014c shown in FIG. 24. The headrest guide 1017 is attached by being inserted from the upper opening portion 1015a of the holder portion 1015.

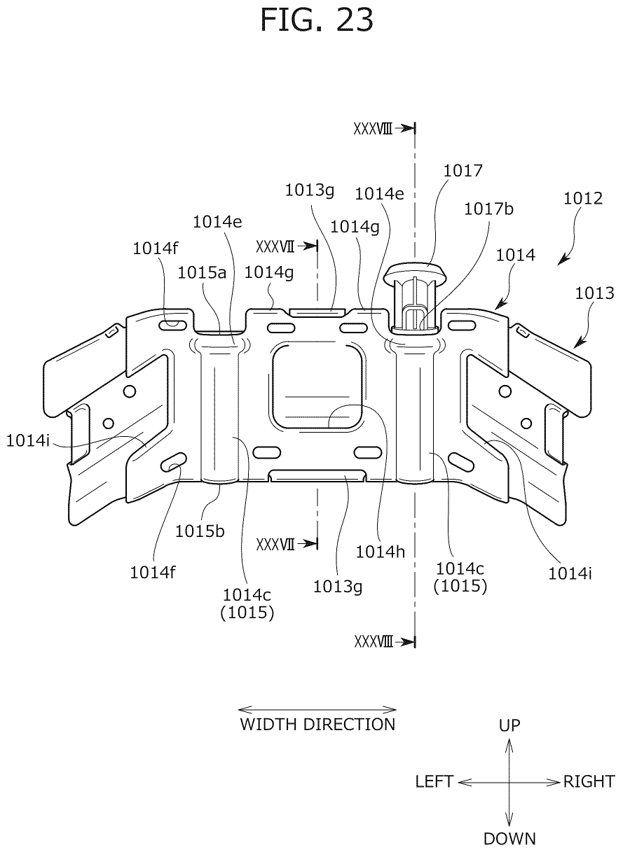

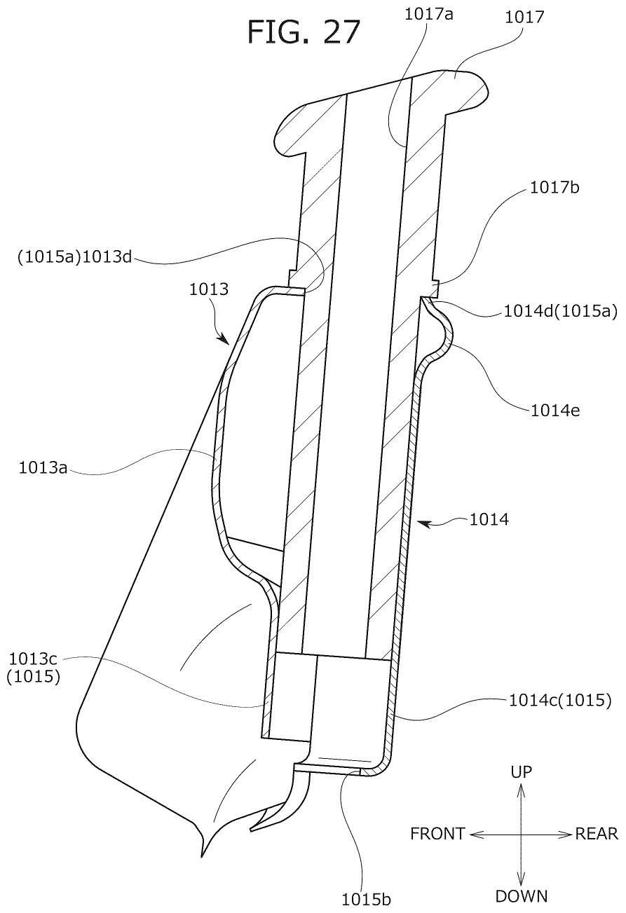

As shown in FIG. 23, in the second pan frame 1014, a flange portion 1014e is formed around the opening portion 1014d. As shown in FIG. 27, a position of the flange portion 1014e is formed at substantially the same height as that of the upper end of the bulging portion 1013a of the first pan frame 1013, and the flange portion 1014e comes into contact with the head portion 1017b of the headrest guide 1017, so that the falling of the headrest guide 1017 to the lower side of the upper frame 1012 is suppressed. In addition, a periphery of the opening portion 1014d is reinforced by providing the flange portion 1014e. Incidentally, the flange portion may be formed around the opening portion 1013d of a first pan frame 1013 side.

A hole 1014h is formed between the two recesses 1014c in the second pan frame 1014 for weight reduction. In addition, cutouts 1014i are formed on outer sides in the width direction of the recesses 1014c.

As shown in FIGS. 24 and 26, hook portions 1013g having a hook shape and hooked to an upper end and a lower end of the second pan frame are formed at parts of an upper end and a lower end of the first pan frame 1013. In addition, as shown in FIG. 25, hook portions 1014g having a hook shape are formed at the upper end and the lower end of the second pan frame 1014 at positions avoiding the hook portions 1013g of the first pan frame 1013. A misalignment in the up to down direction of the second pan frame 1014 with respect to the first pan frame 1013 can be suppressed by hooking the hook portion 1013g of the first pan frame 1013 to an end portion of the second pan frame and by hooking the hook portions 1014g of the second pan frame 1014 to an end portion of the first pan frame.

The first pan frame 1013 and the second pan frame 1014 are adhered to each other by welding. Welding is performed using a plurality of welding holes 1014f formed in the second pan frame 1014.

The first pan frame 1013 and the second pan frame 1014 may be adhered and coupled to each other by an adhesive agent. The adhesive agent is a structural adhesive agent, and it is desirable that the adhesive agent is a high-toughness type or high-viscosity type. In the case of a high-toughness type structural adhesive agent, the cracking of the adhesive agent caused by the twisting or the like of the frame can be suitably suppressed, and the durability of adhesion can be improved. In the case of a high-viscosity type, dripping during adhesion can be suppressed. As the structural adhesive agent, for example, there is one containing epoxy-based rein as a main component.

In the present embodiment, the first pan frame 1013 and the second pan frame 1014 are made of iron, and are formed by pressing a steel sheet. The first pan frame 1013 and the second pan frame 1014 are not limited to being made of iron, and the first pan frame 1013 and the second pan frame 1014 may be made of different materials.

For example, the first pan frame 1013 may be made of high tensile strength steel. Since high tensile strength steel has tension even in the case of being thin, the high tensile strength steel can be made thinner than a steel sheet, so that the weight can be reduced while rigidity is ensured. The second pan frame 1014 may be made of high tensile strength steel.

In addition, the material of the second pan frame 1014 may be resin or aluminum. The upper frame that is more inexpensive or lightweight compared to the case of being made of iron can be formed.

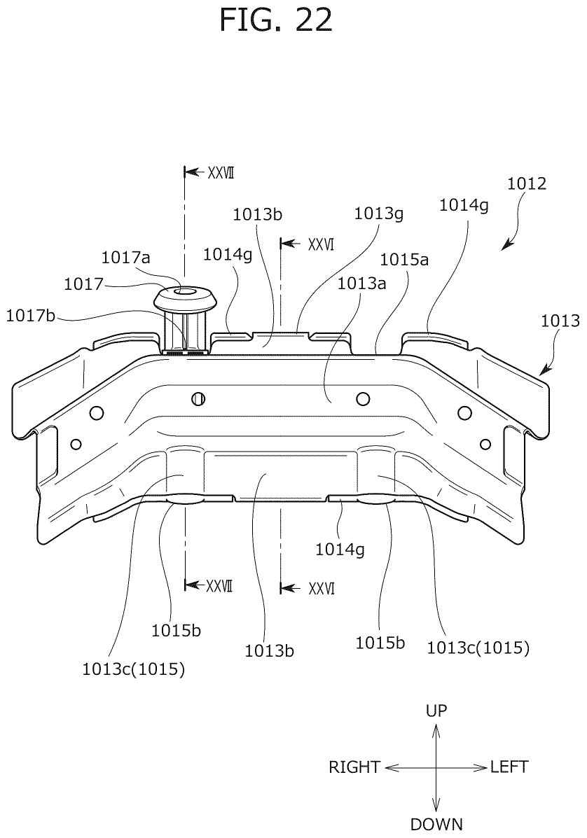

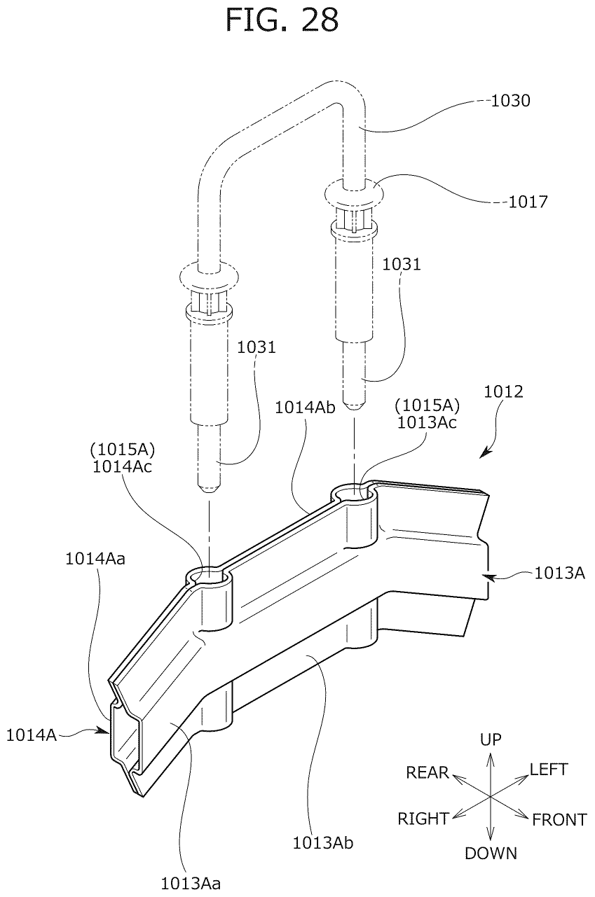

Another example of the upper frame 1012 will be described. An upper frame 1012A shown in FIG. 28 is also a member attached to an upper portion of the seat back frame 1010, and is provided to span between upper end portions of the back side frames 1011. Similarly to the upper frame 1012 shown in FIGS. 22 to 27, the headrest guides 1017 are held by sandwiching the headrest guides 1017 between a first pan frame 1013A and a second pan frame 1014A. Recesses 1013Ac and 1014Ac extending in the up to down direction are formed in the first pan frame 1013A and the second pan frame 1014A, respectively, and holder portions 1015A holding the headrest guides 1017 are formed by disposing the recesses to face each other.

Both the first pan frame 1013A and the second pan frame 1014A have hat-shaped vertical cross sections including bulging portion 1013Aa and 1014Aa and flange portions 1013Ab and 1014Ab. A closed cross-sectional structure (monocoque structure) is formed by aligning and welding the first pan frame 1013A and the second pan frame 1014A to the flange portions 1013Ab and 1014Ab, respectively, or by joining the first pan frame 1013A and the second pan frame 1014A to the flange portions 1013Ab and 1014Ab using a structural adhesive agent, respectively. In such a manner, by forming the first pan frame 1013A and the second pan frame 1014A, while the rigidity of the upper frame is maintained, the upper frame 1012A holding the headrest guides 1017 can be easily assembled.

The conveyance seat S4 of the present embodiment has been described above with reference to the drawings. Incidentally, in the present embodiment, the first pan frame 1013 has a hat-shaped vertical cross section; however, the second pan frame 1014 may be configured such that a bulging portion bulging toward the rear of the seat is provided and the vertical cross section has a hat shape.

### Additional Notes

According to the present invention, there is provided a conveyance seat including: a seat back; a headrest provided on the seat back; and a seat back frame serving as a skeleton of the seat back. It is preferable that the seat back frame includes a pair of back side frames, an upper frame connecting the pair of back side frames, and a headrest guide that holds a stay of the headrest, that the upper frame includes a first pan frame having a plate shape and a second pan frame having a plate shape, and that the first pan frame and the second pan frame sandwich the headrest guide and supports the headrest guide from a front of the seat back and a rear of the seat back, respectively.

According to the conveyance seat described above, the headrest guide is supported by sandwiching the headrest guide between the first pan frame and the second pan frame in a front to rear direction. By joining the first pan frame and the second pan frame in a state where the headrest is sandwiched therebetween in the front to rear direction, the headrest guide can also be aligned and fixed. For this reason, the headrest guide can be fixed to the seat back frame using a relatively simple structure.

In addition, in the conveyance seat described above, it is preferable that at least one of the first pan frame and the second pan frame has a hat-shaped vertical cross section.

By configuring the at least one of the first pan frame and the second pan frame to have a hat-shaped vertical cross section, the rigidity of the first pan frame and the second pan frame is improved.

In addition, in the conveyance seat described above, it is preferable that a holder portion supporting the headrest guide is formed by the first pan frame and the second pan frame through joining a flange portion of one of the first pan frame and the second pan frame to the other, the flange portion having a hat shape and the one having a hat-shaped vertical cross section.

The first pan frame and the second pan frame can be more firmly adhered to each other through adhesion using the flange portion.

In addition, in the conveyance seat described above, it is preferable that recesses extending in an up to down direction in accordance with an outer shape of the headrest guide are formed in the first pan frame and the second pan frame at positions facing each other, and that the holder portion of the upper frame is formed by the recesses of the first pan frame and the second pan frame, the recesses being disposed to face each other.

By inserting the headrest guide into the recesses disposed to face each other, a misalignment in a seat width direction of the headrest guide can be suppressed.

In addition, in the conveyance seat described above, it is preferable that in at least one of the recesses formed in the first pan frame and the second pan frame, a flange portion is formed around an opening portion into which the headrest guide is inserted.

A periphery of the opening portion is reinforced by forming the flange portion around the opening portion into which the headrest guide is inserted.

In addition, in the conveyance seat described above, it is preferable that the first pan frame and the second pan frame are joined by welding.

The first pan frame and the second pan frame are more firmly adhered to each other by being joined through welding. In addition, by joining the first pan frame and the second pan frame through welding, the headrest guide sandwiched therebetween is fixed, so that a step of fixing the headrest guide to the frame can be eliminated.

In addition, in the conveyance seat described above, it is more preferable that the first pan frame and the second pan frame are made of different materials.

One of the first pan frame and the second pan frame can be reduced in weight or can be made with high strength by being made of different materials.

In addition, in the conveyance seat described above, it is more preferable that the first pan frame and the second pan frame are adhered to each other by a structural adhesive agent.

Welding work during assembly is reduced by fixing using an adhesive agent, so that the frame can be more simply assembled.

In addition, in the conveyance seat described above, it is more preferable that the first pan frame is made of high tensile strength steel.

By making the first pan frame, which performs sandwiching from the front, out of high tensile strength steel, the frame that is more lightweight and has higher strength compared to the case of being made of iron can be formed.

In addition, in the conveyance seat described above, it is more preferable that the second pan frame is made of resin or aluminum.

By making the second pan frame out of resin or aluminum, the frame that is more inexpensive or lightweight compared to the case of being made of iron can be formed.

### Fifth Embodiment

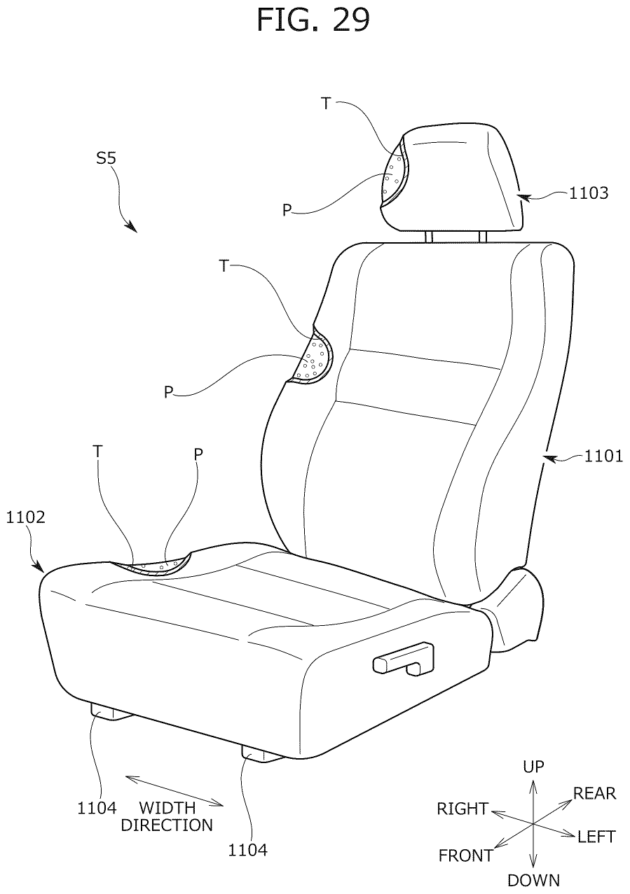

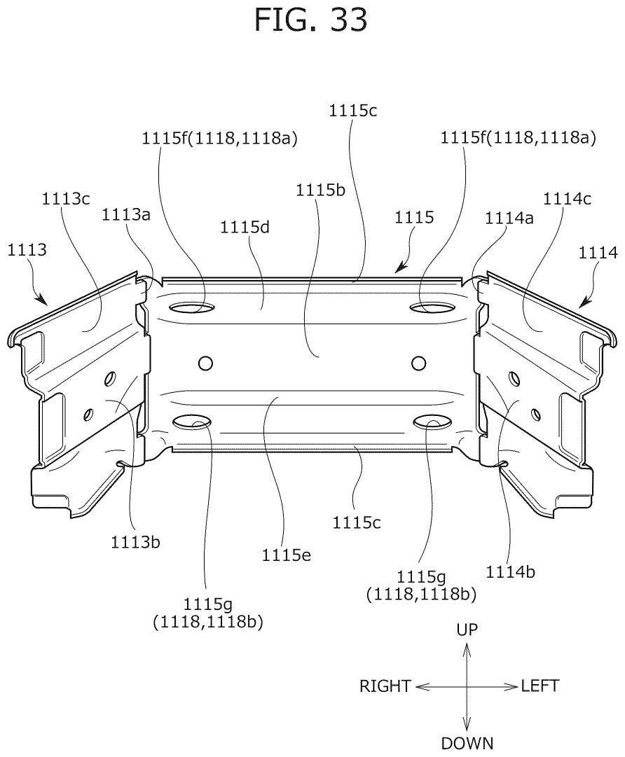

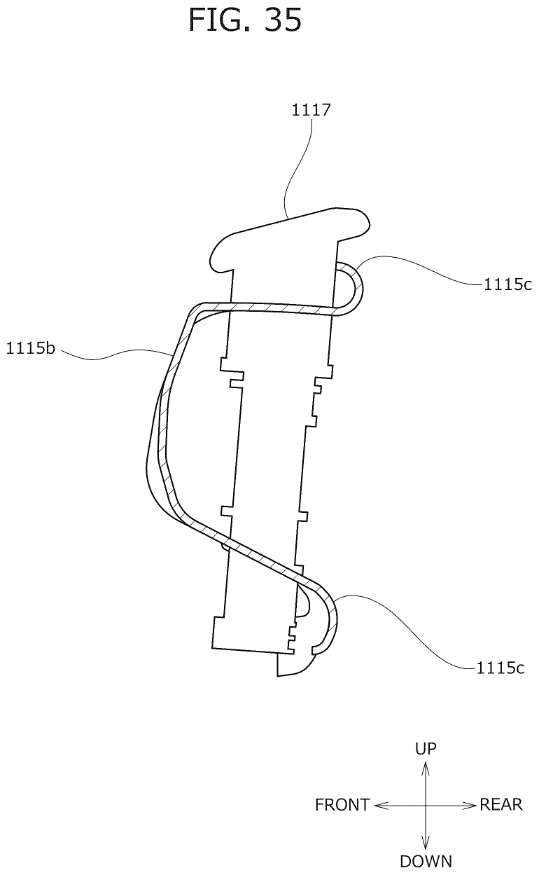

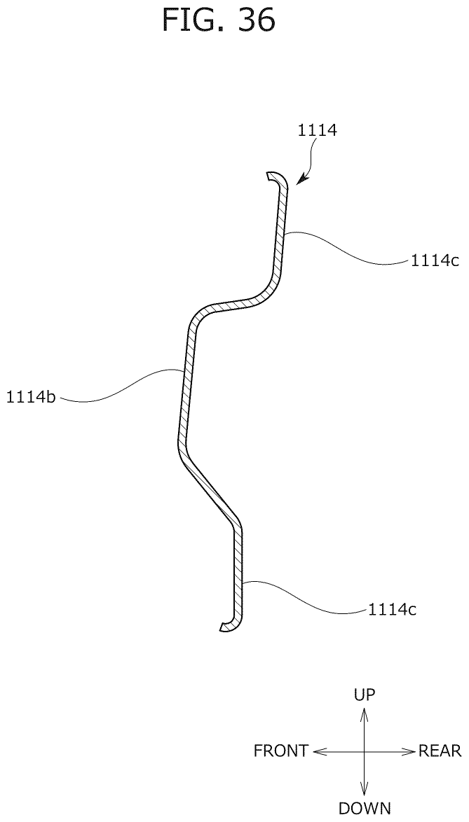

Next, a conveyance seat S5 of a fifth embodiment will be described with reference to FIGS. 29 to 36.

Incidentally, the description of contents that overlap with those of the conveyance seats S1 to S4 described above will be omitted.

The conveyance seat S5 realizes a seat including a seat back frame that is lightweight while maintaining rigidity.

The conveyance seat S5 is a seat which is placed on a vehicle body floor and in which an occupant of a vehicle is seated. The conveyance seat S5 is used as a front seat corresponding to a front seat of the vehicle.

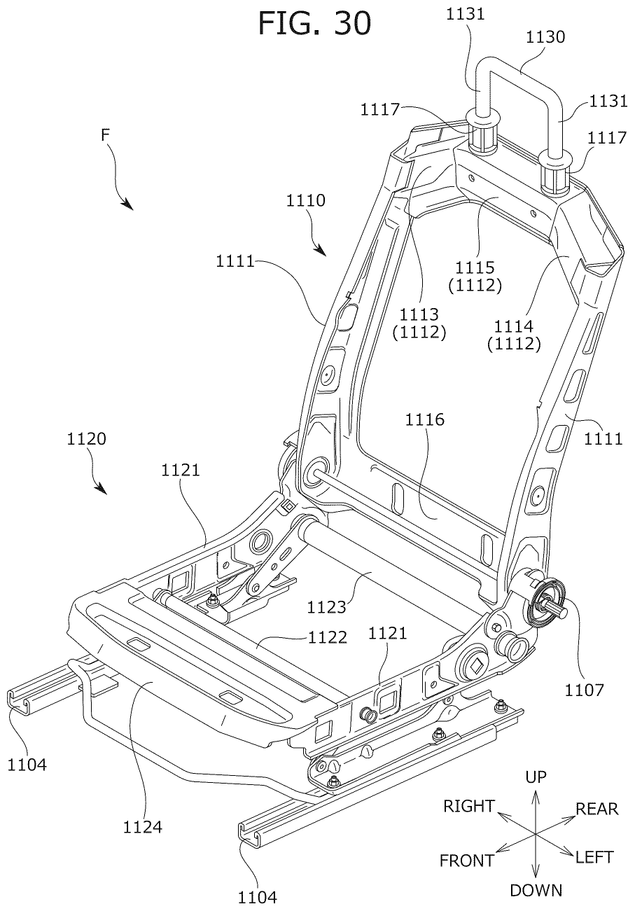

As illustrated in FIG. 29, the conveyance seat S5 includes, as main components, a seat back 1101 serving as a backrest portion that supports the back of the seated occupant; a seat cushion 1102 serving as a seating portion that supports the buttocks of the seated occupant; and a headrest 1103 that is disposed on an upper portion of the seat back 1101 and that supports the head of the seated occupant. The seat back 1101 and the seat cushion 1102 are connected to sandwich a reclining mechanism 1107 (refer to FIG. 30) therebetween. The seat back 1101 is connected to be rotatable and adjustable in angle with respect to the seat cushion 1102. The reclining mechanism 1107 adjusts an inclination angle of the seat back 1101.

As shown in FIG. 30, the seat frame F is provided in the conveyance seat S5, and the seat frame F includes a seat back frame 1110 forming a skeleton of the seat back 1101, and a seat cushion frame 1120 forming a skeleton of the seat cushion 1102.

The seat cushion frame 1120 is formed in a square frame shape, and cushion side frames 1121 are provided at side portions of the seat cushion frame 1120. In addition, the seat cushion frame 1120 includes a front connecting frame 1122 connecting the cushion side frames 1121 in the front, and a rear connecting frame 1123 connecting the cushion side frames 1121 in the rear. The front connecting frame 1122 and the rear connecting frame 1123 located in the front and rear of the conveyance seat S5 are formed of round pipes. In addition, a cushion pan frame 1124 is provided in front of the front connecting frame 1122. Incidentally, although not shown, a pressure receiving member that spans between the cushion pan frame 1124 and the rear connecting frame 1123 is attached, and the pressure receiving member supports the buttocks of the seated occupant from below.

The headrest 1103 is attached to the upper portion of the seat back 1101 so as to support the head of the seated occupant. Inside the headrest 1103, a headrest frame 1130 forming a skeleton of the headrest 1103 is provided, and two headrest pillars 1131 hanging down from a lower portion of the headrest 1103 are provided at both right and left ends of the headrest frame 1130. By inserting the headrest pillars 1131 into headrest guides 1117 attached to an upper frame 1112 of the seat back frame 1110, the headrest 1103 is attached to the seat back frame 1110.

The seat back 1101, the seat cushion 1102, and the headrest 1103 are configured by providing the pads P and the cushion trim covers T (cushion covers) on outer sides of the seat back frame 1110, the seat cushion frame 1120, and the headrest frame 1130.

In addition, as shown in FIG. 30, a slide rail 1104 is installed at a lower portion of the conveyance seat S5. The conveyance seat S5 is attached to the vehicle body floor in a state where the conveyance seat S5 is movable in a sliding manner in a front to rear direction by the slide rail 1104.

Hereinafter, the seat back frame 1110 included in the conveyance seat S5 will be described with reference to FIGS. 30 to 36.

As shown in FIG. 30, the seat back frame 1110 is formed in a square frame shape as a whole, and the seat back frame 1110 includes a pair of back side frames 1111 disposed on both sides; the upper frame 1112; and a lower frame 1116. The upper frame 1112 is disposed between the pair of back side frames 1111, and connects upper ends of the back side frames 1111. The lower frame 1116 is disposed between the pair of back side frames 1111, and connects lower ends of the pair of back side frames 1111.

The upper frame 1112 includes a first member 1113 connected to one right side frame of the pair of back side frames 1111, and a second member 1114 connected to the other left side frame. In addition, the upper frame 1112 includes a third member 1115 located between the first member 1113 and the second member 1114 and connected to the first member 1113 and the second member 1114.

In the present embodiment, the first member 1113 and the second member 1114 are made of iron, and are formed by pressing a steel sheet. Since the first member 1113 and the second member 1114 are made of iron, the upper frame 1112 can be attached to the back side frames 1111 while sufficient strength is maintained. Incidentally, the first member 1113 and the second member 1114 are not limited to being made of iron, and may be made of, for example, high tensile strength steel. Since high tensile strength steel has tension even in the case of being thin, the high tensile strength steel can be made thinner than a steel sheet, so that the weight can be reduced while rigidity is ensured.

In addition, in the present embodiment, the third member 1115 is made of resin. Since the third member 1115 is made of resin that is more lightweight than iron, compared to a case where the entirety of the upper frame 1112 is made of iron, the weight of the upper frame 1112 can be reduced, so that the weight of the seat frame F can be reduced.

Incidentally, the third member 1115 is not limited to being made of resin, and may be made of a light alloy of aluminum or magnesium that is more lightweight than a material forming the first member 1113 and the second member 1114. By making the third member 1115 out of a light alloy that is lightweight, the weight of the upper frame 1112 can be reduced, so that the weight of the seat frame F can be reduced.

A structural adhesive agent is used to join the first member 1113 and the third member 1115 and to join the second member 1114 and the third member 1115. As the structural adhesive agent, for example, an adhesive agent containing epoxy-based resin as a main component can be used, and by using the structural adhesive agent, high adhesive strength and high resistance of a joint portion can be obtained. As the structural adhesive agent, a urethane-based or acrylic-based structural adhesive agent or the like other than an epoxy-based adhesive agent may be used.

In addition, since an electrical insulating layer is formed on a joint surface as a characteristic of the structural adhesive agent, for example, even when the third member 1115 is made of metal different from iron, for example, a light alloy of aluminum or magnesium described above, electrolytic corrosion can be suppressed.

In addition, the third member 1115 includes a first segment 1115a extending from an end portion of the third member 1115 toward the first member 1113 or the second member 1114. In addition, the first member 1113 and the second member 1114 include second segments 1113a and 1114a extending toward the third member 1115, respectively.

The third member 1115 is connected to the first member 1113 and the second member 1114 by overlapping and adhering the first segment 1115a and the second segments 1113a and 1114a.

Three first segments 1115a are provided at each of both end portions in a right to left direction of the third member 1115. In addition, three second segments 1113a and three second segments 1114a are provided at respective end portions of the first member 1113 and the second member 1114 so as to correspond to the positions of the first segments 1115a. Incidentally, the number of the first segments 1115a, the second segments 1113a, and the second segments 1114a is not limited to three, and two or four or more may be provided. In addition, the number of the first segments 1115a, the second segments 1113a, and the second segments 1114a may be one, and in that case, it is preferable that the first segment 1115a and the second segments 1113a and 1114a have a shape that is long in an up to down direction.

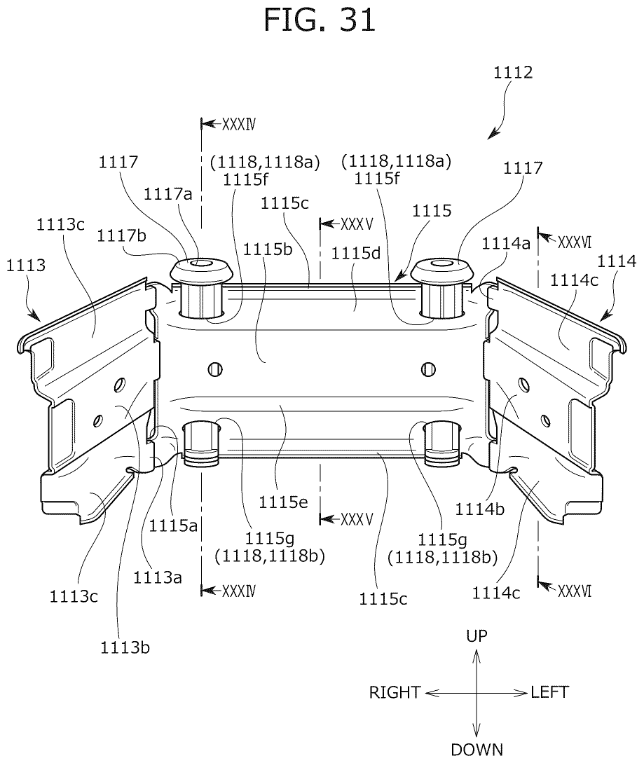

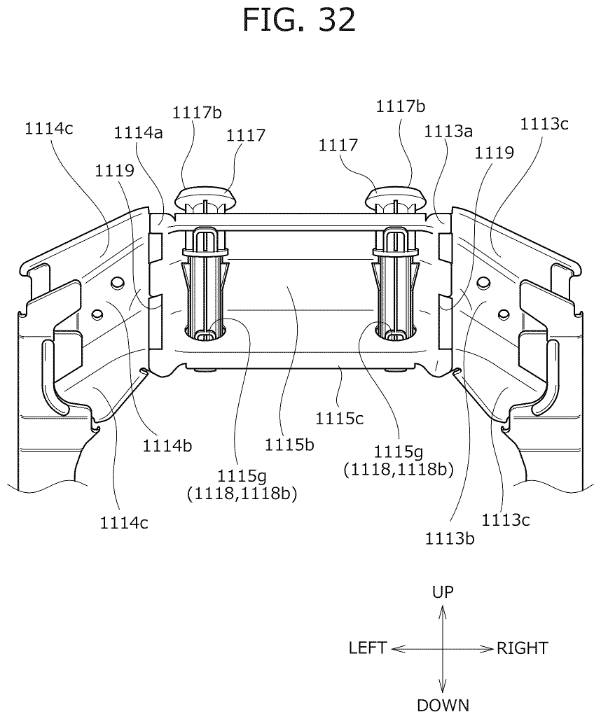

In addition, as shown in FIGS. 31 and 32, slits 1119 are formed between the third member 1115 and the first member 1113 and between the third member 1115 and the second member 1114, and the weight is reduced by the slits 1119.

In addition, in the present embodiment, the first segments 1115a and the second segments 1113a and 1114a are overlapped with each other, and are adhered to each other by applying a structural adhesive agent to adhesive surfaces.

When the third member 1115 is made of a metal material such as aluminum, the first segments 1115a and the second segments 1113a and 1114a may be joined by welding.

By making the third member 1115 out of a more lightweight material, the weight of the upper frame 1112 can be reduced, and accordingly, the weight of the seat frame F can be reduced.

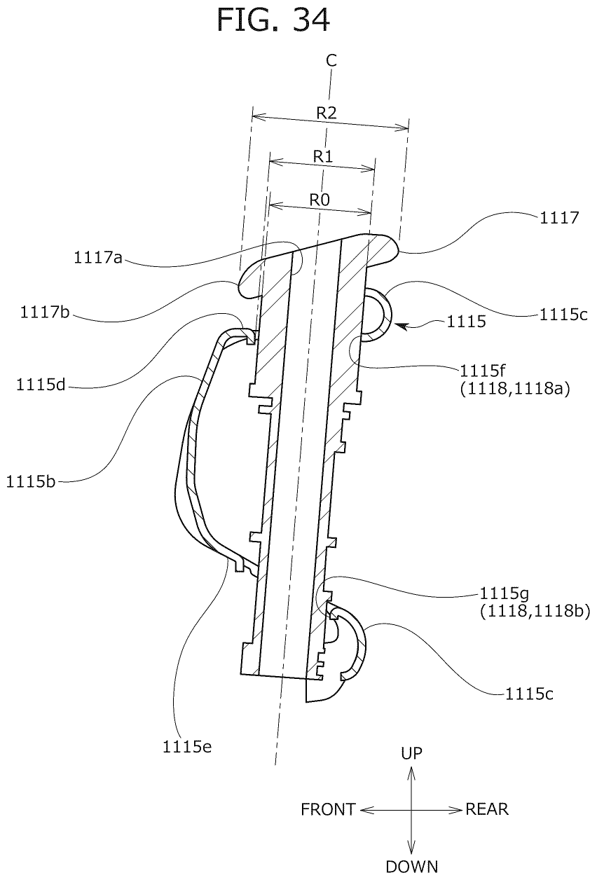

Next, a shape of the third member 1115 will be described. As shown in FIG. 34, a bulging portion 1115b (first bulging portion) bulging toward the front of the conveyance seat S5 is formed in the vicinity of a central portion in the up to down direction of the third member 1115.

The bulging portion 1115b is formed in the third member 1115 so as to extend the right to left direction (width direction) of the conveyance seat S5. Flange portions 1115c (first flange portions) are formed at respective upper and lower end portions of the bulging portion 1115b, and the third member 1115 is formed with a hat-shaped vertical cross section by the bulging portion 1115b and the flange portions 1115c. By forming the vertical cross section of the third member 1115 in a hat shape, the rigidity of the third member 1115 is improved.

Incidentally, the flange portions 1115c of the third member 1115 extend from both the end portions in the up to down direction of the bulging portion 1115b; however, the flange portion 1115c may extend only from one end portion. In addition, the third member 1115 may be formed of only the bulging portion 1115b without the flange portions 1115c, and in that case, the vertical cross section is formed in a C shape.

Similarly to the third member 1115, bulging portions 1113b and 1114b (second bulging portions) bulging toward the front of the conveyance seat S5 are formed at central portions in the up to down direction of the first member 1113 and the second member 1114. In addition, flange portions 1113c and 1114c (second flange portions) are formed to extend from upper and lower end portions of the bulging portions 1113b and 1114b in an up direction or in a down direction. The first member 1113 and the second member 1114 are formed with a hat-shaped vertical cross section by the bulging portions 1113b and 1114b and the flange portions 1113c and 1114c. By forming the cross sections of the first member 1113 and the second member 1114 in a hat shape, the rigidity of the first member 1113 and the second member 1114 is improved. Incidentally, the flange portions 1113c and 1114c extend from both the end portions in the up to down direction; however, the flange portions 1113c and 1114c may extend only from one end portion. In addition, the first member 1113 and the second member 1114 may be formed of only the bulging portions 1113b and 1114b, and in that case, the vertical cross sections are formed in a C shape.

Next, a structure for holding the headrest guides 1117 using the third member 1115 will be described.

In a manufacturing process of the vehicle seat, mechanization has been in progress; however, in the seat frame F of the related art, the headrest guides 1117 need to be welded for attachment, and since the welding work is complicated, mechanization has been difficult. For this reason, a structure for fixing the headrest guides 1117 to the seat frame F using a simpler method has been sought.

The headrest guide 1117 is a tubular body member provided with an insertion opening 1117a into which the headrest pillar 1131 is inserted. A head portion 1117b having an outer diameter R2 larger than a diameter R1 of an opening portion (upper opening portion 1118a) of a holder portion 1118 of the upper frame 1112 to be described later is provided at an upper portion of the headrest guide 1117. Accordingly, even when the headrest guide 1117 is inserted into the holder portion 1118 of the upper frame 1112, the falling of the headrest guide 1117 to a lower side of the upper frame 1112 is suppressed.

Incidentally, in order to maintain the holding strength of and to suppress the wobbling of the headrest 1103, the headrest guides 1117 are made of a metal member with high strength. The headrest guides 1117 are not limited to being made of metal, and may be made of resin.

In addition, as shown in FIGS. 31 to 33, the third member 1115 includes the holder portions 1118 that hold the headrest guides 1117. The holder portion 1118 is formed of a through hole 1115f formed in the up to down direction in an upper surface 1115d of the bulging portion 1115b, and a through hole 1115g formed in a lower surface 1115e. Namely, the through hole 1115f serves as the upper opening portion 1118a of the holder portion 1118, and the through hole 1115g serves as a lower opening portion 1118b of the holder portion 1118.

The through hole 1115f (upper opening portion 1118a) of the upper surface 1115d and the through hole 1115g (lower opening portion 1118b) of the lower surface 1115e are formed with the diameter R1 slightly larger than an outer diameter R0 of a body of the headrest guide 1117. In addition, as shown in FIG. 34, the upper opening portion 1118a and the lower opening portion 1118b are disposed such that the centers thereof are located on an axis line C in the up to down direction. For this reason, as shown in FIGS. 31, 32, and 34, the headrest guide 1117 is attached by inserting the body of the headrest guide 1117 into the through hole 1115f and the through hole 1115g.

In addition, the outer diameter R2 of the head portion 1117b of the headrest guide 1117 is formed to be larger than the diameter R1 of the through hole 1115f (upper opening portion 1118a) formed in the upper surface 1115d, and the head portion 1117b is hooked to a periphery of the through hole 1115f, so that the downward falling of the head portion 1117b is suppressed.

In the related art, the headrest guide is welded and attached to the upper frame formed of a pipe. In the upper frame of the present embodiment, since the headrest guide 1117 is attached by being inserted through the through holes 1115f and 1115g formed in the bulging portion 1115b, attachment by welding is not required. For this reason, spots to be welded in an assembly process can be reduced by manufacturing the upper frame at a factory in advance. Since the structure is such that the headrest guides 1117 are fixed by a simple method, the assembly work of the seat frame F can be mechanized.

### Additional Notes

According to the present invention, there is provided a conveyance seat including: a seat back; and a seat back frame serving as a skeleton of the seat back. It is preferable that the seat back frame includes a pair of back side frames and an upper frame connecting the pair of back side frames, that the upper frame includes a first member connected to one of the pair of back side frames, a second member connected to the other, and a third member located between the first member and the second member and connected to the first member and the second member, and that the first member and the second member are made of metal and the third member is made of a material that is more lightweight than the material of the first member and the second member.

According to the above-described configuration, while rigidity is maintained by making the first member and the second member, which are connected to the pair of side frames, out of metal, the weight of the seat frame can be reduced by making the third member out of a material that is more lightweight than the material of the first member and the second member.

### Sixth Embodiment

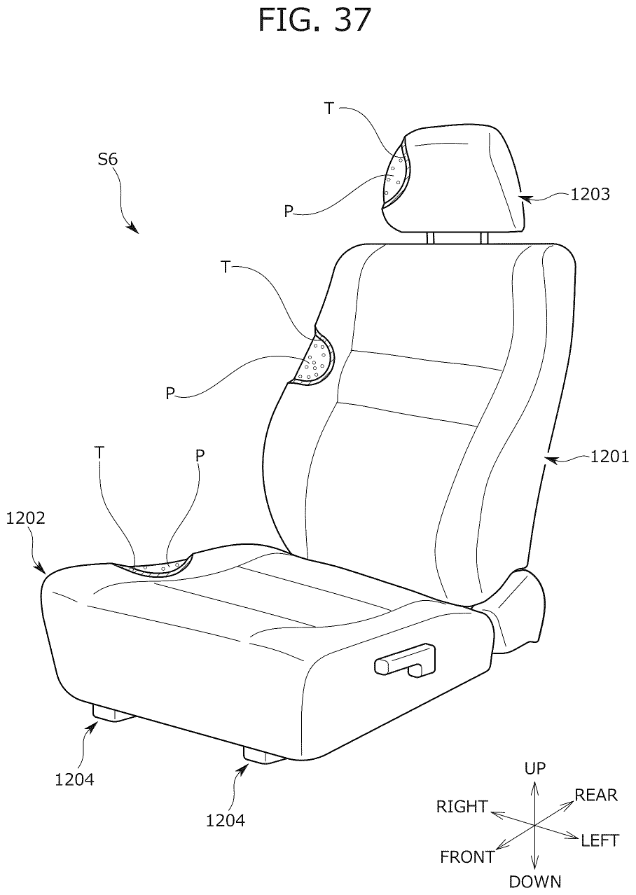

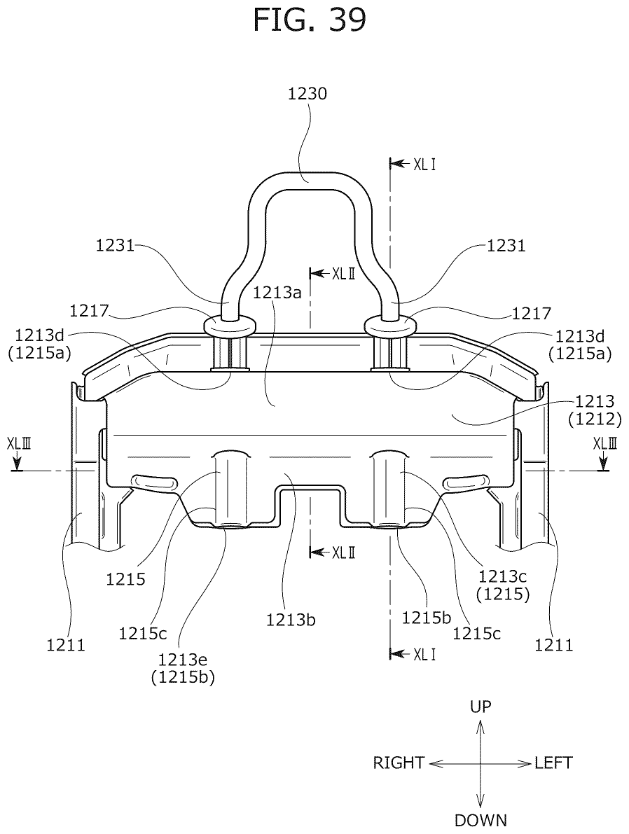

Next, a conveyance seat S6 of a sixth embodiment will be described with reference to FIGS. 37 to 43C.

Incidentally, the description of contents that overlap with those of the conveyance seats S1 to S5 described above will be omitted.

The conveyance seat S6 realizes a seat including a seat back frame that holds a headrest without lower end portions of pillars processed.

A basic configuration of the conveyance seat S6 will be described with reference to FIG. 37. FIG. 37 is a perspective view of the conveyance seat S6, and in FIG. 37, for convenience of illustration, a part of the conveyance seat S6 is shown with the cushion trim cover T or the pad P removed.

The conveyance seat S6 is a seat which is placed on a vehicle body floor and in which an occupant of a vehicle is seated. In the present embodiment, the conveyance seat S6 is used as a front seat corresponding to a front seat of the vehicle. However, the conveyance seat S6 is not limited to the front seat, and can also be used as a seat for a rear seat, and can also be used as a middle seat in a second row or a rear seat in a third row in a vehicle including three rows of seats in a front to rear direction.

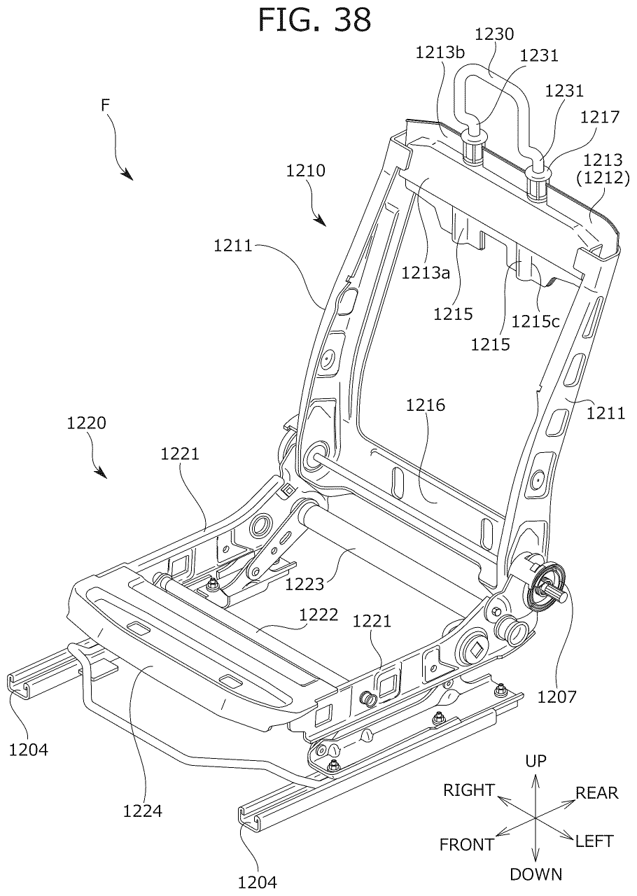

As illustrated in FIG. 37, the conveyance seat S6 includes, as main components, a seat back 1201 serving as a backrest portion that supports the back of the seated occupant; a seat cushion 1202 serving as a seating portion that supports the buttocks of the seated occupant; and a headrest 1203 that is disposed on an upper portion of the seat back 1201 and that supports the head of the seated occupant. The seat back 1201 and the seat cushion 1202 are connected to sandwich a reclining mechanism 1207 (refer to FIG. 38) therebetween. The seat back 1201 is connected to be rotatable and adjustable in angle with respect to the seat cushion 1202. The reclining mechanism 1207 adjusts an inclination angle of the seat back 1201.

As shown in FIG. 38, the seat frame F is provided in the conveyance seat S6, and the seat frame F includes a seat back frame 1210 forming a skeleton of the seat back 1201, and a seat cushion frame 1220 forming a skeleton of the seat cushion 1202.

Hereinafter, first, configurations such as the seat cushion frame 1220 other than the seat back frame 1210 will be described, and details of the seat back frame 1210 will be described thereafter.

The seat cushion frame 1220 is formed in a square frame shape, and cushion side frames 1221 are provided at side portions of the seat cushion frame 1220. In addition, the seat cushion frame 1220 includes a front connecting frame 1222 connecting the cushion side frames 1221 in the front, and a rear connecting frame 1223 connecting the cushion side frames 1221 in the rear. The front connecting frame 1222 and the rear connecting frame 1223 located in the front and rear of the conveyance seat S6 are formed of round pipes. In addition, a cushion pan frame 1224 is provided in front of the front connecting frame 1222. Incidentally, although not shown, a pressure receiving member that spans between the cushion pan frame 1224 and the rear connecting frame 1223 is attached, and the pressure receiving member supports the buttocks of the seated occupant from below.

The headrest 1203 is attached to the upper portion of the seat back 1201 so as to support the head of the seated occupant. Inside the headrest 1203, a headrest frame 1230 forming a skeleton of the headrest 1203 is provided, and two headrest pillars 1231 (also referred to as headrest stays) hanging down from a lower portion of the headrest 1203 are provided at both right and left ends of the headrest frame 1230. By inserting the headrest pillars 1231 into headrest guides 1217 attached to an upper frame 1212 of the seat back frame 1210 to be described later, the headrest 1203 is attached to the seat back frame 1210.

The seat back 1201, the seat cushion 1202, and the headrest 1203 are configured by providing the pads P and the cushion trim covers T (cushion covers) on outer sides of the seat back frame 1210, the seat cushion frame, and the headrest frame 1230. The pad P is, for example, a urethane base material molded by foam molding using a urethane foam material, and the cushion trim cover T is made of, for example, a skin material such as cloth, synthetic leather, or genuine leather.

In addition, as shown in FIG. 38, a slide rail 1204 is installed at a lower portion of the conveyance seat S6. The conveyance seat S6 is attached to the vehicle body floor in a state where the conveyance seat S6 is movable in a sliding manner in a front to rear direction by the slide rail 1204.

The slide rail 1204 is a device that moves the conveyance seat S6 in a sliding manner along the front to rear direction, and has a known structure (structure of a general slide rail mechanism). The slide rail 1204 includes lower rails fixed onto the vehicle body floor, and upper rails that are movable in a sliding manner with respect to the lower rails. The upper rails are slidable with respect to the lower rails fixed to a vehicle body.

The reclining mechanism 1207 is provided between a lower end portion of the seat back 1201 and a rear end portion of the seat cushion 1202. In more detail, the reclining mechanism 1207 connects the seat back frame 1210 of the seat back 1201 and the seat cushion frame 1220 of the seat cushion 1202. The reclining mechanism 1207 can adjust an angle of the seat back 1201 (seat back frame 1210) with respect to the seat cushion 1202 (seat cushion frame 1220). The reclining mechanism 1207 can maintain a state where the seat back 1201 is locked and inclined at a predetermined angle. In addition, the seat back 1201 can be reclined forward or rearward by releasing the locking.

Hereinafter, the seat back frame 1210 included in the conveyance seat S6 will be described with reference to FIGS. 38 to 43.

As shown in FIG. 38, the seat back frame 1210 is formed in a square frame shape as a whole, and the seat back frame 1210 includes a pair of back side frames 1211 disposed on both sides; the upper frame 1212; and a lower frame 1216. The upper frame 1212 is disposed between the pair of back side frames 1211, and connects upper ends of the back side frames 1211. The lower frame 1216 is disposed between the pair of back side frames 1211, and connects lower ends of the pair of back side frames 1211.

The headrest guide 1217 is a tubular body member provided with an insertion opening 1217a into which the headrest pillar 1231 is inserted. A head portion 1217b having an outer diameter larger than a diameter of an opening portion (upper opening portion 1215a) of a holder portion 1215 of the upper frame 1212 to be described later is provided at an upper portion of the headrest guide 1217. Incidentally, a portion of the headrest guide 1217 below the head portion 1217b may be referred to as a body 1217c of the headrest guide 1217. Accordingly, even when the headrest guide 1217 is inserted into the holder portion 1215 of the upper frame 1212, the falling of the headrest guide 1217 to a lower side of the upper frame 1212 is suppressed.

Incidentally, in order to maintain the holding strength of and to suppress the wobbling of the headrest 1203, the headrest guides 1217 are made of a metal member with high strength. The headrest guides 1217 are not limited to being made of metal, and may be made of resin.

The upper frame 1212 includes a first pan frame 1213 having a plate shape and a second pan frame 1214 having a plate shape. In the upper frame 1212, the first pan frame 1213 is located on a front side of the seat back 1201, and the second pan frame 1214 is located on a rear side of the seat back 1201 and on a back side of the first pan frame 1213.

As shown in FIGS. 38 to 40 and 43A to 43C, the first pan frame 1213 and the second pan frame 1214 sandwich the headrest guides 1217 therebetween and support the headrest guides 1217 from the front of the seat back 1201 and the rear of the seat back 1201, respectively.

The holder portion 1215 having a tubular shape and holding the headrest guide 1217 is formed by the first pan frame 1213 and the second pan frame 1214. The headrest guide 1217 is attached by inserting the headrest guide 1217 into the holder portion 1215.

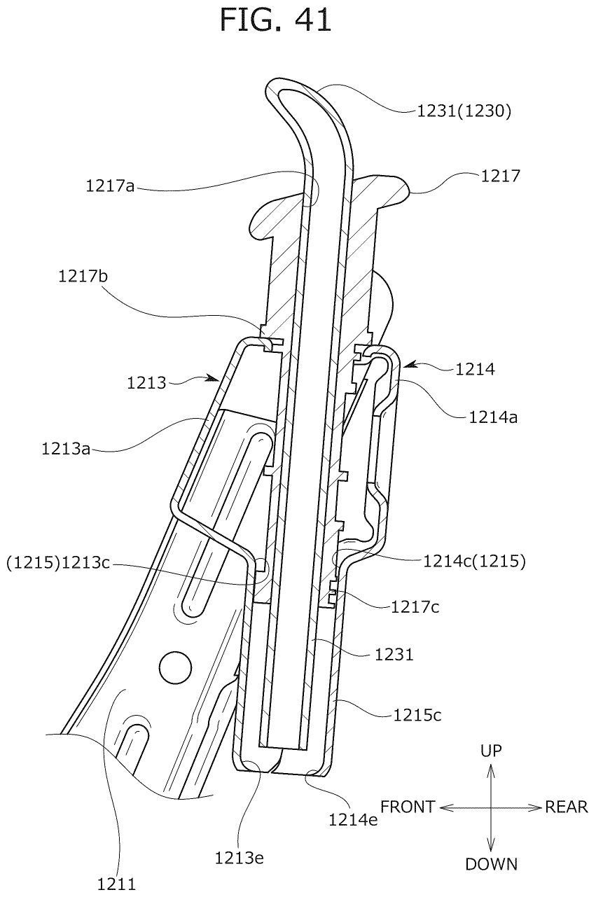

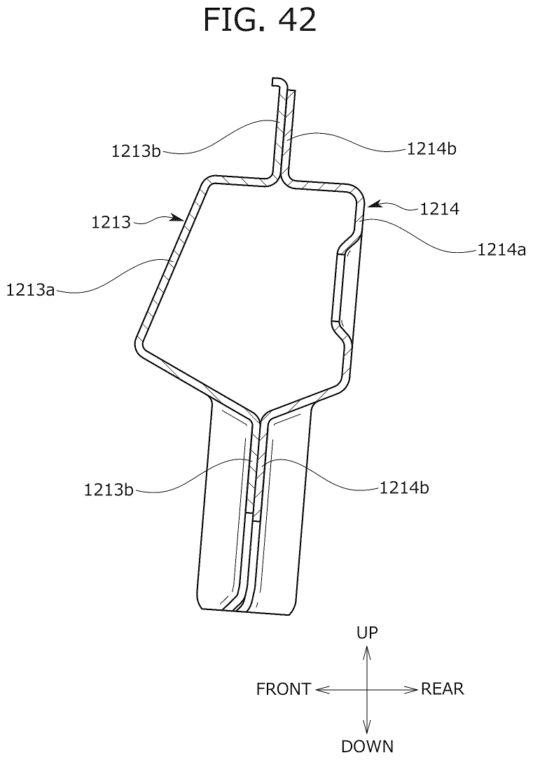

As shown in FIGS. 41 and 42, two first recesses 1213c and two second recesses 1214c extending in an up to down direction are formed in the first pan frame 1213 and the second pan frame 1214 at positions facing each other, respectively. The first recesses 1213c and the second recesses 1214c are formed to align with an outer shape of the bodies 1217c of the headrest guides 1217. The holder portions 1215 holding the headrest guides 1217 are formed by disposing the first recesses 1213c and the second recesses 1214c to face each other, and by joining the first pan frame 1213 and the second pan frame 1214.

The holder portion 1215 forms a tubular space by means of the first recess 1213c and the second recess 1214c, and includes opening portions (the upper opening portion 1215a and a lower opening portion 1215b) at the top and bottom. In other words, the upper opening portion 1215a of the holder portion 1215 includes an opening portion 1213d of the first recess 1213c and an opening portion 1214d of the second recess 1214c shown in FIG. 41. The headrest guide 1217 is attached by being inserted from the upper opening portion 1215a of the holder portion 1215. Incidentally, as shown in FIG. 42, a diameter of the upper opening portion 1215a is formed to be smaller than a diameter of the head portion 1217b of the headrest guide 1217. When the headrest guide 1217 is inserted, the head portion 1217b comes into a contact with a periphery of the upper opening portion 1215a of the holder portion 1215, so that the falling of the head portion 1217b to a lower side of the upper opening portion 1215a is suppressed.

In addition, as shown in FIG. 41, the holder portion 1215 includes a cover portion 1215c at a lower end portion of the holder portion 1215, the cover portion 1215c covering a lower end of the headrest pillar 1231 held by the headrest guide 1217. The cover portion 1215c is provided to cover a lower end 1231a of each of the pair of headrest pillars 1231. The cover portion 1215c is configured by a lower end portion of the first recess 1213c and a lower end portion of the second recess 1214c.

As shown in FIG. 41, a lower end of the holder portion 1215, in more detail, a lower end of the cover portion 1215c is formed to be located below a position of the lower end 1231a of the headrest pillar 1231 held by the headrest guide 1217.

Since the lower end 1231a of the headrest pillar 1231 is covered with the cover portion 1215c, the lower end 1231a of the headrest pillar 1231 does not directly abut against the back of the seated occupant. For this reason, the lower end 1231a of the headrest pillar 1231 may not be processed into a hemispherical shape, and cost or labor involved in the processing can be eliminated.

As shown in FIGS. 41 and 42, a first bulging portion 1213a bulging in a front direction of the conveyance seat S6 is formed in the first pan frame 1213. In addition, the first bulging portion 1213a is formed along a longitudinal direction of the first pan frame 1213 so as to extend in a width direction of the conveyance seat S6. First flange portions 1213b extending in an up direction or in a down direction are formed at end portions in the up to down direction of the first bulging portion 1213a. As shown in FIG. 42, the first flange portions 1213b are joined to second flange portions 1214b of the second pan frame 1214 to be described later. The first pan frame 1213 is formed with a hat-shaped vertical cross section by the first bulging portion 1213a and the first flange portions 1213b extending upward and downward. Since the first pan frame 1213 has a hat-shaped vertical cross section, the rigidity of the first pan frame 1213 is improved.

Incidentally, the hat shape also includes a cap shape. In other words, the hat shape also includes a case where the first flange portion 1213b extending from one of an upper end and a lower end of the first bulging portion 1213a is formed.

As shown in FIGS. 41 and 42, a second bulging portion 1214a bulging toward the rear of the conveyance seat S6 is formed in the second pan frame 1214. The second bulging portion 1214a is formed along a longitudinal direction of the second pan frame 1214 so as to extend in the width direction of the conveyance seat S6. As shown in FIG. 42, the second flange portions 1214b are joined to the first flange portions 1213b of the first pan frame 1213. In addition, the second pan frame 1214 is formed with a hat-shaped vertical cross section by the second bulging portion 1214a and the second flange portions 1214b extending upward and downward. Incidentally, the second flange portion 1214b may be formed to extend from one of an upper end and a lower end of the second bulging portion 1214a.

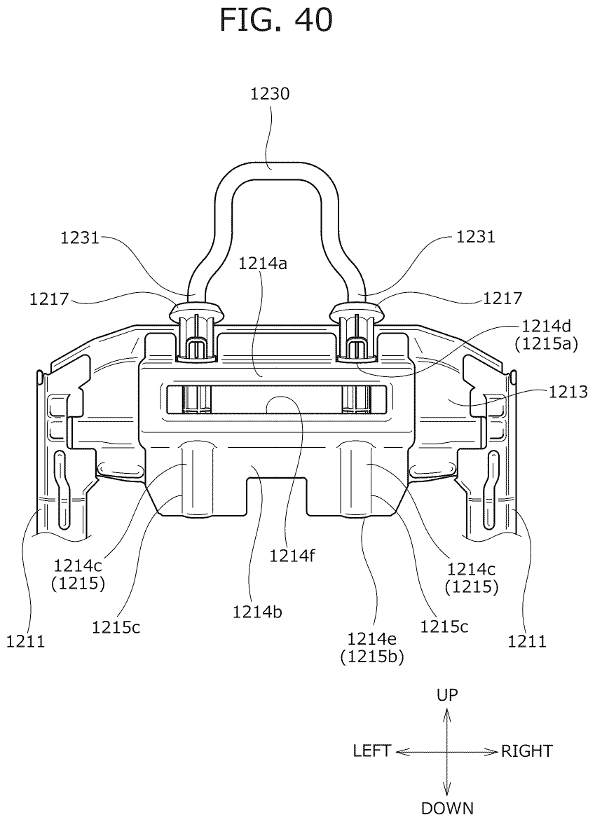

In addition, as shown in FIG. 40, a window portion 1214f is formed at the center of the second bulging portion 1214a. By forming the window portion 1214f, the state of the headrest guides 1217 can be visually confirmed, and the weight can be reduced.

In such a manner, in the present embodiment, both the first pan frame 1213 and the second pan frame 1214 have hat-shaped vertical cross sections, and a closed cross-sectional structure (also referred to as a monocoque structure) including a hollow portion is formed by joining both the flange portions.

In the present embodiment, the first pan frame 1213 is made of iron, and is formed by pressing a steel sheet. In addition, the second pan frame 1214 is made of resin. By making the second pan frame 1214 out of resin, the weight of the upper frame 1212 can be reduced. In such a manner, by making the first pan frame 1213 and the second pan frame 1214 out of different materials, the upper frame 1212 with the characteristics of each material can be formed.

For example, the first pan frame 1213 may be made of high tensile strength steel. Since high tensile strength steel has tension even in the case of being thin, the high tensile strength steel can be made thinner than a steel sheet, so that the weight can be reduced while rigidity is ensured. The second pan frame 1214 may be made of high tensile strength steel.

In addition, the second pan frame 1214 may be made of aluminum or an aluminum alloy. The frame that is more inexpensive or lightweight compared to the case of being made of iron can be formed.

The first pan frame 1213 and the second pan frame 1214 are joined by an adhesive agent. The adhesive agent is, for example, a structural adhesive agent, and it is desirable that the adhesive agent is a high-toughness type or high-viscosity type. In the case of a high-toughness type structural adhesive agent, the cracking of the adhesive agent caused by the twisting or the like of the frame can be suitably suppressed, and the durability of adhesion can be improved. In the case of a high-viscosity type, dripping during adhesion can be suppressed. As the structural adhesive agent, for example, there is one containing epoxy-based rein as a main component. The first flange portions 1213b of the first pan frame 1213 and the second flange portions 1214b of the second pan frame 1214 are adhered to each other. Since joining is performed using the flange portions that spread in a planar manner, adhesive strength can be maintained even when joining by an adhesive agent is performed.

In such a manner, by forming the first pan frame 1213 and the second pan frame 1214, while the rigidity of the upper frame 1212 is maintained, the upper frame 1212 can be easily assembled.

Incidentally, when both the first pan frame 1213 and the second pan frame 1214 are made of metal, the first pan frame 1213 and the second pan frame 1214 may be joined by welding.

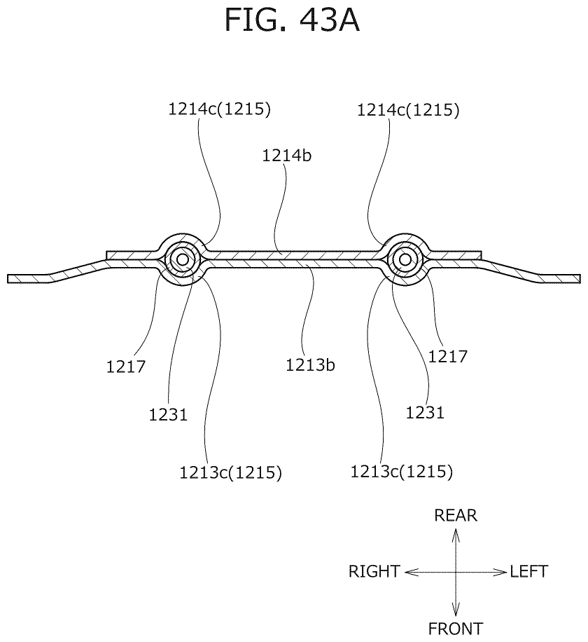

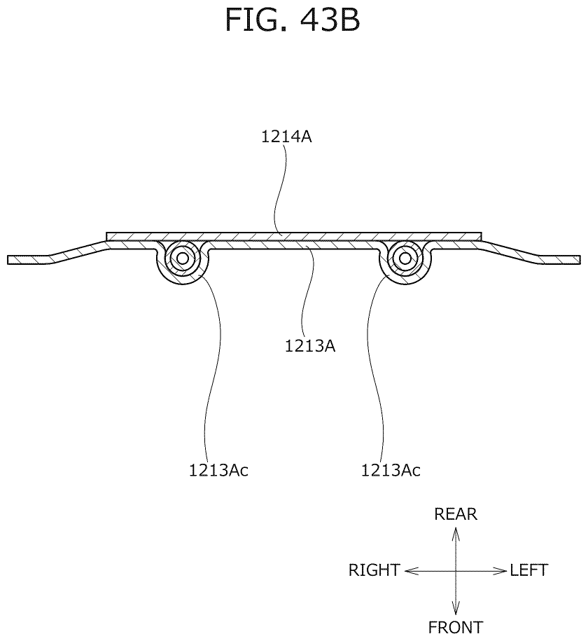

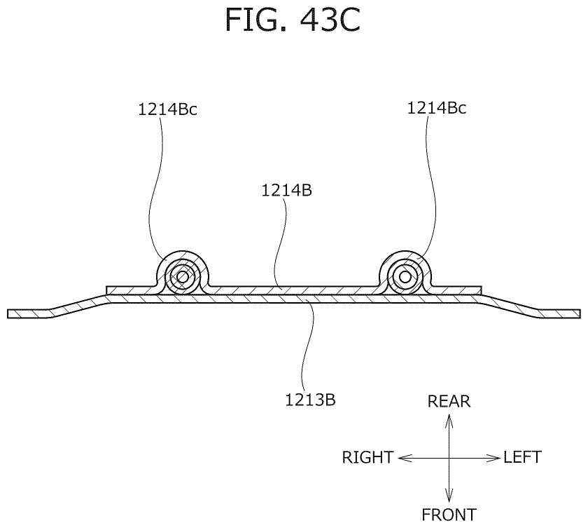

Another example of the upper frame 1212 will be described. Upper frames 1212A and 1212B shown in FIGS. 43B and 43C are members attached to the upper portion of the seat back frame 1210. In the upper frame 1212 shown in FIG. 43A, both the first pan frame 1213 and the second pan frame 1214 are provided with the recesses (the first recesses 1213c and the second recesses 1214c). As shown in FIG. 43B, recesses (first recesses 1213Ac) may be formed only in a first pan frame 1213A. In this case, a second pan frame 1214A serves as a lid portion that closes the recesses. In addition, as shown in FIG. 43C, recesses (second recesses 1214Bc) may be formed only in a second pan frame 1214B, and a first pan frame 1213B serves as a lid portion that closes the second recesses 1214Bc.

The conveyance seat S6 of the present embodiment has been described above with reference to the drawings. In the present embodiment, both the first pan frame 1213 and the second pan frame 1214 are provided with the bulging portions (the first bulging portion 1213a and the second bulging portion 1214a); however, the bulging portion may be formed in only one thereof. In addition, in the present embodiment, the flange portions (the first flange portions 1213b and the second flange portions 1214b) extend from both the upper end portions and the lower end portions of the bulging portions, but may be formed to extend from only one of the upper end portions and the lower end portions.

Incidentally, in the present embodiment, the cover portion 1215c is formed by the recesses of both the first pan frame 1213 and the second pan frame 1214. This configuration is one example, and for example, only the first recess 1213c of the first pan frame 1213 may extend downward to form a cover portion that covers only a front side of the headrest pillar 1231.

### Additional Notes

According to the present invention, there is provided a conveyance seat including: a seat back; a headrest provided on the seat back; and a seat back frame serving as a skeleton of the seat back. It is preferable that the seat back frame includes a pair of back side frames, an upper frame connecting the pair of back side frames, and a headrest guide holding a pillar of the headrest, that the upper frame includes a holder portion holding the headrest guide, and that the holder portion includes a cover portion at a lower end of the holder portion, the cover portion covering a lower end portion of the pillar held by the headrest guide.

By configuring the holder portion of the upper frame to include the cover portion covering the lower end portion of the pillar, the contact of the lower end portion of the pillar with the back of the occupant or the coming off of the lower end portion of the pillar from the seat back is suppressed. For this reason, the lower end portion of the pillar does not need to be processed into a hemispherical shape.

In addition, in the conveyance seat described above, it is preferable that a lower end of the cover portion is located below the lower end portion of the pillar held by the headrest guide.

By locating the lower end of the cover portion below a lower end of the pillar, the pillar can be more reliably protected.

In addition, in the conveyance seat described above, it is preferable that the upper frame includes a first pan frame having a plate shape and a second pan frame having a plate shape, that as the holder portion, a first recess extending in an up to down direction in accordance with an outer shape of the headrest guide is formed in at least one of the first pan frame and the second pan frame, and that the headrest guide is inserted into the first recess, and the first pan frame and the second pan frame sandwich the headrest guide between the first pan frame and the second pan frame from a front of the seat back and a rear of the seat back, respectively, so that the holder portion holds the headrest guide.

By inserting the headrest guide into the first recess forming the holder portion and by sandwiching the headrest guide between the first pan frame and the second pan frame, a lateral shift of the headrest guide is prevented, and the headrest guide is more firmly held.

In addition, in the conveyance seat described above, it is preferable that a second recess extending in the up to down direction in accordance with the outer shape of the headrest guide is formed in the other of the first pan frame and the second pan frame at a position facing the first recess, and that the headrest guide is inserted into the first recess and the second recess, so that the holder portion holds the headrest guide.

By inserting the headrest guide into the first recess and the second recess forming the holder portion and by sandwiching the headrest guide between the first pan frame and the second pan frame, a lateral shift of the headrest guide is prevented, and the headrest guide is more firmly held.

In addition, in the conveyance seat described above, it is preferable that the first pan frame includes a first bulging portion bulging toward a front of the conveyance seat and extending in a width direction of the conveyance seat, and first flange portions extending from an upper end portion and/or a lower end portion of the first bulging portion, and that the first pan frame has a hat-shaped vertical cross section formed by the first bulging portion and the first flange portions.

Since the first pan frame has a hat-shaped vertical cross section, the rigidity of the upper frame is improved.

In addition, in the conveyance seat described above, it is preferable that the second pan frame includes a second bulging portion bulging toward a rear of the conveyance seat and extending in a width direction of the conveyance seat, and second flange portions extending from an upper end portion and/or a lower end portion of the second bulging portion, and that the second pan frame has a hat-shaped vertical cross section formed by the second bulging portion and the second flange portions.

Since the second pan frame has a hat-shaped vertical cross section, the rigidity of the upper frame is improved.

In addition, in the conveyance seat described above, it is preferable that the first pan frame and the second pan frame are made of different materials.

By making the first pan frame and the second pan frame out of a combination of materials with different properties, the upper frame with the characteristics of each material can be formed. For example, one of the first pan frame and the second pan frame can be reduced in weight or can be made with high strength.

In addition, in the conveyance seat described above, it is preferable that the first pan frame and the second pan frame are joined by a structural adhesive agent.

Welding work during assembly is reduced by joining using an adhesive agent, so that the frame can be more simply assembled.

In addition, in the conveyance seat described above, it is preferable that the first pan frame is made of high tensile strength steel.

By making the first pan frame out of high tensile strength steel, the frame that is more lightweight and has higher strength compared to the case of being made of iron can be formed.

In addition, in the conveyance seat described above, it is preferable that the second pan frame is made of resin or aluminum.

By making the second pan frame out of resin or aluminum, the frame that is more inexpensive or lightweight compared to the case of being made of iron can be formed.

### Seventh Embodiment

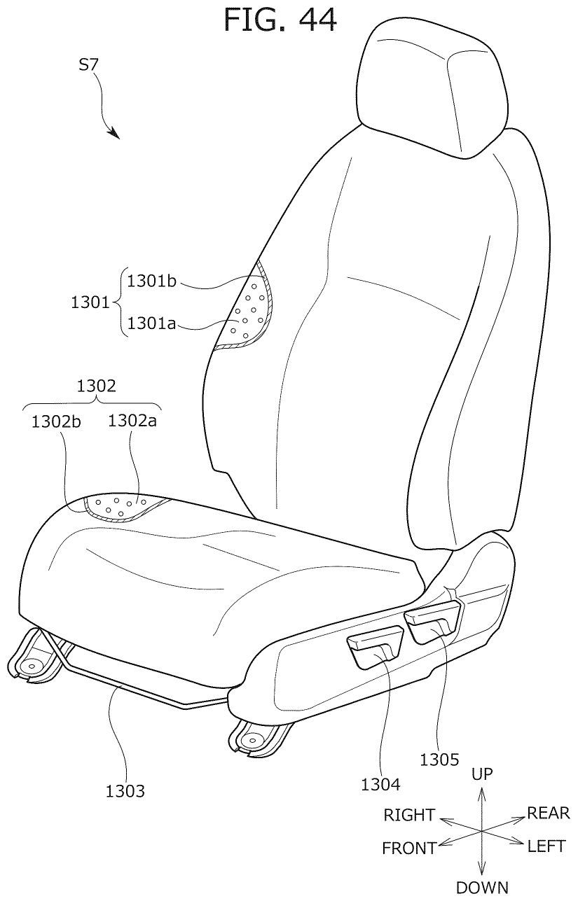

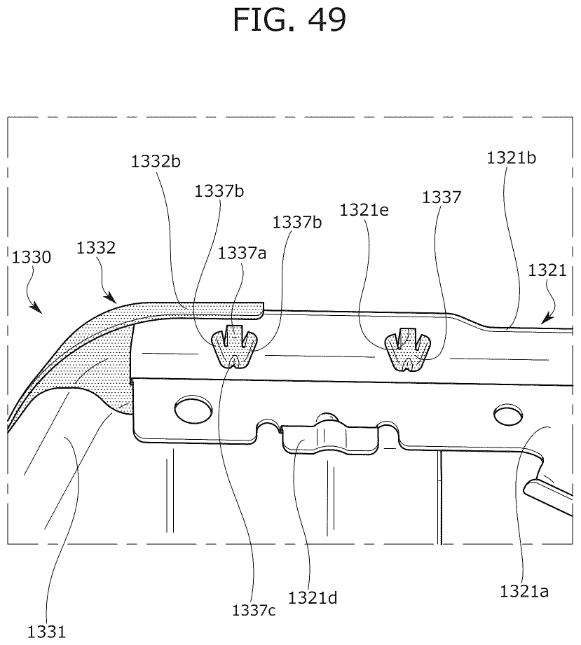

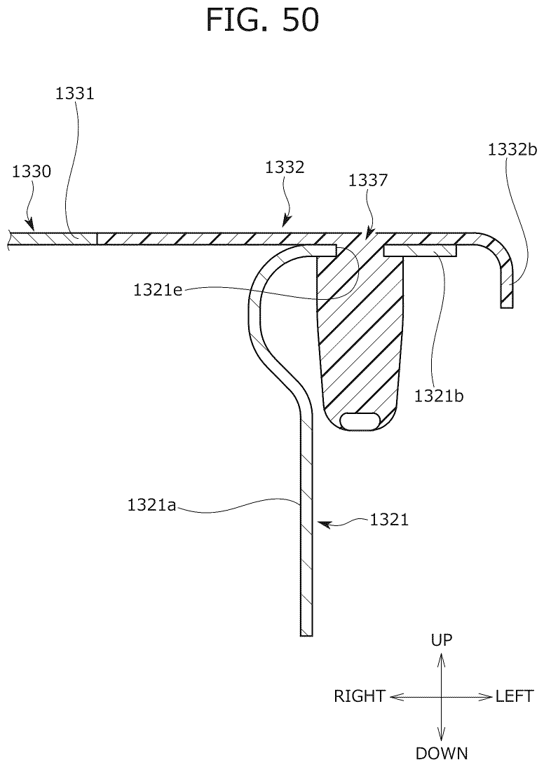

Next, a conveyance seat S7 of a seventh embodiment will be described with reference to FIGS. 44 to 50.

Incidentally, the description of contents that overlap with those of the conveyance seats S1 to S6 described above will be omitted.

The conveyance seat S7 can suitably ensure the rigidity of a seat frame while reducing the weight of the seat frame. In addition, the assembly work of frame components can be facilitated.

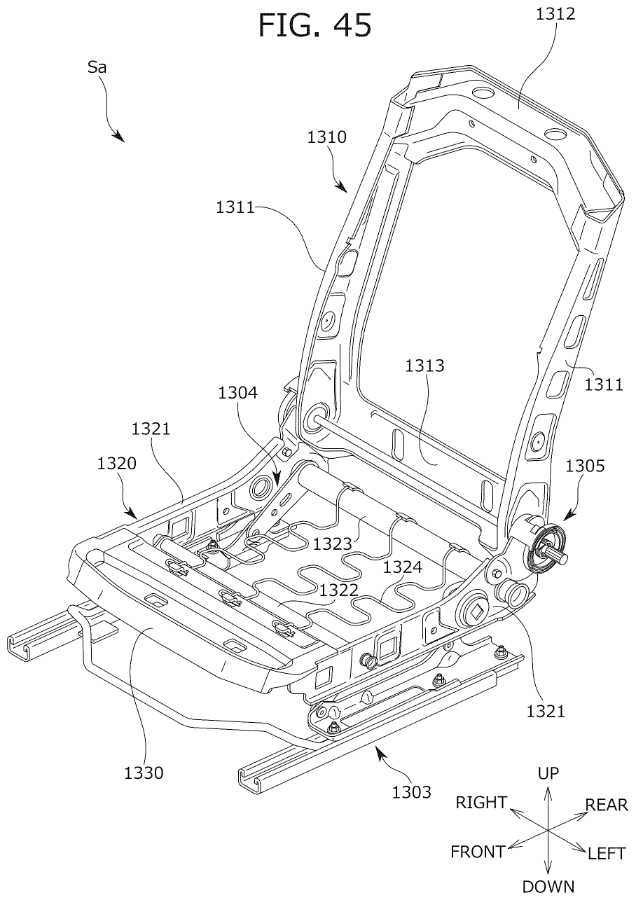

The conveyance seat S7 is, as shown in FIG. 44, a vehicle seat, and mainly includes a seat body including a seat back 1301 and a seat cushion 1302, and as shown in FIG. 45, a rail device 1303 that supports the seat body so as to be movable forward and rearward with respect to a vehicle body floor, a height link device 1304 that connects the seat body to the vehicle body floor so as to be raisable and lowerable, and a reclining device 1305 that rotatably connects the seat back 1301 to the seat cushion 1302.

As shown in FIG. 44, the seat back 1301 is a backrest portion that supports a seated occupant from behind, and is configured by placing a cushion material 1301a on a back frame 1310 serving as a skeleton shown in FIG. 45, and by covering the cushion material 1301a with a skin material 1301b.

The seat cushion 1302 is a seating portion that supports the seated occupant from below, and is configured by placing a cushion material 1302a on a cushion frame 1320 serving as a skeleton shown in FIG. 45, and by covering the cushion material 1302a with a skin material 1302b.

As shown in FIG. 45, the back frame 1310 is formed of a substantially rectangular frame-shaped body, and mainly includes back side frames 1311 disposed on right and left sides; an upper frame 1312 having an inverted U shape and connecting upper end portions of the back side frames 1311; a lower frame 1313 having a plate shape and connecting lower end portions of the back side frames 1311; and elastic springs (not shown) hooked to each of the back side frames 1311 and extending in a meandering manner.

As shown in FIGS. 45 to 47, the cushion frame 1320 is formed of a substantially rectangular frame-shaped body, and mainly includes side frames 1321 disposed on the right and left sides and extending in a seat front to rear direction; a pan frame 1330 having a plate shape and provided on front end portions of the side frames 1321 in a bridging manner; a front connecting frame 1322 connecting front portions of the side frames 1321; a rear connecting frame 1323 connecting rear portions of the side frames 1321; and a plurality of elastic springs 1324 hooked to the pan frame 1330 and the rear connecting frame 1323 and extending in a meandering manner in the seat front to rear direction.

As shown in FIGS. 45 to 47, the side frame 1321 is a plate-shaped frame that is long in the seat front to rear direction, and includes a frame body portion 1321a and an upper end flange portion 1321b and a lower end flange portion 1321c that are bent and protrude outward in a seat width direction from an upper end portion and a lower end portion of the frame body portion 1321a, respectively.

In addition, the side frame 1321 includes skin hook portions 1321d formed by cutting and raising parts of a side surface of the frame body portion 1321a and used for hooking terminal portions of the skin material 1302b.

In addition, the side frame 1321 has engagement holes 1321e formed in an upper surface of the upper end flange portion 1321b and used for engaging engagement clips 1337 of the pan frame 1330.

A plurality of the skin hook portions 1321d and a plurality of the engagement holes 1321e are formed with predetermined distances therebetween in the seat front to rear direction.

Incidentally, the reclining device 1305 is attached to rear end portions of the side frames 1321.

As shown in FIGS. 45 to 50, the pan frame 1330 is a plate-shaped bridging frame provided on upper surfaces of the right and left side frames 1321 in a bridging manner and supporting the thighs of the seated occupant, and side portions of the pan frame 1330 in the seat width direction are placed and attached to the upper surfaces of the side frames 1321.

Specifically, the pan frame 1330 includes a frame central portion 1331 provided at a central portion of the pan frame 1330 in the seat width direction and made of a first material (metal material), and right and left frame side portions 1332 provided at the side portions of the pan frame 1330 in the seat width direction and made of a second material (resin material).

Further, the frame central portion 1331 and the frame side portions 1332 are joined and formed in the seat width direction.

As a method for manufacturing the pan frame 1330, for example, first, the frame central portion 1331 made of a metal material is press-formed. Then, after press forming, the frame central portion 1331 is put into a known resin molding machine. Then, the frame central portion 1331 is insert-molded together with the frame side portions 1332 made of a resin material. During insert molding, the frame central portion 1331 and the frame side portions 1332 are joined and formed in the seat width direction.

The pan frame 1330 made of dissimilar materials can be easily manufactured by the above-described manufacturing method.

In the present embodiment, the frame central portion 1331 is made of a metal material (specifically, iron) as the “first material”. In addition, the frame side portions 1332 are made of a resin material (specifically, carbon fiber reinforced plastic) as the “second material”.

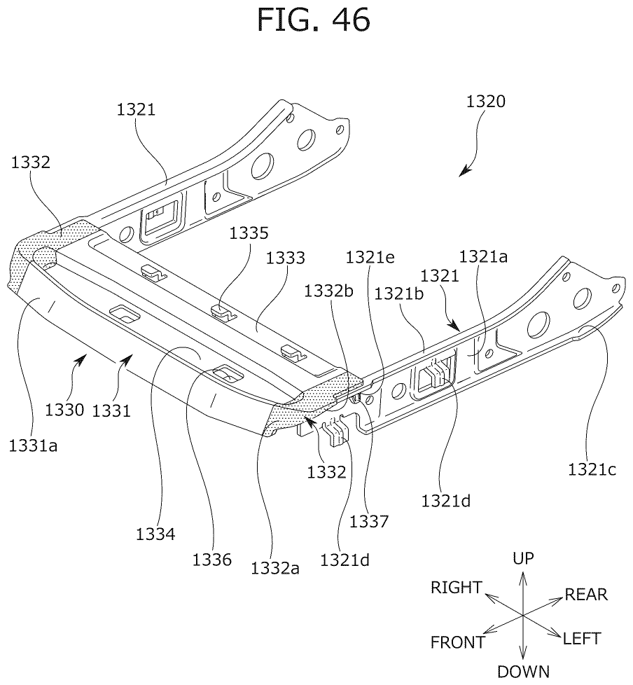

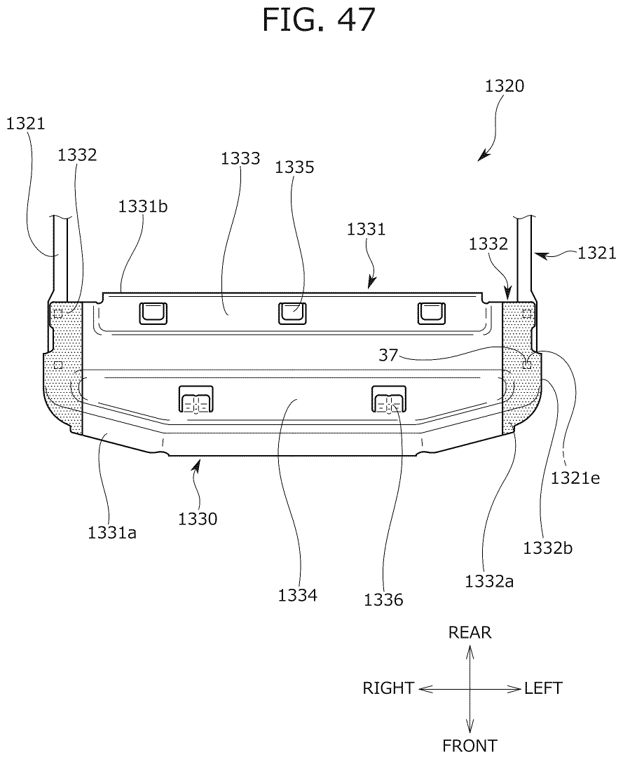

As shown in FIGS. 46 and 47, the frame central portion 1331 is disposed closer to a center side in the seat width direction than the right and left side frames 1321, and is sandwiched and disposed between the right and left side frames 1321.

The frame central portion 1331 includes a rear reinforcement portion 1333 formed as a recess on an upper surface of a rear portion of the frame central portion 1331 and extending in the seat width direction, and a front reinforcement portion 1334 formed as a recess on an upper surface of a front portion of the frame central portion 1331 and extending in the seat width direction.

Spring hook portions 1335 for hooking one end portions of the elastic springs 1324 are formed on an upper surface of the rear reinforcement portion 1333. In addition, skin hook portions 1336 for hooking skin terminal portions of the skin material 1302b are formed on an upper surface of the front reinforcement portion 1334.

Incidentally, protruding flanges 1331a and 1331b protruding downward are formed at a front end portion and a rear end portion of the frame central portion 1331, respectively.

The frame side portions 1332 are widely formed to span between the side frames 1321 in the seat width direction, and are attached to the upper surfaces of the side frames 1321.

The engagement clips 1337 that engage with the engagement holes 1321e formed in the upper surfaces of the side frames 1321 are integrally formed on bottom surfaces of the frame side portions 1332.

Incidentally, protruding flanges 1332a and 1332b protruding downward are formed at front end portions and outer end portions of the frame side portions 1332, respectively.

The rear reinforcement portion 1333 is a reinforcement recess having a rectangular shape that is long in the seat width direction, and extends from a central portion of the frame central portion 1331 to both right and left end portions.

Similarly, the front reinforcement portion 1334 is also a reinforcement recess having a rectangular shape that is long in the seat width direction, and extends to be longer than the rear reinforcement portion 1333.

Specifically, the front reinforcement portion 1334 is continuously formed over the frame central portion 1331 and the frame side portions 1332. In other words, the front reinforcement portion 1334 continuously extends from the frame central portion 1331 to positions reaching the frame side portions 1332.

For this reason, in addition to improving the rigidity of the pan frame 1330, the frame central portion 1331 and the frame side portions 1332 can be easily joined by using the front reinforcement portion 1334 as a positioning portion.

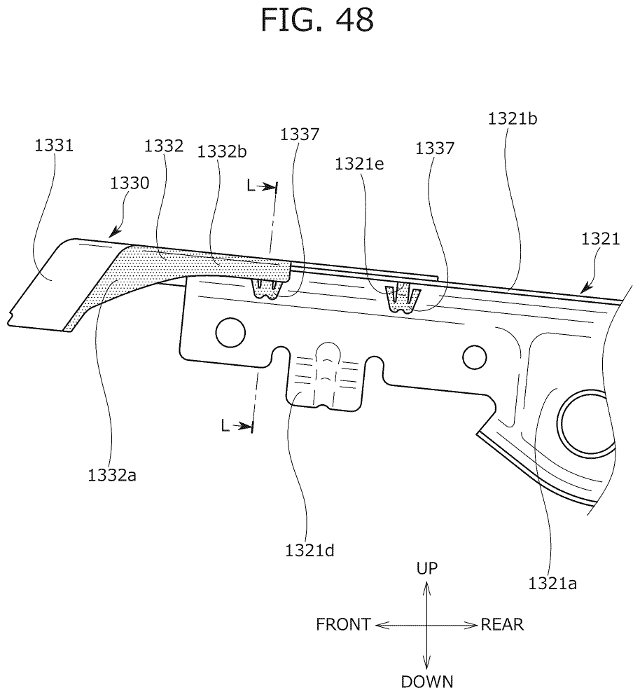

Particularly, as shown in FIG. 48, a front portion of the pan frame 1330 is a portion that is not supported by the side frames 1321, and needs to have higher rigidity than a rear portion of the pan frame 1330. For this reason, with the above-described configuration, the rigidity of the front portion of the pan frame 1330 can be effectively increased.

As shown in FIGS. 46 and 47, a plurality of the spring hook portions 1335 are formed by cutting and raising parts of the upper surface of the rear reinforcement portion 1333, and are formed with predetermined distances therebetween in the seat width direction.

A plurality of the skin hook portions 1336 are formed by cutting and raising parts of the upper surface of the front reinforcement portion 1334, and are formed with distances therebetween in the seat width direction.

The spring hook portions 1335 and the skin hook portions 1336 are disposed at different positions in the seat width direction.

As shown in FIGS. 48 to 50, a plurality of the engagement clips 1337 are engagement hooks that are long in the seat front to rear direction, and are formed with predetermined distances therebetween in the seat front to rear direction.

The engagement clip 1337 includes a clip body portion 1337a extending downward from the bottom surface of the frame side portion 1332, and a pair of engaging portions 1337b protruding from an extending end portion of the clip body portion 1337a in a direction orthogonal to an extending direction of the clip body portion 1337a (seat front to rear direction).

The pair of engaging portions 1337b protrude opposite to each other from the extending end portion of the clip body portion 1337a in a longitudinal direction (seat front to rear direction) of the engagement clip 1337, and extend while being inclined upward.

Incidentally, a recess 1337c having a substantially inverted triangular vertical cross section and recessed toward a side frame 1321 side is formed at a central portion of a bottom surface of the clip body portion 1337a, so that good flexibility is ensured.

With the above-described configuration, once the engagement clips 1337 engage with the engagement holes 1321e formed in the side frames 1321 through a single touch, the engagement clips 1337 firmly engage therewith.

### Additional Notes

According to the present invention, there is provided a conveyance seat including a cushion frame serving as a skeleton of a seat cushion. It is preferable that the cushion frame includes side frames disposed on right and left sides in a seat width direction and extending in a seat front to rear direction, and a bridging frame provided on the right and left side frames in a bridging manner and extending in the seat width direction, and that the bridging frame is formed by combining a first frame portion made of a first material and a second frame portion made of a second material different from the first material.

With the above-described configuration, the conveyance seat capable of suitably ensuring the rigidity of the seat frame while reducing the weight of the seat frame can be realized.

In more detail, the bridging frame that is a frame component is formed by combining the first frame portion made of the first material and the second frame portion made of the second material different from the first material. For this reason, for example, by making the bridging frame out of a combination of a metal material and a resin material, both a reduction in the weight of the cushion frame due to the adoption of the resin material and an improvement in rigidity due to the adoption of the metal material can be achieved. In addition, the material cost can be suppressed compared to when the entirety is made of a resin material.

### Eighth Embodiment

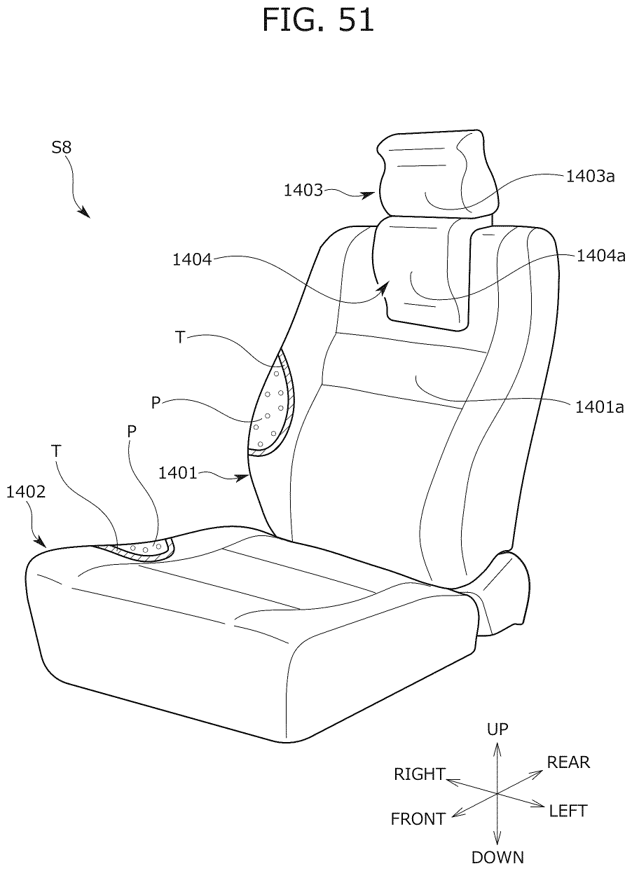

Next, a conveyance seat S8 of an eighth embodiment will be described with reference to FIGS. 51 to 58C.

Incidentally, the description of contents that overlap with those of the conveyance seats S1 to S7 described above will be omitted.

The conveyance seat S8 realizes a seat capable of restraining the neck of an occupant when a load is applied form the occupant.

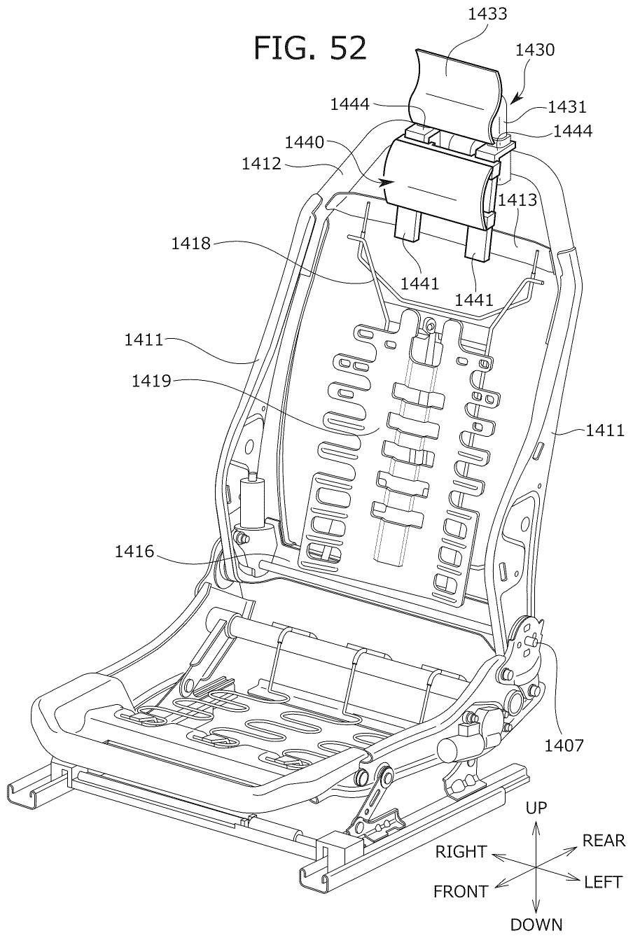

As illustrated in FIG. 51, the conveyance seat S8 includes, as main components, a seat back 1401, a seat cushion 1402, a headrest 1403, and a neck support 1404. The seat back 1401 is a backrest portion for a seated occupant H, and has a torso support surface 1401a that supports a back of a torso H3 of the occupant H. The seat cushion 1402 is a seating portion that supports the buttocks of the occupant H. The headrest 1403 is disposed on an upper portion of the seat back 1401, and has a head support surface 1403a that supports a head H1 of the occupant H. The neck support 1404 is disposed below the headrest 1403, and has a neck support surface 1404a that supports a neck H2 of the occupant H. The seat back 1401 and the seat cushion 1402 are connected to sandwich a reclining mechanism 1407 (refer to FIG. 52) therebetween. The seat back 1401 can be rotated by the reclining mechanism 1407 to adjust a rearward recline angle (backrest angle) with respect to the seat cushion 1402.

As shown in FIG. 52, the seat frame F is provided in the conveyance seat S8, and the seat frame F includes a seat back frame 1410 forming a skeleton of the seat back 1401, and a seat cushion frame 1420 forming a skeleton of the seat cushion 1402. In addition, the seat frame F includes a headrest frame 1430 forming a skeleton of the headrest 1403, and a neck support frame 1440 forming a skeleton of the neck support 1404.

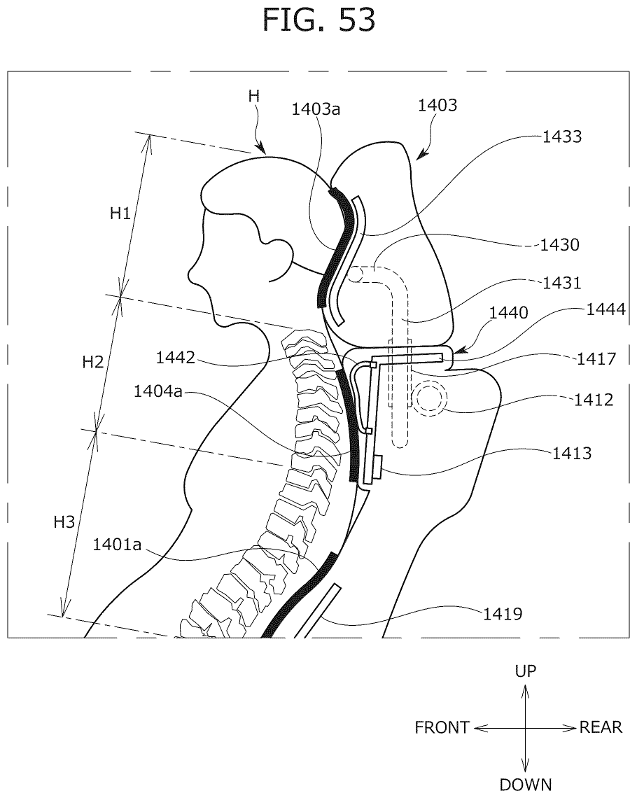

As shown in FIG. 52, the seat back frame 1410 is formed in a square frame shape as a whole, and the seat back frame 1410 includes a pair of back side frames 1411 disposed on both sides; the upper frame 1412; a cross member 1413; and a lower frame 1416. The upper frame 1412 is disposed between the pair of back side frames 1411, and connects upper end portions of the back side frames 1411. The lower frame 1416 is disposed between the pair of back side frames 1411, and connects lower end portions of the pair of back side frames 1411. In addition, headrest guides 1417 (refer to FIG. 53) having a tubular shape and supporting headrest pillars 1431 are attached to the upper frame 1412 of the seat back frame 1410.

The headrest 1403 is attached to the upper portion of the seat back 1401 so as to support the head of the occupant H. Inside the headrest 1403, the headrest frame 1430 forming a skeleton of the headrest 1403 is provided, and two headrest pillars 1431 (also referred to as headrest stays) hanging down from a lower portion of the headrest 1403 are provided at both right and left ends of the headrest frame 1430. By inserting the headrest pillars 1431 into headrest guides 1417 attached to the upper frame 1412 of the seat back frame 1410, the headrest 1403 is attached to the seat back frame 1410.

In addition, as shown in FIG. 52, the headrest 1403 includes a head support plate 1433, which supports the head H1 of the occupant H by receiving the head H1 of the occupant H when a rearward load acts on the occupant H, inside the headrest 1403. A cross section of the head support plate 1433 is formed in an S shape.

The pads P and the cushion trim covers T are provided on outer sides of the seat back frame 1410, the seat cushion frame 1420, and the headrest frame 1430. The pad P is, for example, a urethane base material molded by foam molding using a urethane foam material, and the cushion trim cover T is made of, for example, a skin material such as cloth, synthetic leather, or genuine leather.

The neck support 1404 is a member that supports the neck H2 of the occupant H from behind as described above, and as shown in FIG. 51, is installed below the headrest 1403. The neck support 1404 of the present embodiment includes a body 1450 having a rectangular parallelepiped shape in the front, and a surface (front end surface) of the body 1450 facing the occupant H serves as the neck support surface 1404a that supports the neck H2 of the occupant H. The neck support 1404 includes an upper attachment portion 1451 extending rearward from an upper end portion of the body 1450 having a rectangular parallelepiped shape. The neck support 1404 has an inverted L-shaped vertical cross section formed by the body 1450 and the upper attachment portion 1451. The neck support 1404 includes the neck support frame 1440 forming a skeleton of the neck support 1404, and the pad P and the cushion trim cover T covering a surface of the pad P are provided on the outer side of the neck support frame 1440. The neck support frame 1440 includes a pair of guide members 1441 provided on both sides, and upper attachment portion frames 1444 extending rearward from upper end portions of the guide members 1441. Rear end portions of the upper attachment portion frames 1444 are attached to the upper frame 1412.

Through holes 1451a are formed in the upper attachment portion 1451 of the neck support 1404. By inserting the headrest guides 1417 into the through holes 1451a, the upper attachment portion frames 1444 of the neck support 1404 is brought into contact with and fixed to the upper frame 1412. In addition, the headrest 1403 is supported by inserting the headrest pillars 1431 of the headrest 1403 into the headrest guides 1417.

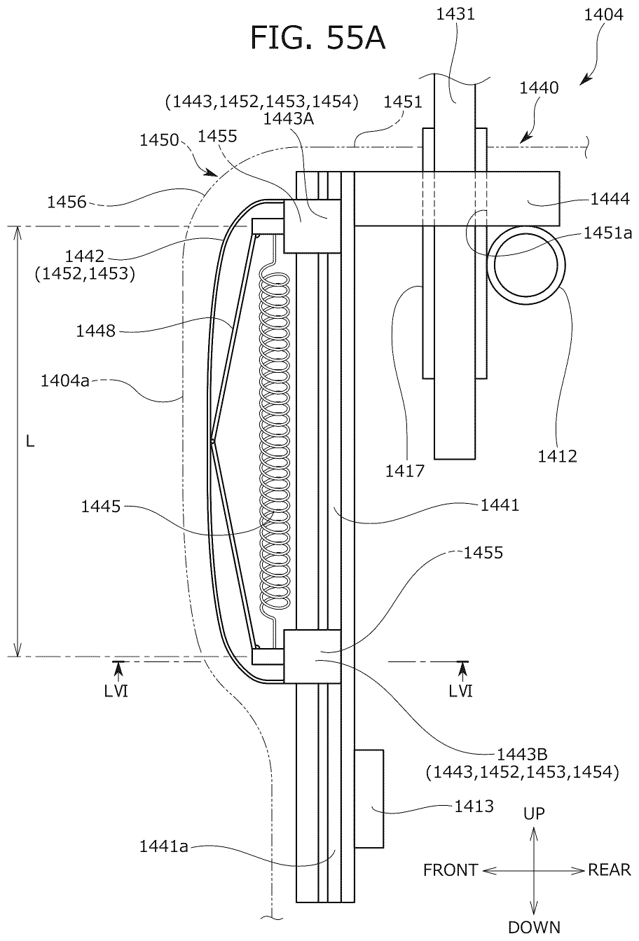

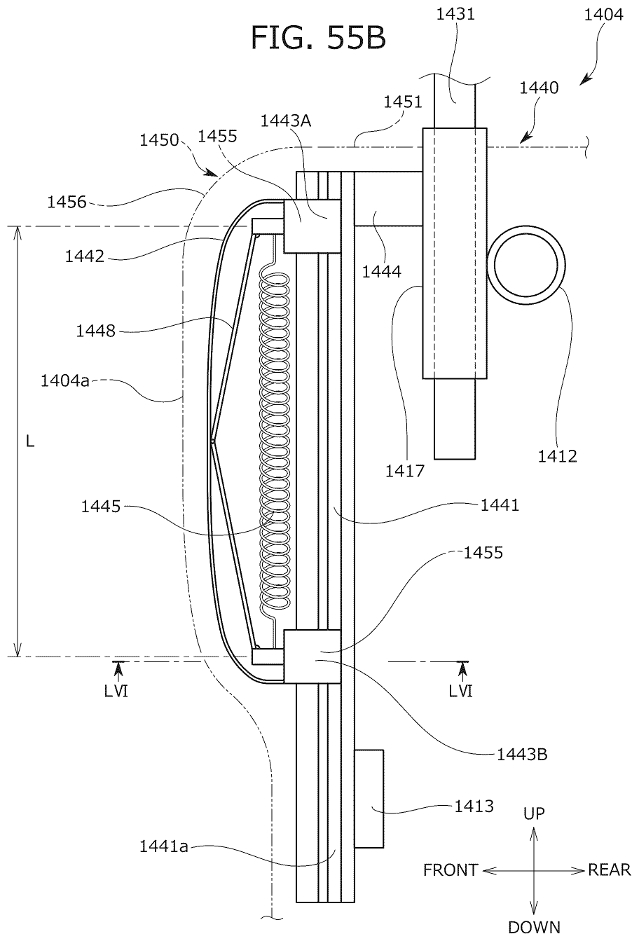

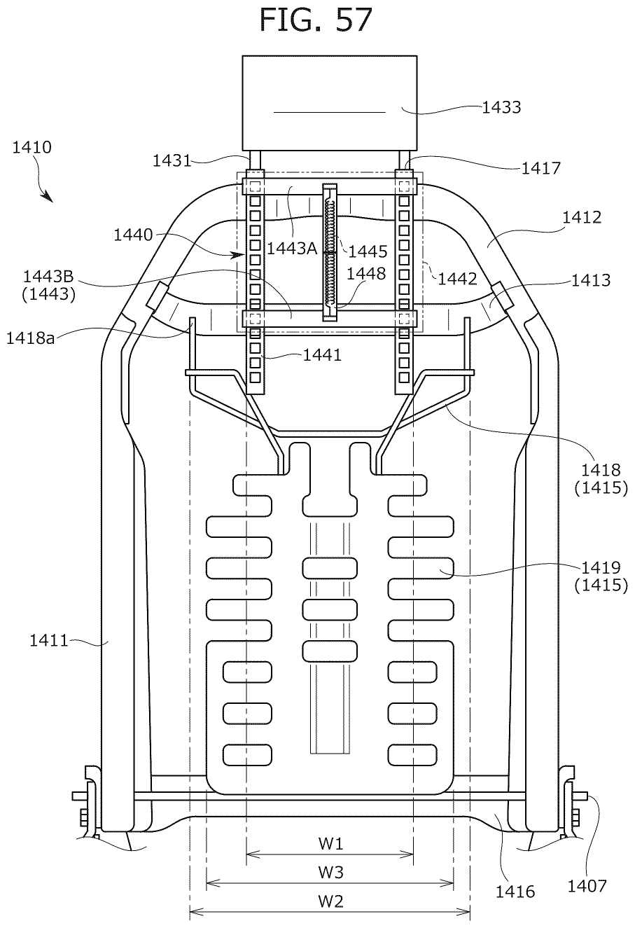

As shown in FIGS. 52 and 57, lower end portions of the guide members 1441 are fixed to the cross member 1413. The upper attachment portion frames 1444 extending from upper ends of the guide members 1441 are fixed to the upper frame 1412, and the lower end portions of the guide members 1441 are fixed to the cross member 1413, so that attachment rigidity is improved. In addition, as shown in FIGS. 52 and 55, the guide members 1441 are disposed in front of the headrest pillars 1431. Interference between the guide members 1441 and the headrest pillars 1431 is suppressed, so that the occurrence of abnormal noise due to contact is suppressed.

The neck support 1404 is provided with an adjustment mechanism 1452 that adjusts a shape of the neck support surface 1404a. The neck support surface 1404a includes a protruding portion 1456 protruding forward. The protruding portion 1456 comes into contact with the neck H2 of the occupant H. The adjustment mechanism 1452 includes a protrusion amount adjustment portion 1453 that adjusts a protrusion amount of the protruding portion of the neck support surface 1404a in the front to rear direction, and an up and down position adjustment portion 1454 that adjusts a position of the protruding portion 1456 of the neck support surface 1404a in an up to down direction. In addition, the adjustment mechanism 1452 includes lock portions 1455 that lock a position of the protruding portion 1456 such that the position of the protruding portion 1456 adjusted by the up and down position adjustment portion 1454 is not changed when a load is applied to the neck support surface 1404a from the occupant in the event of a rear collision, namely, when the protruding portion 1456 is pushed rearward.

Since a change in the position of the protruding portion 1456 is prevented by the lock portions 1455, the neck H2 of the occupant can be restrained by the neck support surface 1404a. In addition, as described above, the torso H3 of the occupant H can be restrained by a torso support plate 1419 that supports the torso support surface 1401a of the seat back 1401, and the head H1 of the occupant can be restrained by the head support plate 1433 that supports the head support surface 1403a of the headrest 1403. For this reason, as shown in FIG. 53, a continuous restraining surface along a shape of the backbone can be formed by the head support surface 1403a of the headrest 1403, the neck support surface 1404a, and the torso support surface 1401a of the seat back 1401, and the conveyance seat S8 can move the occupant H rearward in a state where a shape of the spine of the occupant H is maintained in the event of a rear collision. When the phenomenon of sinking into the seat occurs, the sinking amount of the chest of the occupant H is reduced, and a difference between the head and the neck is reduced, so that the occurrence of a hunched state in the occupant H is suppressed and a load acting on the occupant H in the event of a rear collision is effectively reduced.

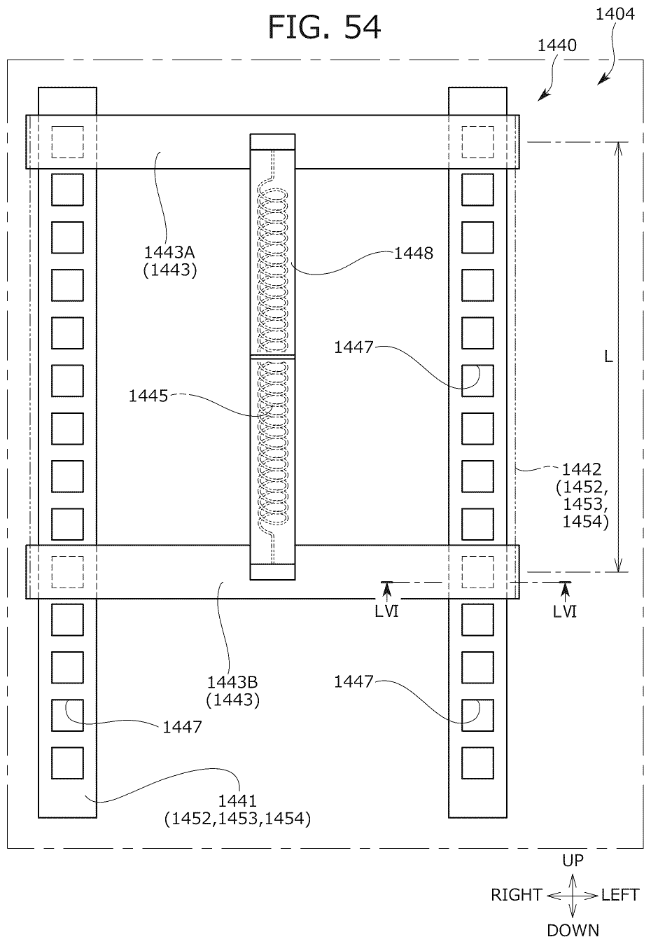

A specific internal configuration of the adjustment mechanism 1452 of the neck support 1404 will be described with reference to FIGS. 54 to 56. As shown in FIGS. 54 and 55A, the adjustment mechanism 1452 includes the pair of guide members 1441 extending in the up to down direction of the conveyance seat S8, and a neck support plate 1442 (support member) forming the shape of the neck support surface 1404a and attached to be movable in the up to down direction along the guide members 1441.

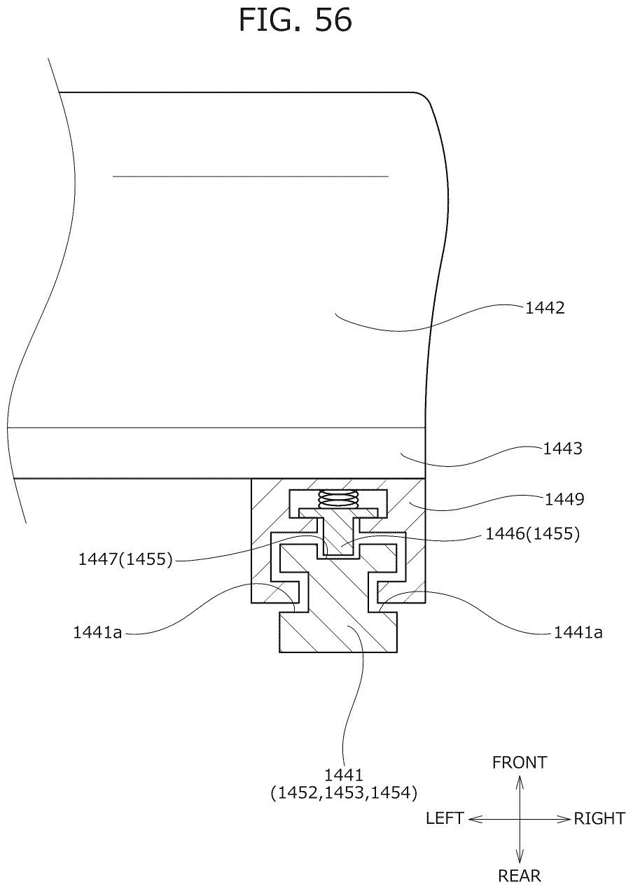

The guide members 1441 are elongated members that guide the neck support plate 1442 in the up to down direction. As shown in FIG. 56, grooves 1441a extending along a longitudinal direction are formed at both side portions of the guide members 1441. In addition, a plurality of recesses 1447 for locking a position of the neck support plate 1442 are formed side by side on front surfaces of the guide members 1441. By inserting latch pieces 1446 of the lock portions 1455 to be described later into the recesses 1447, a position of end portions of the neck support plate 1442 (position holding member 1443) is fixed.

The neck support plate 1442 is a plate-shaped member made of metal. As shown in FIG. 55A, by adjusting a distance L between an upper end portion and a lower end portion of the neck support plate 1442, the deflection amount of the neck support plate 1442 is changed, so that the protruding portion 1456 of the neck support surface 1404a can be formed. For example, when the distance L is shortened by moving a second position holding member 1443B to be described later to an upper side, the neck support plate 1442 protrudes further forward.

Incidentally, the neck support plate 1442 is formed from a thin metal plate, but may be formed from a thin resin plate.

The neck support plate 1442 includes a first position holding member 1443A that holds a position of the upper end portion of the neck support plate 1442, and the second position holding member 1443B that holds a position of the lower end portion.

The first position holding member 1443A and the second position holding member 1443B are attached to front sides of the guide members 1441 so as to be movable upward and downward along the guide members 1441.

The first position holding member 1443A and the second position holding member 1443B have the same configuration. For this reason, in the following description, unless there is a particular need to distinguish between the first position holding member 1443A and the second position holding member 1443B, the first position holding member 1443A and the second position holding member 1443B will be simply described as the “position holding member 1443”.

As shown in FIG. 56, the position holding member 1443 includes holding portions 1449 that hold the guide members 1441, and by inserting tips of the holding portions 1449 into the grooves 1441a of the guide members 1441, the position holding member 1443 is slidable in the up to down direction while holding the guide members 1441.

The lock portions 1455 that lock the movement of the position holding member 1443 in the up to down direction are provided between the guide members 1441 and the position holding member 1443. A position of the neck support plate 1442 in the up to down direction is locked by locking the movement of the position holding member 1443.

The lock portion 1455 includes the latch piece 1446 provided in the holding portion 1449 of the position holding member 1443 and biased toward the guide member 1441, and a plurality of the recesses 1447 which are formed on the front surface of the guide member 1441 and into which the latch piece 1446 can be inserted. The plurality of recesses 1447 are formed side by side on the front surface of the guide member 1441 in the longitudinal direction (up to down direction) of the guide member 1441. Inertia locking can be formed by the latch pieces 1446 and the recesses 1447, and the position holding member 1443 can be locked on the guide members 1441 at any position where the recesses 1447 are located. Since the lock portions 1455 are provided between the guide members 1441 and the position holding member 1443, the lock portions 1455 can be protected in a normal state.

Incidentally, other than a structure in which locking is performed by the latch pieces 1446 and the recesses 1447, the lock portions 1455 may have a structure in which a position of the position holding member 1443 is locked by inserting pins into recesses or through holes formed on lateral sides of the holding portions 1449 and the guide members 1441.

Incidentally, the protrusion amount adjustment portion 1453 is realized by the neck support plate 1442 and the position holding member 1443 that fixes the positions of the upper and lower end portions of the neck support plate 1442 to the guide members 1441. The up and down position adjustment portion 1454 is realized by the position holding member 1443 and the guide members 1441 of which the position is movable upward and downward.

A spring 1445 (biasing member) that biases the first position holding member 1443A and the second position holding member 1443B toward each other is provided therebetween. In the present embodiment, the biasing spring 1445 is formed of one tension coil spring disposed at a central portion, but may be realized by a plurality of coil springs.

By providing the spring 1445, an assisting force can be obtained when the protrusion amount by the neck support plate 1442 is increased, namely, when the first position holding member 1443A and the second position holding member 1443B are brought closer to each other. In addition, by providing the spring 1445 at the central portion of the position holding member 1443 in the seat width direction, a biasing force by the spring 1445 can be stabilized.

As shown in FIGS. 54 and 55A, a shape-maintaining member 1448 is provided between the first position holding member 1443A and the second position holding member 1443B. An upper end portion and a lower end portion of the shape-maintaining member 1448 are rotatably attached to the first position holding member 1443A and the second position holding member 1443B. In addition, the shape-maintaining member 1448 is formed to be bendable at a central portion in the up to down direction. When the distance L between the first position holding member 1443A and the second position holding member 1443B is shortened, the central portion of the shape-maintaining member 1448 protrudes forward, thereby supporting the neck support plate 1442, which is curved forward, from behind.

By providing the shape-maintaining member 1448, the neck support plate 1442 that is curved is supported from behind, and a restraining force on the neck in the event of a rear collision is reinforced.

The guide members 1441 shown in FIGS. 52, 53, and 55A are located in front of the headrest guides 1417, and the upper attachment portion frames 1444 extending rearward from the upper ends of the guide members 1441 are fixed to the upper frame 1412. This configuration is one example, and as shown in FIG. 55B, the upper attachment portion frames 1444 may be directly fixed to front portions of the headrest guides 1417. The need for the through holes 1451a through which the headrest guides 1417 pass is eliminated, so that assembly is facilitated.

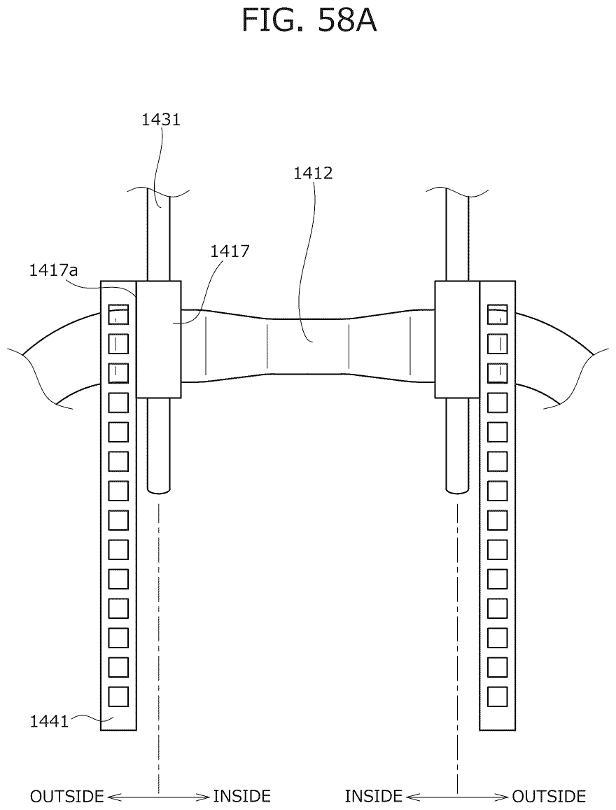

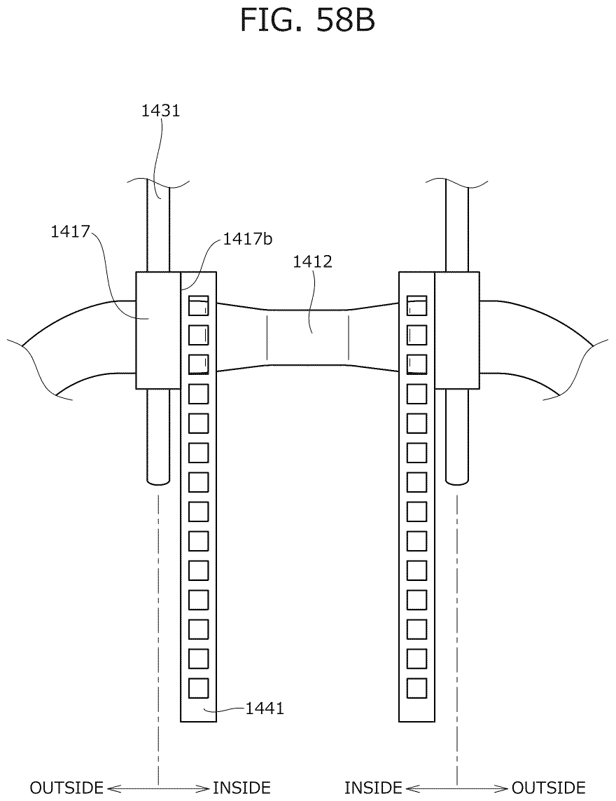

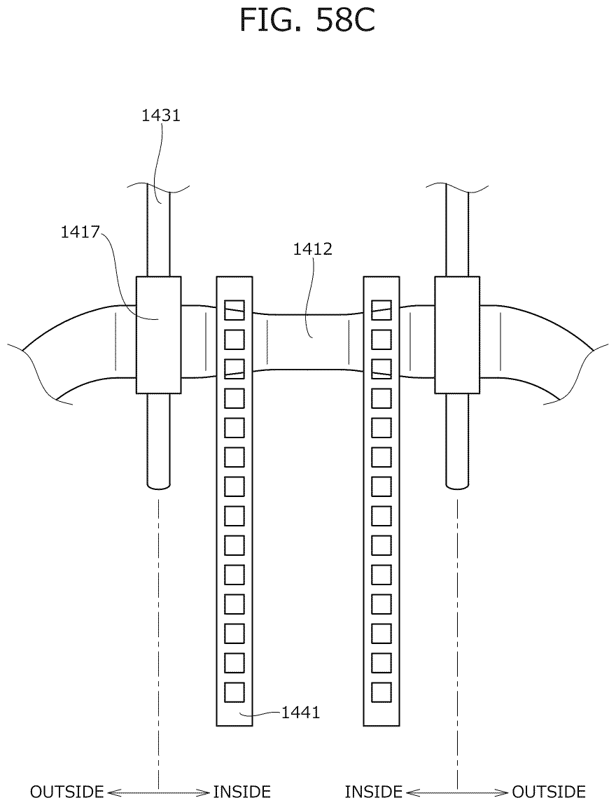

In addition, a width W1 of the neck support is smaller than a distance by which a pair of the headrest guides 1417 are separated from each other (refer to FIG. 58C), and the upper attachment portion frames 1444 may be fixed to the upper frame 1412 so as to avoid the headrest guides 1417. By disposing the upper attachment portion frames 1444 between the pair of headrest guides 1417, the guide members 1441 can be located behind the headrest guides 1417, and accordingly, an increase in size in the front to rear direction can be suppressed, and a distance between the guide members 1441 and the upper frame 1412 is shortened, so that the rigidity is improved.

In addition, as shown in FIG. 57, the positions of the guide members 1441 in the seat width direction are located inside connection portions between an attachment wire 1418 and the cross member 1413. In other words, the width W1 of the neck support 1404 is narrower than a distance between the connection portions (width W2). By providing the guide members 1441 inside the connection portions, the occurrence of abnormal noise due to contact between the guide members 1441 and the attachment wire 1418 can be suppressed while an increase in the size of the neck support 1404 in a right to left direction is suppressed.

In addition, as shown in FIG. 57, the width W1 of the neck support 1404 (a distance in the width direction between the guide members 1441 located on the right and left) is formed to be narrower than a width W3 of the torso support plate 1419. Accordingly, an increase in the size of the neck support 1404 is suppressed.

### Additional Notes

According to the present invention, there is provided a conveyance seat including: a seat back serving as a backrest for an occupant; a headrest which is provided on the seat back and of which an up and down position is adjustable; and a neck support provided below the headrest and having a neck support surface that supports a neck of the occupant. It is preferable that the neck support is provided with an adjustment mechanism that adjusts the neck support surface, and that the adjustment mechanism includes a protrusion amount adjustment portion that adjusts a protrusion amount of the neck support surface in a front to rear direction, an up and down position adjustment portion that adjusts a position of the neck support surface in an up to down direction, and a lock portion that locks a position of the up and down position adjustment portion when a load is applied to the neck support surface from the occupant in an event of a rear collision.

In the conveyance seat of the present invention configured as described above, since the adjustment mechanism that adjusts the neck support surface, namely, the lock portion of the adjustment mechanism locks the position of the up and down position adjustment portion when a load is applied to the neck support surface from the occupant in the event of a rear collision, the neck support surface can restrain the neck of the occupant without moving.

### Ninth Embodiment

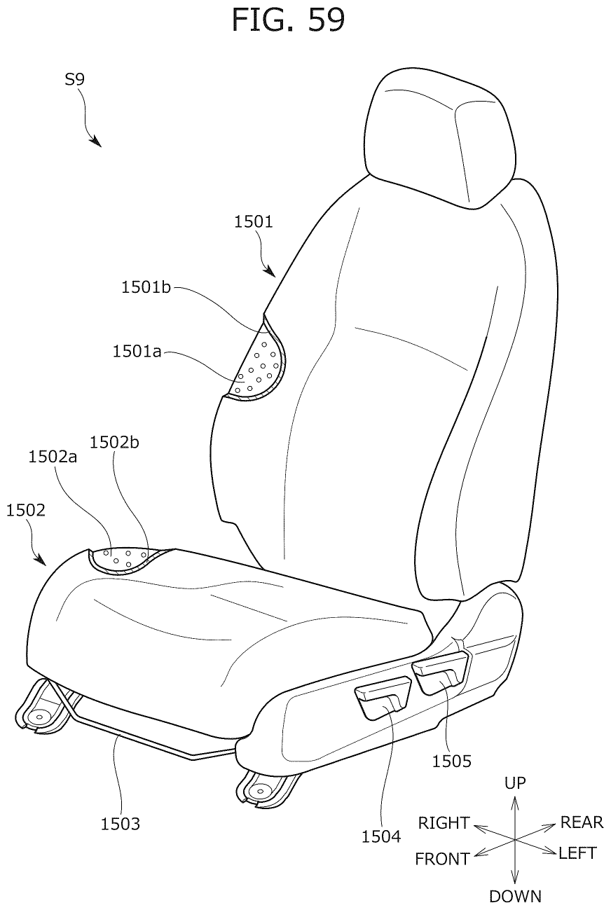

Next, a conveyance seat S9 of a ninth embodiment will be described with reference to FIGS. 59 to 65.

Incidentally, the description of contents that overlap with those of the conveyance seats S1 to S8 described above will be omitted.

The conveyance seat S9 realizes a seat capable of improving the efficiency of the assembly work of a seat frame serving as a skeleton.

In addition, the conveyance seat S9 realizes a seat capable of improving the efficiency of the assembly work of a frame by reducing the man-hours of the assembly work and by reducing the number of components of the seat frame.

In addition, the conveyance seat S9 realizes a seat capable of suitably accepting a load even when the load is applied in a predetermined direction during use.

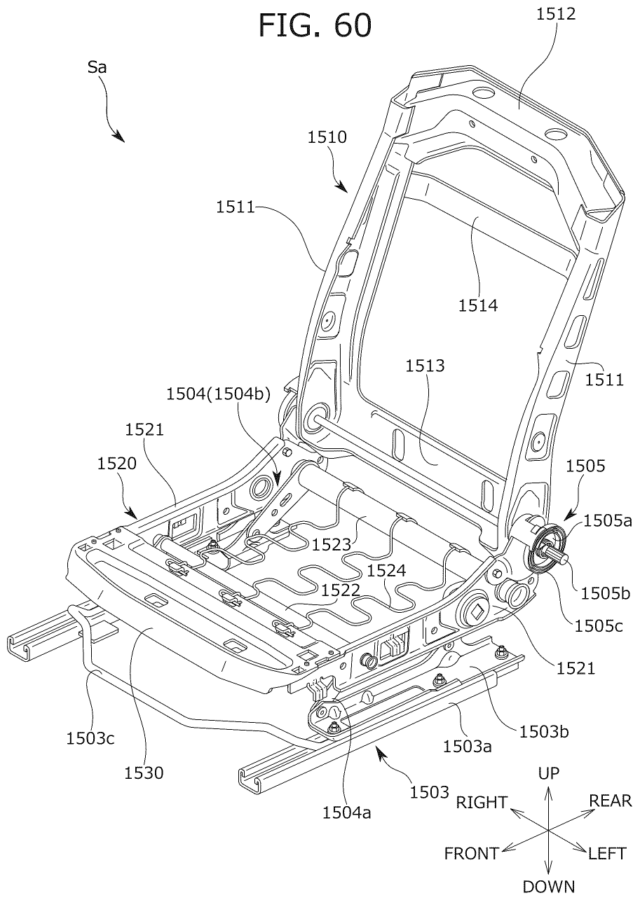

The conveyance seat S9 is, as shown in FIG. 59, a vehicle seat, and mainly includes a seat body including a seat back 1501 and a seat cushion 1502, and as shown in FIG. 60, a rail device 1503 that supports the seat body so as to be movable forward and rearward with respect to a vehicle body floor, a height link device 1504 that connects the seat body to the vehicle body floor so as to be raisable and lowerable, and a reclining device 1505 that rotatably connects the seat back 1501 to the seat cushion 1502.

As shown in FIG. 59, the seat back 1501 is a backrest portion that supports a seated occupant from behind, and is configured by placing a cushion material 1501a on a back frame 1510 serving as a skeleton shown in FIG. 60, and by covering the cushion material 1501a with a skin material 1501b.

The seat cushion 1502 is a seating portion that supports the seated occupant from below, and is configured by placing a cushion material 1502a on a cushion frame 1520 serving as a skeleton shown in FIG. 60, and by covering the cushion material 1502a with a skin material 1502b.

As shown in FIG. 60, the rail device 1503 is disposed between the seat body and the vehicle body floor in an up to down direction, and mainly includes right and left lower rails 1503a fixed to the vehicle body floor and extending in a seat front to rear direction; right and left upper rails 1503b supported to be slidable along the lower rails 1503a; a lock member (not shown) that non-slidably locks the upper rails 1503b to the lower rails 1503a; and a rail operating lever 1503c for releasing a locked state of the lock member.

The cushion frame 1520 is provided on upper surfaces of the right and left upper rails 1503b via the height link device 1504 in a bridging manner.

As shown in FIG. 60, the height link device 1504 is attached between the rail device 1503 and the cushion frame 1520, and mainly includes right and left first links 1504a disposed on a seat front side; right and left second links 1504b disposed on a seat rear side; a lock member (not shown) that locks the seat body so as not to be raisable and lowerable; and a height operating lever (not shown) for releasing a locked state of the lock member. Further, the second links 1504b are devices that serve as drive links to be able to adjust a height of the seat body.

As shown in FIG. 60, the reclining device 1505 mainly includes a reclining body 1505a that is driven when the back frame 1510 is rotated; rotating shafts 1505b; a spiral spring 1505c that biases the back frame 1510 to rotate forward about the rotating shafts 1505b; and a reclining operating lever (not shown) operated to release a locked state of the back frame 1510.

The reclining body 1505a includes a known lock mechanism, and can switch the state of the back frame 1510 between a locked state where the back frame 1510 is fixed to the cushion frame 1520 and an unlocked state where the back frame 1510 is rotatable with respect to the cushion frame 1520.

The rotating shafts 1505b are supported on a back frame 1510 side and on a cushion frame 1520 side in the seat width direction, and the spiral spring 1505c is configured such that one end portion of the spiral spring 1505c is latched to the back frame 1510 side and the other end portion is latched to the cushion frame 1520 side.

As shown in FIG. 60, the back frame 1510 is formed of a substantially rectangular frame-shaped body, and mainly includes back side frames 1511 disposed on right and left sides; an upper frame 1512 having an inverted U shape and connecting upper end portions of the back side frames 1511; a lower frame 1513 having a plate shape and connecting lower end portions of the back side frames 1511; a member frame 1514 connecting upper portions of the back side frames 1511; and elastic springs (not shown) hooked to each of the back side frames 1511 and extending in a meandering manner.

The back side frames 1511 are sheet material members extending in the up to down direction and having substantially C-shaped lateral cross sections, and the lower end portions of the back side frames 1511 are connected to rear end portions of side frames 1521 via the reclining device 1505.

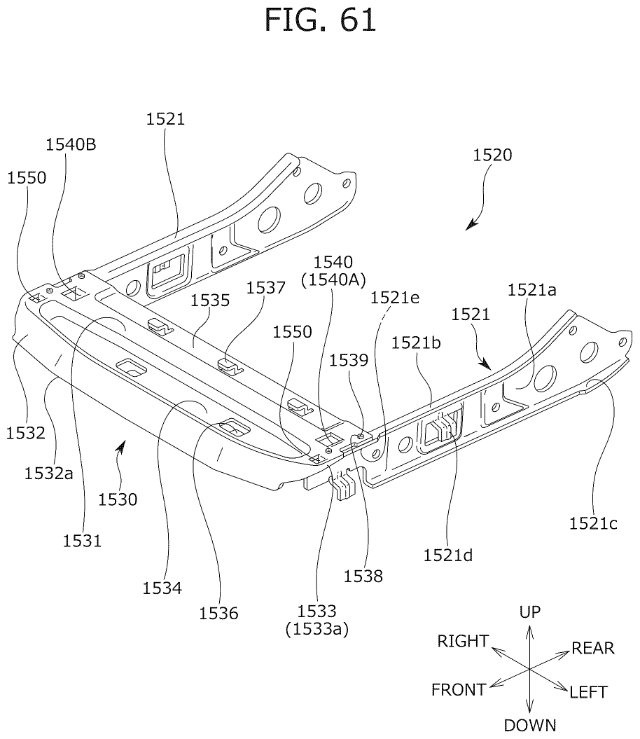

As shown in FIGS. 60 and 61, the cushion frame 1520 is formed of a substantially rectangular frame-shaped body, and mainly includes the side frames 1521 disposed on the right and left sides and extending in the seat front to rear direction; a pan frame 1530 having a plate shape and provided on front end portions of the side frames 1521 in a bridging manner; a front connecting frame 1522 connecting front portions of the side frames 1521; a rear connecting frame 1523 connecting rear portions of the side frames 1521; and a plurality of elastic springs 1524 hooked to the pan frame 1530 and the rear connecting frame 1523 and extending in a meandering manner in the seat front to rear direction.

As shown in FIGS. 60 to 63, the side frame 1521 is a plate-shaped frame that is long in the seat front to rear direction, and includes a frame body portion 1521a and an upper end flange portion 1521b and a lower end flange portion 1521c that are bent and protrude outward in the seat width direction from an upper end portion and a lower end portion of the frame body portion 1521a, respectively.

In addition, the side frame 1521 includes skin hook portions 1521d formed by cutting and raising parts of a side surface of the frame body portion 1521a and used for hooking terminal portions of the skin material 1502b.

In addition, the side frame 1521 has attachment holes 1521e (attaching portion) formed in an upper surface of the upper end flange portion 1521b and used for attaching the pan frame 1530.

A plurality of the skin hook portions 1521d and a plurality of the attachment holes 1521e are formed with predetermined distances therebetween in the seat front to rear direction.

Incidentally, the reclining device 1505 is attached to the rear end portions of the side frames 1521.

As shown in FIG. 60, each of the front connecting frame 1522 and the rear connecting frame 1523 is a pipe-shaped frame, and connects the right and left side frames 1521 and connects the respective right and left links (the first links 1504a and the second links 1504b).

The plurality of elastic springs 1524 are elastic support members that support the buttocks of the seated occupant, and are provided with predetermined distances therebetween in the seat width direction.

Front end portions of the elastic springs 1524 are hooked to spring hook portions 1537 formed on an upper surface of the pan frame 1530. In addition, rear end portions of the elastic springs 1524 are attached to the rear connecting frame 1523 via hook members.

As shown in FIGS. 60 to 63, the pan frame 1530 is a plate-shaped frame (connecting frame) provided on upper surfaces of the right and left side frames 1521 in a bridging manner and supporting the thighs of the seated occupant, and side portions of the pan frame 1530 in the seat width direction are placed and attached to the upper surfaces of the side frames 1521.

Specifically, the pan frame 1530 mainly includes a frame body portion 1531 having a rectangular plate shape that is long in the seat width direction; a frame front wall portion 1532 protruding downward from a front end portion of the frame body portion 1531; and right and left frame side wall portions 1533 protruding downward from both right and left end portions of the frame body portion 1531.

Incidentally, bent portions 1532a and 1533a formed by bending tips of tip portions of the frame front wall portion 1532 and the frame side wall portions 1533 upward are formed at the tip portions thereof.

The bent portion 1532a is continuously formed to extend along the seat width direction, and specifically, is formed by curling.

In addition, the bent portion 1533a is continuously formed to extend along the seat front to rear direction.

For this reason, manufacturing cost (mold cost) can be suppressed compared to hemming or drawing in the related art.

As shown in FIGS. 61 to 63, the pan frame 1530 includes a first reinforcement recess 1534 and a second reinforcement recess 1535 formed as recesses on an upper surface of the frame body portion 1531 and extending in the seat width direction.

Each of the first reinforcement recess 1534 and the second reinforcement recess 1535 is a substantially rectangular reinforcement portion that is long in the seat width direction, and the first reinforcement recess 1534 is disposed at a seat front position with respect to the second reinforcement recess 1535.

Skin hook portions 1536 for hooking terminal portions of the skin material 1502b are formed on an upper surface of the first reinforcement recess 1534.

In addition, the spring hook portions 1537 for hooking one ends of the elastic springs 1524 are formed on an upper surface of the second reinforcement recess 1535.

A plurality of the skin hook portions 1536 are formed by cutting and raising parts of the upper surface of the first reinforcement recess 1534, and are formed with distances therebetween in the seat width direction.

A plurality of the spring hook portions 1537 are formed by cutting and raising parts of the upper surface of the second reinforcement recess 1535, and are formed with predetermined distances therebetween in the seat width direction.

The skin hook portions 1536 and the spring hook portions 1537 are disposed at different positions in the seat width direction.

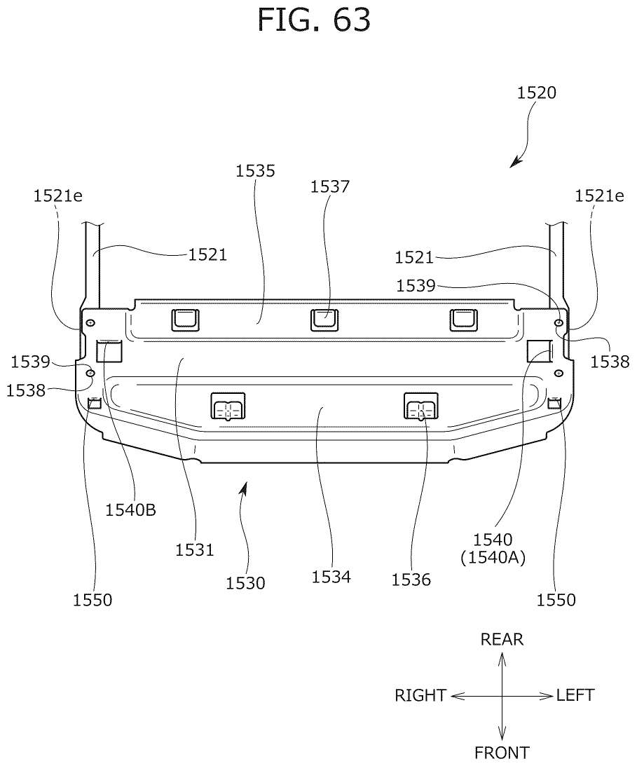

As shown in FIGS. 61 and 63, the pan frame 1530 includes right and left attachment holes 1538 formed at both respective end portions in the seat width direction of the frame body portion 1531 and used for attaching the right and left side frames 1521.

By fastening attachment bolts 1539 in a state where the attachment holes 1538 of the pan frame 1530 and the attachment holes 1521e of the side frames 1521 are in communication with each other, the pan frame 1530 is assembled to the side frames 1521.

A plurality of the right attachment holes 1538 and a plurality of the left attachment holes 1538 are formed with distances therebetween in the seat front to rear direction. In the present embodiment, two attachment holes 1538 and two left attachment holes 1538 are formed.

### Frame Contact Portion>>

As shown in FIGS. 61 to 63, the pan frame 1530 includes a frame contact portion 1540 that is provided on a back surface of the frame body portion 1531 to protrude to a lower side and that comes into contact with inner surfaces of the side frames 1521, and second frame contact portions 1550 that come into contact with front surfaces of the side frames 1521.

The frame contact portion 1540 is a cut and raised portion having a substantially rectangular plate shape and formed by cutting out a part of the frame body portion 1531, and includes a left frame contact portion 1540A formed on one side (left side) in the seat width direction, and a right frame contact portion 1540B formed on the other side (right side) in the seat width direction.

The frame contact portion 1540 is formed to come into contact with (abut against) an upper portion of the inner surfaces of the side frames 1521.

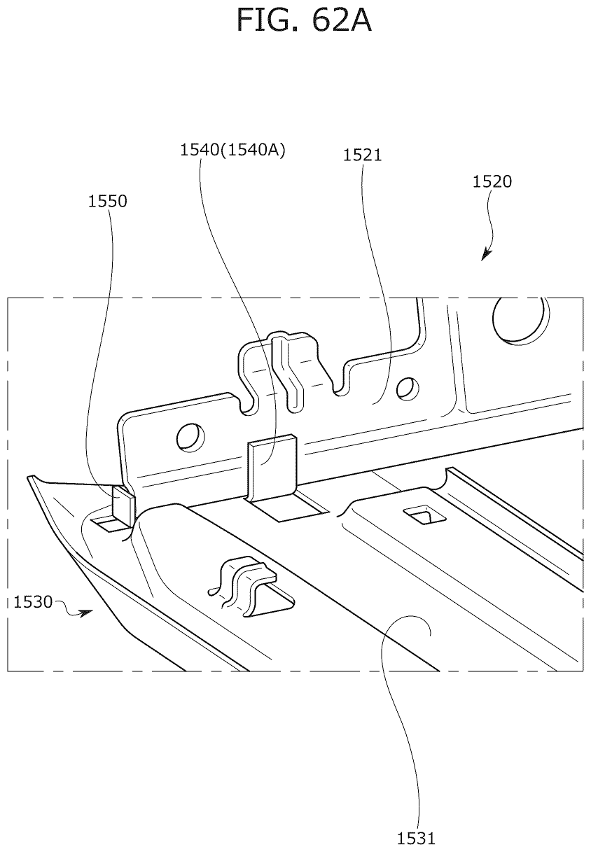

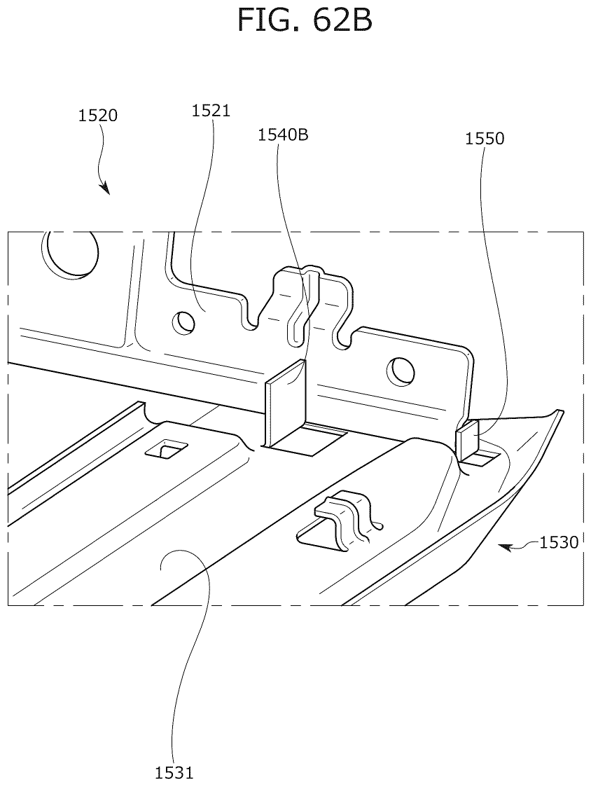

As shown in FIG. 62A, the left frame contact portion 1540A is cut and raised outward in the seat width direction (toward the side frame 1521) from the back surface of the frame body portion 1531. Further, the left frame contact portion 1540A extends along a longitudinal direction of the side frames 1521 while being in contact with the inner surface of the side frames 1521. In other words, the left frame contact portion 1540A is in surface contact with the inner surface of the side frame 1521.

As shown in FIG. 62B, the right frame contact portion 1540B is cut and raised toward the rear of the seat from the back surface of the frame body portion 1531. Further, the right frame contact portion 1540B is configured such that an outer end portion thereof in the seat width direction comes into contact with the inner surface of the side frame 1521, and extends along a direction intersecting (orthogonal to) the longitudinal direction of the side frames 1521. In other words, the right frame contact portion 1540B is in surface contact with the inner surface of the side frame 1521.

As shown in FIG. 63, each of the frame contact portions 1540A and 1540B is formed on a bottom surface of the pan frame 1530 at a position avoiding the first reinforcement recess 1534 and the second reinforcement recess 1535.

In addition, the frame contact portions 1540A and 1540B are formed on the left side and on the right side in the seat width direction, respectively, and are disposed at positions where the second reinforcement recess 1535 is sandwiched therebetween in the seat width direction.

In addition, the frame contact portions 1540A and 1540B are disposed between the first reinforcement recess 1534 and the second reinforcement recess 1535 in the seat front to rear direction.

As described above, when the frame contact portion 1540 is formed by cutting and raising a part of the pan frame 1530, by cutting and raising the part while avoiding the first reinforcement recess 1534 (second reinforcement recess 1535) of the pan frame 1530, a downward protrusion amount of the frame contact portion 1540 can be reduced. Accordingly, interference of the frame contact portion 1540 with other components (for example, a harness) inside the cushion frame 1520 can be suppressed.

In addition, as described above, the frame contact portion 1540 can be disposed at a position around the first reinforcement recess 1534 and the second reinforcement recess 1535, and the rigidity of the frame contact portion 1540 can be increased.

As shown in FIG. 63, the frame contact portions 1540A and 1540B are disposed between a plurality of attachment bolts 1539 (attachment holes 1538) in the seat front to rear direction.

For this reason, when the pan frame 1530 is connected to the side frames 1521, the positions of both the frames can be restricted in a well-balanced manner by the frame contact portions 1540A and 1540B. In addition, with the above-described configuration, the rigidity of the frame contact portions 1540A and 1540B can also be increased.

As shown in FIGS. 62A and 62B, the second frame contact portions 1550 are cut and raised portions having a substantially rectangular plate shape and formed by cutting out parts of the frame body portion 1531, and are formed on the right and left sides in the seat width direction. Further, the second frame contact portions 1550 are formed to come into contact with upper portions of the front surfaces of the side frames 1521.

In more detail, the second frame contact portions 1550 are cut and raised toward the rear of the seat (toward the side frames 1521) from the back surface of the frame body portion 1531. Further, the second frame contact portions 1550 come into contact with the front surfaces of the side frames 1521, and extend along the direction intersecting (orthogonal to) the longitudinal direction of the side frames 1521.

The second frame contact portions 1550 are formed on the bottom surface of the pan frame 1530 at positions avoiding the first reinforcement recess 1534 and the second reinforcement recess 1535.

In addition, the right and left second frame contact portions 1550 are disposed at positions where the first reinforcement recess 1534 and the second reinforcement recess 1535 are sandwiched therebetween in the seat width direction.

In addition, the second frame contact portions 1550 are disposed at positions overlapping the first reinforcement recess 1534 in the seat front to rear direction.

With the above-described configuration, the second frame contact portions 1550 can be suitably disposed at positions different from those of the first reinforcement recess 1534 and the second reinforcement recess 1535.

In addition, as described above, the second frame contact portions 1550 can be disposed at positions around the first reinforcement recess 1534, and the rigidity of the second frame contact portions 1550 can also be increased.

### Modification Examples of Frame Contact Portion

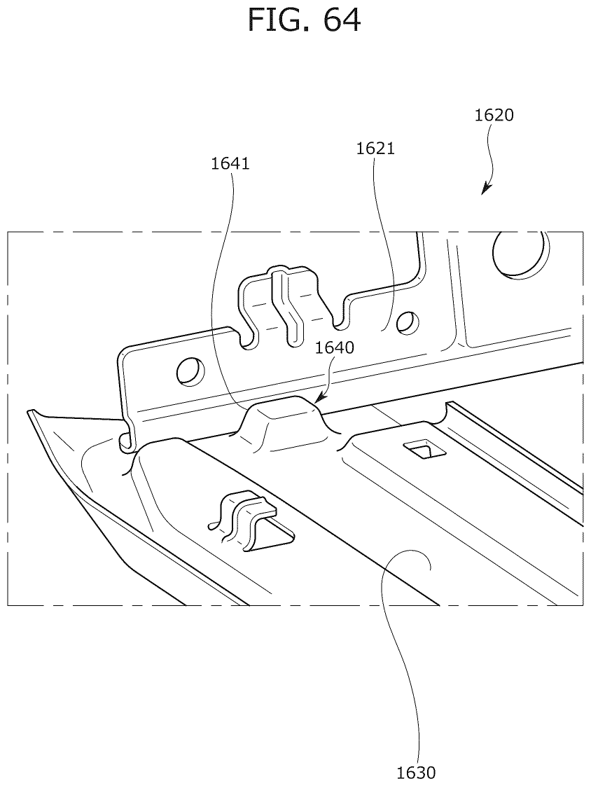

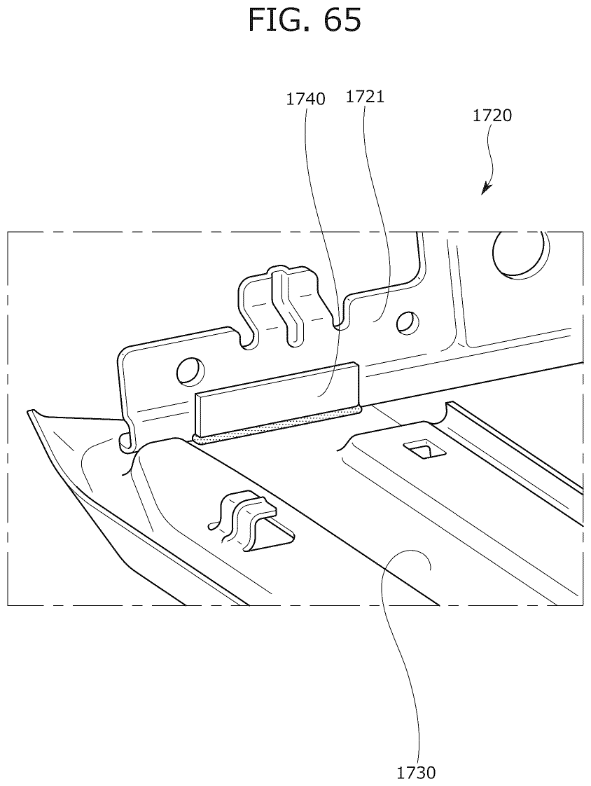

Next, modification examples of the frame contact portion 1540 will be described with reference to FIGS. 64 and 65.

Incidentally, the description of contents that overlap with those of the frame contact portion 1540 described above will be omitted.

As shown in FIG. 64, frame contact portions 1640 of a first modification example are, for example, formed by press forming, and have a recessed shape that is recessed to a lower side from an upper surface of a pan frame 1630.

The frame contact portions 1640 are configured such that outer wall portions 1641 thereof in the seat width direction come into contact with inner surfaces of side frames 1621, and extend along a longitudinal direction of the side frames 1621.

Even with the above-described configuration, when the pan frame 1630 is connected to the right and left side frames 1621, the frame contact portions 1640 can be brought into contact with the inner surfaces of the right and left side frames 1621, and the positions of both the frames in the seat width direction can be easily restricted. As a result, the man-hours of the assembly work of both the frames can be reduced.

As shown in FIG. 65, frame contact portions 1740 of a second modification example are, for example, plate-shaped frame pieces that are separately attached to a back surface of a pan frame 1730.

The frame contact portions 1740 extend along a longitudinal direction of the side frames 1721 while being in contact with inner surfaces of side frames 1721.

Even with the above-described configuration, when the pan frame 1730 is connected to the right and left side frames 1721, the frame contact portions 1740 can be brought into contact with the inner surfaces of the right and left side frames 1721, and the positions of both the frames in the seat width direction can be easily restricted.

### Others

In the above-described embodiment, as shown in FIGS. 62A and 62B, the pan frame 1530 includes the frame contact portion 1540, which comes into contact with the inner surfaces of the side frames 1521, on the back surface of the pan frame 1530; however, the present invention is not particularly limited, and a frame other than the pan frame 1530 may include the frame contact portion 1540.

For example, the front connecting frame 1522 or the rear connecting frame 1523 may include frame contact portions that come into contact with the inner surfaces of the side frames 1521.

In addition, for example, the member frame 1514 may include frame contact portions that come into contact with inner surfaces of the back side frames 1511. Frame contact portions that come into contact with front surfaces or rear surfaces of the back side frames 1511 may be provided.

In addition, for example, the upper frame 1512 or the lower frame 1513 may include frame contact portions that come into contact with the inner surfaces of the back side frames 1511.

In the above-described embodiment, as shown in FIGS. 62A and 62B, the pan frame 1530 includes the frame contact portion 1540 and the second frame contact portions 1550; however, the present invention is not particularly limited, and the pan frame 1530 may include only the frame contact portion 1540 or may include only the second frame contact portions 1550.

In the above-described embodiment, as shown in FIGS. 62A and 62B, the frame contact portion 1540 is a cut and raised portion formed by cutting out a part of the pan frame 1530, but may not particularly formed through cutting and raising. The frame contact portion 1540 may be formed in an uneven shape by press forming or the like as in the first modification example described above, or may be formed by separately attaching frame pieces as in the second modification example described above.

In the above-described embodiment, as shown in FIGS. 61 and 63, the pan frame 1530 includes the first reinforcement recess 1534 and the second reinforcement recess 1535; however, the reinforcement portions can be changed without being particularly limited to a recessed shape.

For example, the pan frame 1530 may include reinforcement protrusions formed as protrusions on the upper surface of the pan frame 1530 and extending in the seat width direction.

### Additional Notes

According to the present invention, there is provided a conveyance seat including a seat frame serving as a skeleton. It is preferable that the seat frame includes side frames disposed on right and left sides in a seat width direction, and a connecting frame connecting the right and left side frames, and that the connecting frame includes a frame contact portion that is provided to protrude toward one side in a thickness direction of the connecting frame, and that comes into contact with inner surfaces of the side frames.

With the above-described configuration, the conveyance seat capable of improving the efficiency of the assembly work of the seat frame can be realized.

In more detail, the connecting frame includes the frame contact portion that is provided to protrude toward the one side in the thickness direction of the connecting frame, and that comes into contact with the inner surfaces of the side frames. For this reason, when the connecting frame is connected to the right and left side frames, the frame contact portion can be brought into contact with (abutted against) the inner surfaces of the right and left side frames, and the positions of both the frames in the seat width direction can be easily restricted. As a result, the man-hours of the assembly work of both the frames can be reduced.

In addition, as described above, since the connecting frame includes the frame contact portion, the number of components of the seat frame can be reduced. Specifically, in the case of attaching the connecting frame (for example, a pan frame) to the right and left side frames using rivets (attachment bolts), even when the number of rivet fastening points is reduced, the assembly rigidity of both the frames can be ensured.

In addition, as described above, since the connecting frame includes the frame contact portion, even when a predetermined load is applied in the seat width direction during use of the conveyance seat, the load can be suitably accepted.

In this case, it is preferable that the connecting frame is formed from a plate-shaped frame, and that the frame contact portion is formed by cutting out a part of the connecting frame, and extends along a longitudinal direction of the side frames while being in contact with the inner surfaces of the side frames.

With the above-described configuration, the frame contact portion can be formed through a simple configuration.

In addition, as described above, the frame contact portion extends along the longitudinal direction of the side frames while being in contact with (in surface contact with) the inner surfaces of the side frames. For this reason, interference of the frame contact portion with other components (for example, a harness) around the connecting frame can be suppressed.

In this case, it is preferable that the connecting frame is formed from a plate-shaped frame, and that the frame contact portion is formed by cutting out a part of the connecting frame, is configured such that an outer end portion of the frame contact portion in the seat width direction comes into contact with the inner surfaces of the side frames, and extends along a direction intersecting a longitudinal direction of the side frames.

With the above-described configuration, the frame contact portion can be formed through a simple configuration.

In addition, as described above, the frame contact portion is configured such that the outer end portion of the frame contact portion in the seat width direction comes into contact with (in surface contact with) the inner surfaces of the side frames, and extends along the direction intersecting the longitudinal direction of the side frames. For this reason, when a predetermined load is applied in the seat width direction, the load can be more suitably accepted. Namely, the frame contact portion that is cut and raised is configured to be less likely to tip over.

In this case, it is preferable that the frame contact portion includes one side frame contact portion formed on one side in the seat width direction and the other side frame contact portion formed on the other side in the seat width direction, on a bottom surface of the connecting frame, and that the one side frame contact portion extends along a longitudinal direction of the side frames while being in contact with the inner surface of the side frame, and the other side frame contact portion is configured such that an outer end portion of the other side frame contact portion in the seat width direction comes into contact with the inner surface of the side frame, and extends along a direction intersecting the longitudinal direction of the side frames.

As described above, since the connecting frame includes the one side frame contact portion and the other side frame contact portion facing different directions, interference of the one side frame contact portion with other components can be suppressed, and the other side frame contact portion can more suitably accept a load applied in the seat width direction.

In this case, it is preferable that the connecting frame is formed from a plate-shaped frame, that the connecting frame includes a reinforcement portion formed as a protrusion or a recess on an upper surface of the connecting frame and extending in the seat width direction, and that the frame contact portion is formed on a bottom surface of the connecting frame at a position avoiding the reinforcement portion.

With the above-described configuration, the connecting frame can be suitably reinforced.

In addition, with the above-described configuration, for example, when the frame contact portion is formed by cutting and raising a part of the connecting frame, by cutting and raising the part while avoiding the reinforcement portion having an uneven shape on the connecting frame, the protrusion amount of the frame contact portion can be reduced. As a result, interference of the frame contact portion with other components can be suppressed.

In this case, it is preferable that the side frames are cushion side frames extending in a seat front to rear direction, that the connecting frame is a pan frame provided on front portions of the right and left side frames in a bridging manner, that the reinforcement portion is formed as a reinforcement recess having a recessed shape, that a hook portion for hooking a seat component of the conveyance seat is provided on an upper surface of a portion of the pan frame, the reinforcement recess being formed at the portion, and that the frame contact portions are formed on the respective right and left sides in the seat width direction and are disposed at positions where the reinforcement recess is sandwiched between the frame contact portions in the seat width direction.

With the above-described configuration, the assembly rigidity of the seat component to the pan frame (hook portion) can be increased. Incidentally, for example, a skin material can be assumed as the seat component, and a skin terminal portion of the skin material can be hooked to the pan frame (hook portion).

In this case, it is preferable that the reinforcement recess includes a first reinforcement recess and a second reinforcement recess formed at different positions in the seat front to rear direction and extending along the seat width direction, and that the frame contact portions are disposed between the first reinforcement recess and the second reinforcement recess in the seat front to rear direction.

With the above-described configuration, the connecting frame can be more suitably reinforced. In addition, the rigidity of the frame contact portions can also be increased.

In this case, it is preferable that the side frames are cushion side frames extending in the seat front to rear direction, that the connecting frame is a pan frame provided on front portions of the right and left side frames in a bridging manner, and that the connecting frame includes second frame contact portions that are provided on a bottom surface of the connecting frame to protrude downward and that come into contact with front surfaces of the side frames.

With the above-described configuration, the positions of both the frames in the seat width direction and in the seat front to rear direction can be easily restricted. As a result, the man-hours of the assembly work of both the frames can be further reduced.

In addition, with the above-described configuration, even when a predetermined load is applied in the seat width direction or in the seat front to rear direction during use of the conveyance seat, the load can be suitably accepted.

In this case, it is preferable that the frame contact portions and the second frame contact portions are formed on the bottom surface of the connecting frame at positions avoiding the reinforcement portion, that the second frame contact portions are formed on the respective right and left sides in the seat width direction, and that the right and left second frame contact portions are disposed at positions where the reinforcement portion is sandwiched between the right and left second frame contact portions in the seat width direction, and are disposed at positions overlapping the reinforcement portion in the seat front to rear direction.

With the above-described configuration, the right and left frame contact portions and the right and left second frame contact portions can be suitably disposed at positions different from that of the reinforcement portion. In addition, the right and left frame contact portions and the right and left second frame contact portions can also be increased in rigidity by being disposed around the reinforcement portion.

### Tenth Embodiment

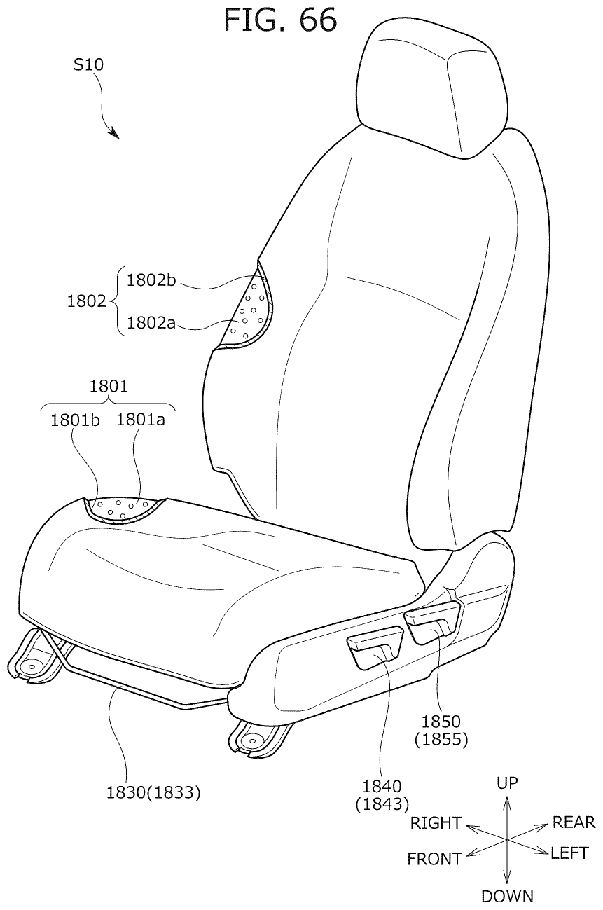

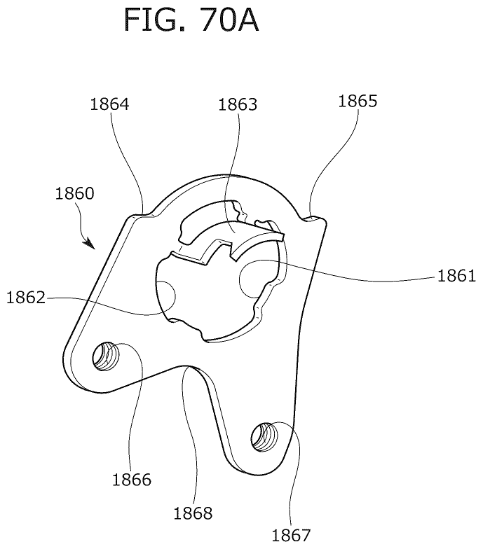

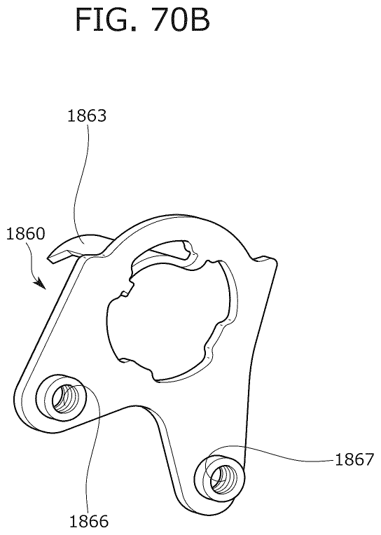

Next, a conveyance seat S10 of a tenth embodiment will be described with reference to FIGS. 66 to 72.

Incidentally, the description of contents that overlap with those of the conveyance seats S1 to S9 described above will be omitted.

The conveyance seat S10 realizes a seat capable of improving the efficiency of assembly work.

In addition, the conveyance seat S10 realizes a seat including a reclining device, which improves the efficiency of the assembly work of the device.

In addition, the conveyance seat S10 realizes a seat capable of reducing the number of components.

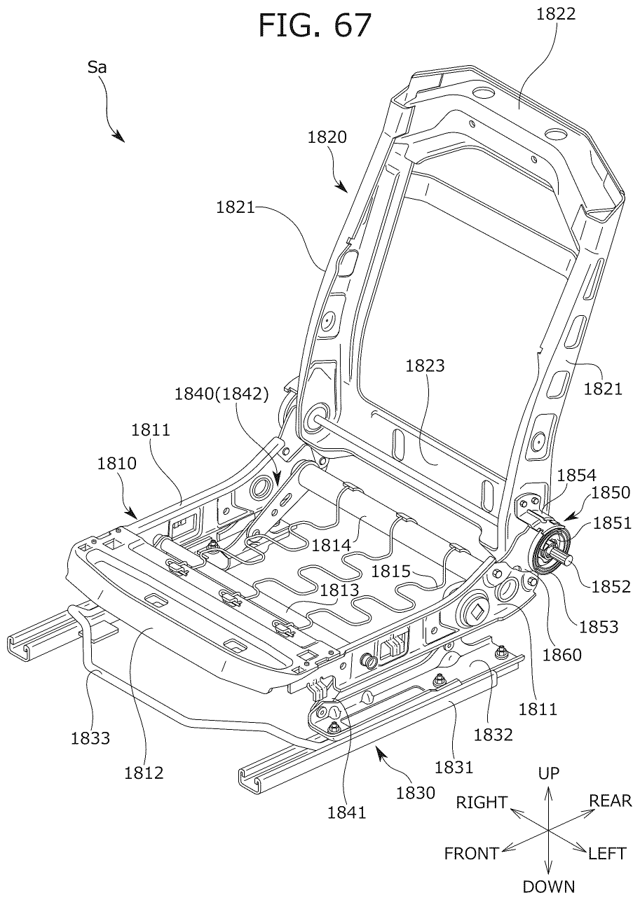

The conveyance seat S10 is, as shown in FIG. 66, a vehicle seat, and mainly includes a seat body including a seat cushion 1801 and a seat back 1802, and as shown in FIG. 67, a rail device 1830 that supports the seat body so as to be movable forward and rearward with respect to a vehicle body floor, a height link device 1840 that connects the seat body to the vehicle body floor so as to be raisable and lowerable, a reclining device 1850 that rotatably connects the seat back 1802 to the seat cushion 1801, and connecting brackets 1860 connecting the seat cushion 1801 and the seat back 1802.

As shown in FIG. 66, the seat cushion 1801 is a seating portion that supports an occupant from below, and is configured by placing a cushion material 1801a on a cushion frame 1810 serving as a skeleton shown in FIG. 67, and by covering the cushion material 1801a with a skin material 1801b.

The seat back 1802 is a backrest portion that supports the occupant from behind, and is configured by placing a cushion material 1802a on a back frame 1820 serving as a skeleton shown in FIG. 67, and by covering the cushion material 1802a with a skin material 1802b.

The cushion frame 1810 and the back frame 1820 are connected by the connecting brackets 1860.

As shown in FIG. 67, the cushion frame 1810 is formed of a substantially rectangular frame-shaped body, and mainly includes cushion side frames 1811 disposed on right and left sides; a pan frame 1812 having a plate shape and provided on front end portions of the cushion side frames 1811 in a bridging manner; a front connecting frame 1813 connecting front portions of the cushion side frames 1811; a rear connecting frame 1814 connecting rear portions of the cushion side frames 1811; and a plurality of elastic springs 1815 hooked to the pan frame 1812 and the rear connecting frame 1814 and extending in a meandering manner in a seat front to rear direction.

The cushion side frames 1811 are plate-shaped frames that are long in the seat front to rear direction.

The reclining device 1850 is attached to the rear portions of the cushion side frames 1811 via the connecting brackets 1860, and the rail device 1830 is attached to lower portions of the cushion side frames 1811 via the height link device 1840.

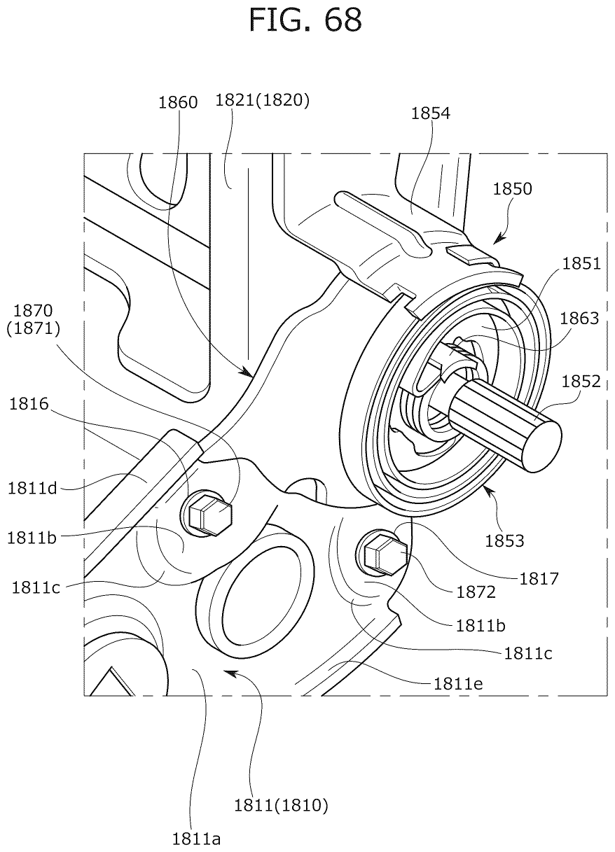

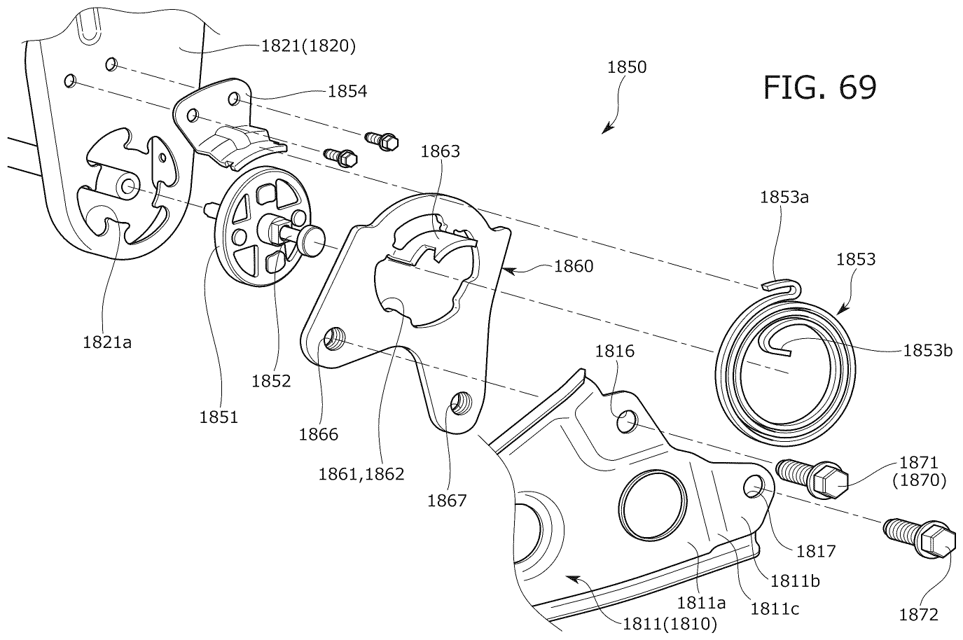

As shown in FIGS. 68 and 69, the rear portion of the cushion side frame 1811 has a stepped shape that is bent in a seat width direction, and includes body wall portion 1811a extending long in the seat front to rear direction; an outer wall portion 1811b disposed outside the body wall portion 1811a in the seat width direction; and a connecting wall portion 1811c connecting the body wall portion 1811a and the outer wall portion 1811b.

Further, the connecting bracket 1860 is assembled to an inner surface of the outer wall portion 1811b by fastening members 1870.

Incidentally, an upper end flange 1811d and a lower end flange 1811e that are bent and protrude to one side (strictly speaking, outward) in the seat width direction are formed at an upper end portion and a lower end portion of the cushion side frame 1811, respectively.

The upper end flange 1811d and the lower end flange 1811e extend from a position where the reclining device 1850 is attached to a position where the pan frame 1812 is attached in the cushion side frame 1811 in the seat front to rear direction.

As shown in FIG. 67, the pan frame 1812 is a plate-shaped bridging frame that supports the thighs of the occupant, and side portions of the pan frame 1812 in the seat width direction are placed and attached to upper surfaces of the cushion side frames 1811.

Each of the front connecting frame 1813 and the rear connecting frame 1814 is a pipe-shaped frame, and connects the right and left cushion side frames 1811 and connects respective right and left links (first links 1841 and second links 1842).

A plurality of the elastic springs 1815 are elastic support members that support the buttocks of the occupant, and are provided with predetermined distances therebetween in the seat width direction.

Front end portions of the elastic springs 1815 are hooked to spring hook portions 1812a formed on an upper surface of the pan frame 1812. In addition, rear end portions of the elastic springs 1815 are attached to the rear connecting frame 1814 via hook members.

As shown in FIG. 67, the back frame 1820 is formed of a substantially rectangular frame-shaped body, and mainly includes back side frames 1821 disposed on the right and left sides; an upper frame 1822 having an inverted U shape and connecting upper end portions of the back side frames 1821; a lower frame 1823 having a plate shape and connecting lower end portions of the back side frames 1821; and elastic springs (not shown) hooked to each of the back side frames 1821 and extending in a meandering manner.

The back side frames 1821 are sheet material members extending in an up to down direction and having substantially C-shaped lateral cross sections, and the lower end portions of the back side frames 1821 are connected to rear end portions of cushion side frames 1811 via the reclining device 1850 and the connecting brackets 1860.

In the above-described configuration, the back frame 1820 is rotatable relative to the cushion frame 1810.

As shown in FIG. 67, the rail device 1830 is disposed between the seat body and the vehicle body floor in the up to down direction, and mainly includes right and left lower rails 1831 fixed to the vehicle body floor and extending in the seat front to rear direction; right and left upper rails 1832 supported to be slidable along the lower rails 1831; a lock member (not shown) that non-slidably locks the upper rails 1832 to the lower rails 1831; and a rail operating lever 1833 for releasing a locked state of the lock member.

The cushion frame 1810 is provided on upper surfaces of the right and left upper rails 1832 via the height link device 1840 in a bridging manner.

As shown in FIG. 67, the height link device 1840 is attached between the rail device 1830 and the cushion frame 1810, and mainly includes the right and left first links 1841 disposed on a seat front side; the right and left second links 1842 disposed on a seat rear side; a brake unit (not shown) that restricts a raising and lowering operation of the seat body; and a height operating lever 1843 (refer to FIG. 66) for releasing a restriction state of the brake unit.

When the height operating lever 1843 is operated, the second link 1842 (left second link) serves as a drive link, and the right second link 1842 and the right and left first links 1841 also rotate. Accordingly, the seat body is raised or lowered to adjust the height of the seat.

As shown in FIGS. 68 and 69, the reclining device 1850 is a device that rotatably connects the back frame 1820 to the cushion frame 1810, and that can lock the back frame 1820.

The reclining device 1850 mainly includes a reclining unit 1851 that restricts the rotation of the back frame 1820; a rotating shaft 1852 that is supported on lower end portions of the back frame 1820 in the seat width direction, and that protrudes from an outer surface of the back frame 1820 to be connected to the reclining unit 1851; and a spiral spring 1853 that is attached to an outer side in the seat width direction of the reclining unit 1851, and that biases the back frame 1820 to rotate about the rotating shaft 1852 to a cushion frame 1810 side.

The reclining unit 1851 can switch the state of the back frame 1820 between a locked state where the back frame 1820 is fixed to the cushion frame 1810 and an unlocked state where the back frame 1820 and the cushion frame 1810 are rotatable relative to each other.

The reclining unit 1851 is configured such that the state of the back frame 1820 is normally set to a locked state and when a reclining operating lever 1855 shown in FIG. 66 is operated, the rotating shaft 1852 is rotated by the operation of the reclining operating lever 1855 and the state of the back frame 1820 is switched to an unlocked state.

Further, the configuration is such that while the state of the back frame 1820 is in an unlocked state, the occupant can tilt the seat back 1802 rearward, and when the occupant releases the reclining operating lever 1855 at the time that the rearward tilt angle reaches a desired angle, the state of the back frame 1820 returns to a locked state.

The rotating shaft 1852 is disposed between the right and left cushion side frames 1811 in a state where an axial direction is aligned along the seat width direction, and an extending end portion of the rotating shaft 1852 passes through a shaft hole 1821a formed in a side surface of the back side frame 1821, and protrudes outward in the seat width direction.

The extending end portion of the rotating shaft 1852 which protrudes is assembled to the reclining unit 1851, and is assembled to the reclining operating lever 1855 shown in FIG. 66 located outside the reclining unit 1851.

When the state of the back frame 1820 is in an unlocked state and the back frame 1820 is in a rearward tilted state, the spiral spring 1853 biases the back frame 1820 to rotate about the rotating shaft 1852 to the cushion frame 1810 side.

As shown in FIGS. 68 and 69, one end portion 1853a of the spiral spring 1853 is hooked to a protruding portion of a spring latch bracket 1854 located on a back side frame 1821 side, and the other end portion 1853b of the spiral spring 1853 is hooked to a spring latch portion 1863 of the connecting bracket 1860 located on the cushion frame 1810 side.

As shown in FIGS. 68 to 71, the connecting bracket 1860 is a metal plate connecting a rear portion of the cushion frame 1810 and a lower portion of the back frame 1820.

A central portion of the connecting bracket 1860 is fitted to an outer surface of the reclining unit 1851 attached to the back side frame 1821.

In addition, a front portion and a lower portion of the connecting bracket 1860 are bolt-fastened to an inner surface of the cushion side frame 1811.

Specifically, a shaft hole 1861 for inserting the rotating shaft 1852 and fitting holes 1862 provided around the shaft hole 1861 so as to surround the shaft hole 1861 and fitted to the reclining unit 1851 are formed at a central portion of a side surface of the connecting bracket 1860.

In addition, the spring latch portion 1863 protruding outward in the seat width direction and used for hooking the other end portion 1853b of the spiral spring 1853 is formed at an upper portion of the connecting bracket 1860.

In addition, a front restriction portion 1864 and a rear restriction portion 1865 that can come into contact with a front end portion 1854a and a rear end portion 1854b of the spring latch bracket 1854, respectively, are formed at upper end portions of an outer peripheral portion of the connecting bracket 1860. The restriction portions 1864 and 1865 restrict the rotation range of the back frame 1820 when the back frame 1820 rotates. Specifically, the restriction portions 1864 and 1865 function to restrict the rotation range of the spring latch bracket 1854 rotating integrally with the back frame 1820.

A fastening hole 1866 for fastening the fastening member 1870 (for example, a fastening bolt or a fastening pin) from the outside in the seat width direction is integrally formed at the front portion of the connecting bracket 1860.

In addition, a second fastening hole 1867 for fastening the fastening member 1870 is also integrally formed at the lower portion of the connecting bracket 1860.

The fastening holes 1866 and 1867 are fastening holes which are formed along the seat width direction and in which tapping (burring) is performed on the inner sides of the fastening holes 1866 and 1867.

The fastening holes 1866 and 1867 are disposed to communicate with fastening holes 1816 and 1817, respectively, which are formed in the outer wall portion 1811b of the rear portion of the cushion side frame 1811.

Peripheral portions of the fastening holes 1866 and 1867 in the connecting bracket 1860 protrude to extend inward in the seat width direction, and the fastening holes 1866 and 1867 extend in a protruding direction (seat width direction).

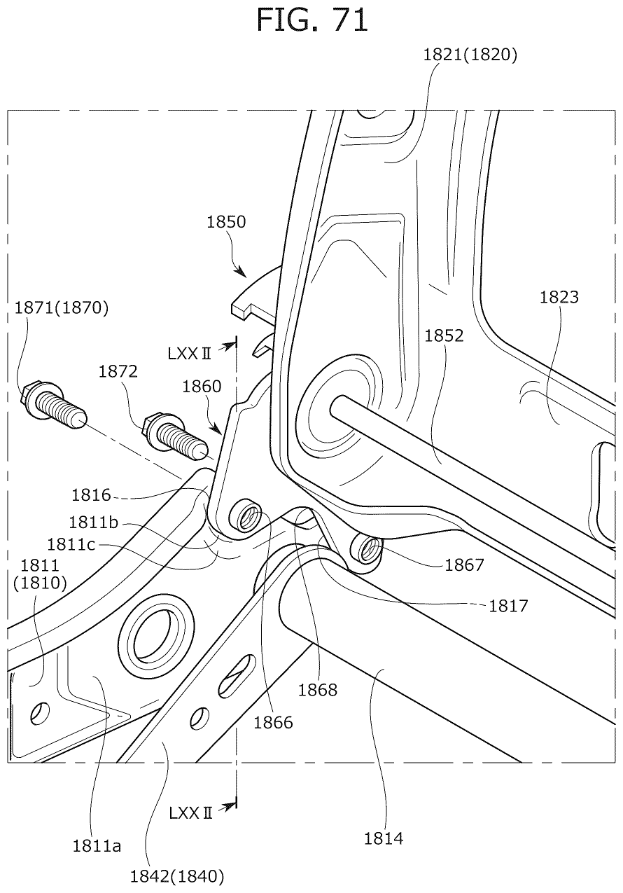

As shown in FIGS. 71 and 72, a first fastening member 1871 is fastened to the fastening hole 1866 and to the fastening hole 1816 of the cushion side frame 1811 from the outside in the seat width direction.

In addition, a second fastening member 1872 is fastened to the fastening hole 1867 and to the fastening hole 1817 of the cushion side frame 1811 from the outside in the seat width direction.

With the above-described configuration, the connecting bracket 1860 can be efficiently assembled to the inner surface of the cushion side frame 1811. Specifically, the need for fastening nuts can be eliminated, the number of components can be reduced, and the work process can be shortened.

In the above-described configuration, as shown in FIG. 72, the peripheral portion of the fastening hole 1866 protrudes inward in the seat width direction continuously from a body portion of the connecting bracket 1860, and is disposed at a position not overlapping the back side frame 1821 in the seat width direction.

For this reason, the connecting bracket can be compactly disposed in the seat width direction. In addition, when the back frame 1820 rotationally operates in the seat front to rear direction, interference between the connecting bracket 1860 (fastening hole 1866) and the back side frame 1821 can be suppressed.

In addition, in the above-described configuration, as shown in FIG. 72, the peripheral portion of the fastening hole 1866, the back side frame 1821, and the second link 1842 are disposed at different positions in the seat width direction.

For this reason, when the reclining device 1850 and the height link device 1840 operate, interference between the connecting bracket 1860 (fastening hole 1866), the back side frame 1821, and the second link 1842 can be suppressed.

In addition, in the above-described configuration, as shown in FIG. 72, the peripheral portion of the fastening hole 1866 protrudes further inward in the seat width direction than the body wall portion 1811a of the cushion side frame 1811.

With such a configuration, the fastening length between the fastening hole 1866 and the fastening member 1870 is easily extended. For this reason, the fastening strength of the connecting bracket 1860 to the cushion side frame 1811 is increased.

In addition, in the above-described configuration, as shown in FIG. 72, the fastening member 1870 protrudes further inward in the seat width direction than the peripheral portion of the fastening hole 1866, and is disposed at a position not overlapping the back side frame 1821 in the seat width direction.

For this reason, when the back frame 1820 rotationally operates in the seat front to rear direction, interference between the fastening member 1870 and the back side frame 1821 can be suppressed.

In addition, in the above-described configuration, as shown in FIG. 71, a cutout portion 1868 that is cut out opposite to a rear connecting frame 1814 side is formed at a portion of the outer peripheral portion of the connecting bracket 1860, the portion being close to the rear connecting frame 1814.

For this reason, interference between the connecting bracket 1860 and the rear connecting frame 1814 can be suppressed.

Incidentally, the cutout portion 1868 is cut out in a substantially triangular shape, and is sandwiched and disposed between two fastening holes 1866 and 1867.

In addition, in the above-described configuration, as shown in FIG. 71, the first fastening member 1871 and the second fastening member 1872 are disposed around the reclining unit 1851 so as to surround the reclining unit 1851, and are disposed around the rear connecting frame 1814 so as to surround the rear connecting frame 1814.

In addition, the first fastening member 1871 is disposed at a seat front position with respect to the second fastening member 1872. The first fastening member 1871 is disposed at a position overlapping the rear connecting frame 1814 in the seat front to rear direction, and is disposed at a position overlapping the reclining unit 1851 in the up to down direction. Further, the second fastening member 1872 is disposed at a position overlapping the reclining unit 1851 in the seat front to rear direction, and is disposed at a position overlapping the rear connecting frame 1814 in the up to down direction.

For this reason, the assembly rigidity of the reclining unit 1851 and the rear connecting frame 1814 can be increased.

### Others

In the above-described embodiment, as shown in FIG. 67, the conveyance seat S10 includes the rail device 1830, the height link device 1840, and the reclining device 1850; however, such a configuration can be changed without being particularly limited.

Namely, the conveyance seat S10 may not include the rail device 1830, the height link device 1840, and the reclining device 1850.

In the above-described embodiment, as shown in FIG. 71, the connecting bracket 1860 is attached to the inner surface of the cushion side frame 1811; however, the present invention is not particularly limited, and the connecting bracket 1860 may be attached to an outer surface of the cushion side frame 1811.

In that case, it is preferable that the cushion side frame 1811 has a stepped shape that is bent inward in the seat width direction.

In the above-described embodiment, as shown in FIG. 71, the connecting bracket 1860 is attached to an outer surface of the back side frame 1821; however, the present invention is not particularly limited, and the connecting bracket 1860 may be attached to an inner surface of the back side frame 1821.

In the above-described embodiment, as shown in FIGS. 71 and 72, the peripheral portion of the fastening hole 1866 protrudes inward in the seat width direction; however, the present invention is not particularly limited, and the peripheral portion of the fastening hole 1866 may protrude outward in the seat width direction.

In that case, it is preferable that the connecting bracket 1860 is attached to the outer surface of the cushion side frame 1811.

### Additional Notes

According to the present invention, there is provided a conveyance seat including: a cushion frame; a back frame; and connecting brackets connecting seat rear portions of the cushion frame and lower portions of the back frame. It is preferable that the cushion frame includes cushion side frames disposed on right and left sides in a seat width direction, that the connecting brackets are attached to the cushion side frames by fastening members, that fastening holes for fastening the fastening members are formed in each of the connecting brackets and the cushion side frames, that peripheral portions of the fastening holes in the connecting brackets protrude toward one side in the seat width direction, and that the fastening holes extend in a protruding direction.

With the above-described configuration, the conveyance seat capable of improving the efficiency of assembly work, specifically, reducing the number of components can be realized.

In more detail, the fastening holes for fastening the fastening members are formed in each of the connecting brackets and the cushion side frames, the peripheral portions of the fastening holes in the connecting brackets protrude toward the one side in the seat width direction, and the fastening holes extend in the protruding direction. For this reason, generally, the connecting brackets are fixed to the cushion side frames using fastening bolts and fastening nuts, but in the case of this configuration, the need for fastening nuts can be eliminated.

Specifically, protruding portions of the peripheral portions of the fastening holes of the connecting brackets can substitute for fastening nuts. For example, fastening bolts can be fastened by tapping inner sides of fastening holes.

With such a configuration, the conveyance seat that improves the efficiency (eliminating the need for fastening nuts, reducing the number of components, and shortening the work process) of the assembly work of the connecting brackets can be realized.

In this case, it is preferable that a reclining device that rotatably connects the back frame to the cushion frame is provided, that the reclining device includes a reclining unit attached to an outer surface of the back frame and restricting a rotation of the back frame, and that the connecting brackets are attached to the outer surface of the back frame.

With the above-described configuration, the conveyance seat including the reclining device, which improves the efficiency of the assembly work of the device, can be realized.

In this case, it is preferable that the back frame includes back side frames disposed on the right and left sides in the seat width direction, and that the peripheral portions of the fastening holes protrude further inward in the seat width direction than body portions of the connecting brackets, and are disposed at positions not overlapping the back side frames in the seat width direction.

As described above, since the peripheral portions of the fastening holes protrude inward in the seat width direction, the connecting brackets can be compactly disposed in the seat width direction.

In addition, as described above, since the peripheral portions of the fastening holes are disposed at the positions not overlapping the back side frames in the seat width direction, when the back frame rotationally operates in a seat front to rear direction, interference between the connecting brackets and the back side frames can be suppressed.

In this case, it is preferable that the connecting brackets are attached to the cushion side frames by fastening the fastening members from an outside in the seat width direction, and that the fastening members protrude further inward in the seat width direction than the peripheral portions of the fastening holes, and are disposed at positions not overlapping the back side frames in the seat width direction.

With the above-described configuration, compared to the case of fastening the fastening members from the inside in the seat width direction, the fastening members can be efficiently assembled.

In addition, with the above-described configuration, when the back frame rotationally operates in the seat front to rear direction, interference between the fastening members and the back side frames can be suppressed.

In this case, it is preferable that the cushion side frames have a stepped shape that is bent in the seat width direction, and include body wall portions extending long in a seat front to rear direction, outer wall portions attached to outer surfaces of the connecting brackets and disposed outside the body wall portions in the seat width direction, and connecting wall portions connecting the body wall portions and the outer wall portions, and that the body portions of the connecting brackets are disposed between the body wall portions and the outer wall portions in the seat width direction.

With the above-described configuration, the connecting brackets can be compactly disposed in the seat width direction.

In this case, it is preferable that the peripheral portions of the fastening holes protrude further inward in the seat width direction than the body wall portions of the cushion side frames.

With the above-described configuration, since fastening lengths between the fastening members and the fastening holes are easily extended, the fastening strength of the connecting brackets to the cushion side frames can be increased.

In this case, it is preferable that a height link device that connects the cushion frame to a vehicle body floor so as to be raisable and lowerable is provided, that the height link device includes right and left links provided between the cushion frame and the vehicle body floor, and that the peripheral portions of the fastening holes are disposed at positions not overlapping the links in the seat width direction.

With the above-described configuration, when the height link device operates, interference between the connecting brackets (peripheral portions of the fastening holes) and the links can be suppressed.

In this case, it is preferable that the cushion frame includes a connecting frame connecting rear portions of the right and left cushion side frames, that the connecting frame connects the right and left links, and that the peripheral portions of the fastening holes, the back side frames, and the links are disposed at different positions in the seat width direction.

With the above-described configuration, when the reclining device and the height link device operate, interference between the connecting brackets (peripheral portions of the fastening holes), the back side frames, and the links can be suppressed.

In this case, it is preferable that the cushion frame includes a connecting frame connecting rear portions of the right and left cushion side frames, that the connecting brackets are attached to the cushion side frames by first fastening members and second fastening members, and that the first fastening members and the second fastening members are disposed around the reclining unit, and are disposed around the connecting frame.

In addition, it is preferable that the first fastening members are disposed at seat front positions with respect to the second fastening members, that the first fastening members are disposed at positions overlapping the connecting frame in the seat front to rear direction, and are disposed at positions overlapping the reclining unit in an up to down direction, and that the second fastening members are disposed at positions overlapping the reclining unit in the seat front to rear direction, and are disposed at positions overlapping the connecting frame in the up to down direction.

With the above-described configuration, the assembly rigidity of the reclining unit and the connecting frame can be increased.

In the above-described embodiments, the conveyance seats used in automobiles have been described as specific examples; however, the present invention is not particularly limited thereto, and the conveyance seats can be used as conveyance seats for airplanes, ships, and the like in addition to conveyance seats for trains, buses, and the like.

In the present embodiments, the conveyance seats according to the present invention have been mainly described.

However, the above-described embodiments are merely examples provided to facilitate understanding of the present invention, and do not limit the present invention. The present invention can be modified and improved without departing from the concept of the present invention, and it goes without saying that the present invention includes its equivalents.

### REFERENCE SIGNS LIST

S1 to S10, SA Conveyance seat (vehicle seat)
   Sa, F, FX Seat frame
   S3a Seat cushion
   S3b Seat back
   S3c Headrest
   T Trim cover (cushion trim cover)
   P Pad member (pad)
1, 501, 1001, 1101, 1201, 1301, 1401, 1401A, 1501, 1802 Seat back
   1a, 2a, 501a, 502a, 1301a, 1302a, 1501a, 1502a, 1801a, 1802a Cushion material
   1b, 2b, 501b, 502b, 1301b, 1302b, 1501b, 1502b, 1801b, 1802b Skin material
   1401a Torso support surface
2, 502, 1002, 1102, 1202, 1302, 1402, 1402A, 1502, 1801 Seat cushion
3, 503, 1004, 1104, 1204, 1303, 1405, 1503, 1830 Slide rail device (rail device, slide rail)
   3a, 1503a, 1831 Lower rail
   3b, 1503b, 1832 Upper rail
   3c, 1503c, 1833 Rail operating lever
4, 504, 1304, 1504, 1840 Height link device
   4a, 504a, 1304a, 1504a, 1841 First link
   4b, 504b, 1504b, 1842 Second link
   4c, 504, 1843 Height operating lever
10, 510 Back frame
11, 511 Back side frame
   11a Fitting hole
12, 512 Upper frame
13, 513 Lower frame
20, 520 Cushion frame
21, 521 Side frame
   21a Fitting hole
   521a Frame body portion
   521b Upper end flange portion
   521c Lower end flange portion
   521d Skin hook portion
22, 522 Pan frame
23 Front connecting frame
24 Rear connecting frame
30, 130, 230, 505, 1007, 1107, 1207, 1305, 1407, 1505, 1850 Reclining device (reclining mechanism)
31, 1505a, 1851 Reclining body (reclining unit)
32, 132, 232, 332, 432, 1505b, 1852 Rotating shaft
33, 1505c, 1853 Spiral spring
   1853a One end portion
   1853b The other end portion
34, 1855 Reclining operating lever
35, 1854 Spring latch bracket
   1854a Front end portion
   1854b Rear end portion
36 Spring latch member
40, 140, 240, 340, 440 Connecting member
41, 141, 241, 341, 441 Connecting body portion
   341a, 441a First facing wall portion
   341b, 441b Second facing wall portion
   341c, 441c Connecting wall portion
42, 142, 242, 342, 442 Shaft attachment portion
   42a, 142a, 242a, 342a, 442a First facing wall portion
   42b, 142b, 242b, 342b, 442b Second facing wall portion
   42c, 142c, 242c, 342c, 442c Connecting wall portion
   42d, 142d, 242d First flange portion
   42e, 142e, 242e Second flange portion
43, 143, 243, 343, 443 Reinforcement protrusion (reinforcement portion)
44, 144 Reinforcement recess (reinforcement portion)
45 Welding mark
146, 246 Positioning portion
244 Second reinforcement protrusion
245 Reinforcement recess
444 Through hole
523 Elastic spring
530 Front connecting frame (connecting frame)
531 Frame body portion
532 Flange portion
540 Rear connecting frame (connecting frame)
541 Frame body portion
   541a First facing wall portion
   541b Second facing wall portion
   541c Connecting wall portion
542 Flange portion
   542a First flange portion
   542b Second flange portion
   542c Third flange portion
543 Reinforcement recess (reinforcement portion)
544 Reinforcement protrusion (reinforcement portion)
910 Seat cushion frame
911 Cushion side frame (side frame)
912 Pan frame
913 Front connection pipe (connection member)
914 Rear connection pipe (connection member)
   914a Central portion (first portion)
   914b End portion (second portion)
   914c Boundary portion
   914d Contact portion
920 Seat back frame
921 Back side frame
922 Upper frame
923 Lower frame
930 Slide rail
940 Height adjustment mechanism
1003, 1103, 1203 Headrest
1010 Seat back frame
1011 Back side frame
1012, 1012A Upper frame
1013, 1013A First pan frame
   1013a, 1013Aa Bulging portion
   1013b, 1013Ab Flange portion
   1013c, 1013Ac Recess
   1013d Opening portion
   1013g Hook portion
1014, 1014A Second pan frame
   1014Aa Bulging portion
   1014Ab Flange portion
   1014c, 1014Ac Recess
   1014d Opening portion
   1014e Flange portion
   1014f Welding hole
   1014g Hook portion
   1014h Hole
   1014i Cutout
1015, 1015A Holder portion
   1015a Upper opening portion
   1015b Lower opening portion
1016 Lower frame
1017 Headrest guide
   1017a Insertion opening
   1017b Head portion
1020 Seat cushion frame
1021 Cushion side frame
1022 Front connecting frame
1023 Rear connecting frame
1024 Cushion pan frame
1030 Headrest frame
1031 Headrest stay
1110 Seat back frame
1111 Back side frame
1112 Upper frame
1113 First member
   1113a Second segment
   1113b Bulging portion (second bulging portion)
   1113c Flange portion (second flange portion)
1114 Second member
   1114a Second segment
   1114b Bulging portion (second bulging portion)
   1114c Flange portion (second flange portion)
1115 Third member
   1115a First segment
   1115b Bulging portion (first bulging portion)
   1115c Flange portion (first flange portion)
   1115d Upper surface
   1115e Lower surface
   1115f Through hole
   1115g Through hole
1116 Lower frame
1117 Headrest guide
   1117a Insertion opening
   1117b Head portion
1118 Holder portion
   1118a Upper opening portion
   1118b Lower opening portion
1119 Slit
1120 Seat cushion frame
1121 Cushion side frame
1122 Front connecting frame
1123 Rear connecting frame
1124 Cushion pan frame
1130 Headrest frame
1131 Headrest pillar
1210 Seat back frame
1211 Back side frame
1212, 1212A, 1212B Upper frame
1213, 1213A, 1213B First pan frame
   1213a First bulging portion
   1213b First flange portion
   1213c, 1213Ac First recess
   1213d Upper opening portion
   1213e Lower opening portion
1214, 1214A, 1214B Second pan frame
   1214a Second bulging portion
   1214b Second flange portion
   1214c, 1214Bc Second recess
   1214d Upper opening portion
   1214e Lower opening portion
   1214f Window portion
1215 Holder portion
   1215a Upper opening portion
   1215b Lower opening portion
   1215c Cover portion
1216 Lower frame
1217 Headrest guide
   1217a Insertion opening
   1217b Head portion
   1217c Body
1220 Seat cushion frame
1221 Cushion side frame
1222 Front connecting frame
1223 Rear connecting frame
1224 Cushion pan frame
1230 Headrest frame
1231 Headrest pillar
   1231a Lower end
1310 Back frame
1311 Back side frame
1312 Upper frame
1313 Lower frame
1320 Cushion frame
1321 Side frame
   1321a Frame body portion
   1321b Upper end flange portion
   1321c Lower end flange portion
   1321d Skin hook portion
   1321e Engagement hole (engaged portion)
1322 Front connecting frame
1323 Rear connecting frame
1324 Elastic spring (elastic member)
1330 Pan frame (bridging frame)
1331 Frame central portion (first frame portion)
   1331a, 1331b Protruding flange
1332 Frame side portion (second frame portion)
   1332a, 1332b Protruding flange
1333 Rear reinforcement portion (reinforcement portion)
1334 Front reinforcement portion (reinforcement portion, reinforcement recess)
1335 Spring hook portion
1336 Skin hook portion
1337 Engagement clip (engaging portion)
   1337a Clip body portion
   1337b Engaging portion
   1337c Recess
1403, 1403A Headrest
   1403a Head support surface
1404, 1404A Neck support
   1404a Neck support surface
1410 Seat back frame
1411 Back side frame
1412 Upper frame
1413 Cross member
1416 Lower frame
1417 Headrest guide
1418 Attachment wire
1419 Torso support plate
1420 Seat cushion frame
1430 Headrest frame
1431 Headrest pillar
1433 Head support plate
1440 Neck support frame
1441 Guide member
   1441a Groove
1442 Neck support plate (support member)
1443 Position holding member
   1443A First position holding member
   1443B Second position holding member
1444 Upper attachment portion frame
1445 Spring (biasing member)
1446 Latch piece
1447 Recess
1448 Shape-maintaining member
1449 Holding portion
1450 Body
1451 Upper attachment portion
   1451a Through hole
1452 Adjustment mechanism
1453 Protrusion amount adjustment portion
1454 Up and down position adjustment portion
1455 Lock portion
1456 Protruding portion
1510 Back frame
1511 Back side frame (side frame)
1512 Upper frame (connecting frame)
1513 Lower frame (connecting frame)
1514 Member frame (connecting frame)
1520, 1620, 1720 Cushion frame
1521 Side frame (cushion side frame)
   1521a Frame body portion
   1521b Upper end flange portion
   1521c Lower end flange portion
   1521d Skin hook portion
   1521e Attachment hole (attached portion)
1522 Front connecting frame
1523 Rear connecting frame
1524 Elastic spring (elastic member)
1530, 1630, 1730 Pan frame (connecting frame)
1531 Frame body portion
1532 Frame front wall portion
   1532a, 1533a Bent portion
1533 Frame side wall portion
1534 First reinforcement recess (reinforcement portion)
1535 Second reinforcement recess (reinforcement portion)
1536 Skin hook portion (hook portion)
1537 Spring hook portion (hook portion)
1538 Attachment hole (attaching portion)
1539 Attachment bolt (attaching member)
1540, 1640, 1740 Frame contact portion
1540A Left frame contact portion (frame contact portion on one side)
1540B Right frame contact portion (frame contact portion on the other side)
1550 Second frame contact portion
1641 Outer wall portion
1810 Cushion frame
1811 Cushion side frame
   1811a Body wall portion
   1811b Outer wall portion
   1811c Connecting wall portion
   1811d Upper end flange
   1811e Lower end flange
1812 Pan frame
   1812a Spring hook portion
1813 Front connecting frame
1814 Rear connecting frame
1815 Elastic spring
1186 Fastening hole
1820 Back frame
1821 Back side frame
   1821a Shaft hole
1822 Upper frame
1823 Lower frame
1860 Connecting bracket
1861 Shaft hole
1862 Fitting hole
1863 Spring latch portion
1864 Front restriction portion
1865 Rear restriction portion
1866 Fastening hole
1867 Second fastening hole
1868 Cutout portion
1870 Fastening member (fastening bolt)
1871 First fastening member
1872 Second fastening member
H Occupant
H1 Head
H2 Neck
H3 Torso
BF Vehicle body floor

What is claimed is:

1. A conveyance seat, comprising:
a seat body including a seat cushion and a seat back; and
a reclining device that rotatably connects the seat back to the seat cushion,
wherein the reclining device includes rotating shafts disposed on right and left sides in a seat width direction and serving as a rotation center of the seat back, and a connecting member extending in the seat width direction and connecting the right and left rotating shafts,
the connecting member includes a connecting body portion extending long in the seat width direction, and shaft attachment portions provided at extending end portions of the connecting body portion and used for attaching the rotating shafts, and
each of the shaft attachment portions has an open cross-sectional shape in which an opening portion is formed on one side in an up to down direction or on one side in a seat front to rear direction, and supports an extending portion of the corresponding rotating shaft.
